(19) United States
(12) Patent Application Publication
(10) Pub. No.: US 2005/0240441 A1
(43) Pub. Date: Oct. 27, 2005

(54) Hospital information system and program thereof

(75) Inventors: Hitoshi Suzuki, Tokyo (JP); Yasuyuki Fukuhara, Tokyo (JP); Keiichi Hiyama, Tokyo (JP); Kazuhiro Akiyama, Tokyo (JP); Kiyobumi Watanabe, Tokyo (JP); Katsuya Suzuki, Sagamihara (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/113,913

(22) Filed: Apr. 25, 2005

(30) Foreign Application Priority Data
Apr. 26, 2004 (JP) 2004-129944
Aug. 3, 2004 (JP) 2004-226324

(51) Int. Cl. G06F 17/60

(52) U.S. Cl. 705/2

(57) ABSTRACT

A hospital information system according to the present invention lets an RF reader 12 comprised by a PDA 8 read tag information, once for all, recorded by RF tags either attached to, or embedded in, plural kinds of a plurality of patient wrist bands, injection medicine bottles, patient charts, medical instrument cases, et cetera, and transmits a query to a server 5 by way of a wireless LAN 9, server 7 and LAN 3 for confirmation from the server 5. The server 5 collates it with the content of a medical practice order recorded in its data base, and registers a completion of instructed operation for an instructed item in the database, as well as responds back with notifying “correct” if the transmitted readout data from the PDA 8 is correct. If the readout data is not correct, the PDA will be notified of “incorrect” with an instruction for reading again.

### CROSS REFERENCE TO RELATED APPLICATION

This application is based upon and claims the benefit of priority from the prior Japanese Application No. 2003-123320, filed Apr. 28, 2003, No. 2004-129944, filed Apr. 26, 2004 and No. 2004-226324, filed Aug. 3, 2004, the entire contents of which are incorporated herein by reference.

### BACKGROUND OF THE INVENTION

1. Field of the Invention

The present invention relates to a hospital information system for enabling a real time grasp of information about medical practice, such as the information about medicine administered to a patient by injection or drip infusion for instance, and assisting a smooth operation of the medical practice through an integrated central management of the data input and output by mobile terminals on the spot of the medical practice.

2. Description of the Related Art

It has conventionally been possible to record the performed medical practice at the fixed place providing medical practice to where the patient visit to take medical practice such as endoscopy, since a system for recording the medical practice is installed in situ.

However, the medical practice for which the practitioners thereof, e.g., doctor and nursing treat man (she or he e, visit the patient's room to provide the appropriate medical treatment for each patient in one patient's room one after another in an orderly fashion is recorded using paper media.

This requires a large amount of labor to collect such medical operation data by integrating the recorded contents on the paper media. Furthermore, a large amount of labor is necessary to comprehend a state of medical practice by understanding the recorded contents on paper or grasping by human system information exchanges.

If a hospital has an office of clerks or the central back-office, it is possible to record the medical practices therein after they have been provided. This method, however, is actually the recording after the fact, and therefore it is difficult to grasp the content, progress, result, et cetera, of the medical practice in real time.

It is also seen at times that such an after-the-fact recording system brings about the difference between the actual medical practice and the recorded content, making it difficult to keep an accurate record.

As a countermeasure to such a problem, a technique has been proposed for managing various medical practices by a host computer based on the medical operation data which has been inputted by mobile input terminals (i.e. mobile terminals), indicating the medical practices provided for patients (refer to a Japanese patent laid-open application publication No. 08-106500: the abstract and FIG. 1 therein, for example).

The proposed technique therein relates to the one which is done in real time by a nurse accompanied by a doctor who instructs to record various medical practices based thereon, thereby keeping an accurate record without causing a mistake as with the after-the-fact recording and reducing the load imposed on the nurse by a direct input of the instruction from the doctor in situ.

Incidentally, the medical practices are not necessarily always provided by a doctor accompanying a nurse, but the nurse alone often performs a medical practice according to a medical practice order prescribed by the doctor, such as an injection (including a drip infusion) and administration of medicine to an inpatient.

Meanwhile, as one of the conventional systems for managing a medicine, a method has been proposed for making certain of a medicine to be administered by attaching read-only identification information to medicines and syringe labels, which contains the identification ID for identifying the respective medicines, by reading out the identification information by a mobile terminal, when administering a medicine to the patient, and by collating the read-out identification information with the injection order (refer to a Japanese patent laid-open application publication No. 2002-92164: paragraphs [0027] through [0040] for instance).

### SUMMARY OF THE INVENTION

A hospital information system according to the present invention at least comprises a terminal for use in an input and output of data relating to a medical practice; a server system for exchanging the data with the terminal; and an intra-hospital information management system for recording information within a hospital exchanged by the server system and performing an integrated central management of the information.

The above noted terminal comprises at least an order registration terminal equipped with an order registration apparatus for registering an order relating to an injection treatment; and a mobile terminal, being equipped within at least one of the server systems, capable of inputting and outputting data relating to the injection treatment on a practicing spot thereof.

And the hospital information system according to the present invention for instance comprises an order information storage apparatus for generating, storing and managing order information relating to a medicine administered to a patient; and a medicine management apparatus for writing information generated in accordance with the order information relating to the medicine on an RF tag attached to the aforementioned medicine when delivering the medicine based on the order.

### BRIEF DESCRIPTION OF THE DRAWINGS

FIG. 1 is a block diagram showing an overall configuration of hospital information system according to a first embodiment of the present invention;

FIG. 2 shows a hardware configuration of the PDA (personal digital assistant: a generic name for mobile information terminal for personal use) shown by FIG. 1;

FIG. 3 is a table of medical practices ranging from injection to sample test and a detailed content of work schedule ranging from an order registration to implementation of the medical practice;

FIGS. 4A, 4B and 4C are flow charts respectively showing contents of operational procedures at an order registration, reference and practice;

FIG. 5 shows a content of work schedule generated based on a registration of injection order;

FIG. 6 is a flow chart showing a content of operational procedure of a PDA system at the time of registering an injection order;

FIG. 7 exemplifies a login screen of PDA;

FIG. 8 exemplifies a registration screen for work schedule list;

FIG. 9 exemplifies a display screen for showing a list of all patients to be treated during a designated work shift in the case of registering by patient names in the procedure shown by FIG. 8;

FIG. 10 exemplifies a screen for selecting a ward in the case of registering by ward in the procedure shown by FIG. 8;

FIG. 11 exemplifies a screen for selecting a work shift in the case of operating the work shift button in FIG. 9;

FIG. 12 exemplifies a screen for selecting a work schedule list;

FIG. 13 exemplifies a display screen displayed in the case of selecting the today's work list in FIG. 12;

FIG. 14 exemplifies a display screen in the case of selecting a list of completion in the work schedule list;

FIG. 15 shows a structure of work schedule data;

FIG. 16 is a flow chart showing a detailed operation content for practicing an injection (i.e., administering);

FIG. 17 exemplifies a display screen in the case of selecting the injection item from among the operation list by practice item shown by FIG. 12;

FIG. 18 exemplifies a display screen in the case of checking the bottle;

FIG. 19 exemplifies a display screen showing a warning when detecting a mistake such as a medicine bottle wrongly selected;

FIG. 20 exemplifies a display screen in the case of checking the patient wrist band;

FIG. 21 exemplifies a display screen for confirming an injection;

FIG. 22 exemplifies a display screen for inputting an administered amount after completing an injection;

FIG. 23 is a flow chart of checking bottle label in performing an injection;

FIG. 24 exemplifies a display screen for checking a bottle in order to input a broken injection medicine bottle when that occurs;

FIG. 25 exemplifies a screen for confirming an input of a broken injection medicine bottle when that occurs;

FIG. 26A shows an operational content for starting a drip infusion in the case of practicing the drip infusion;

FIG. 26B shows an operational content for completing a drip infusion in the case of practicing the drip infusion;

FIG. 27 illustrates reading an identification code of an injection medicine bottle and that of a patient wrist band;

FIG. 28 is a flow chart describing processing operations of hospital information system relating to reading an identification code of an injection medicine bottle and that of a patient wrist band;

FIG. 29 illustrates an operation of reading in an RF-tagged patient chart as another embodiment of reading an RF tag by an RF reader equipped in a PDA;

FIG. 30A is a flow chart describing a processing operation of hospital information system relating to a reading operation of RF-tagged patient chart;

FIG. 30B is a flow chart describing a processing operation of the same system as FIG. 30A in the case of reading a patient chart data by an optical reading apparatus for reference;

FIG. 31 illustrates a reading operation of RF-tagged medical instrument cases as yet another embodiment of RF tag reading by an RF reader equipped by a PDA;

FIG. 32 is a flow chart describing a processing operation of hospital information system relating to tag reading operation of RF-tagged medical instrument cases;

FIG. 33 is a flow chart describing another example of a processing operation of a hospital information system relating to reading identification information of an injection medicine bottle and that of a patient wrist band, both according to a second embodiment;

FIG. 34 is a flow chart describing an example processing operation of a hospital information system relating to an injection medicine mixing according to a third embodiment;

FIG. 35 shows an example configuration of hospital information system according to a fourth embodiment;

FIG. 36 shows an example configuration of a terminal apparatus and that of a server;

FIG. 37 shows an example configuration of a PDA for recording injection practice;

FIG. 38 shows information and material flows relating to medicines administered to patients in a hospital by using a hospital information system according to the fourth embodiment;

FIG. 39 is a flow chart showing a processing flow for delivering a medicine;

FIG. 40 shows tag information stored in an RF tag attached to a medicine and an injection medicine bottle;

FIG. 41 is a flow chart showing a processing flow of injection medicine mixing operation;

FIG. 42 is a flow chart showing a processing of injection practice;

FIG. 43 describes a processing at the time of order change;

FIG. 44 is a flow chart showing an outline of conditional discarding processing;

FIG. 45 is a flowchart (part 1) showing a processing in the case of changing injection order before injection medicine mixing operation following a requisition of the medicine;

FIG. 46 is a flowchart (part 2) showing a processing in the case of changing injection order before injection medicine mixing operation following a requisition of the medicine;

FIG. 47 is a flowchart (part 1) showing a processing in the case of changing an injection order after an injection medicine mixing operation; and

FIG. 48 is a flowchart (part 2) showing a processing in the case of changing an injection order after an injection medicine mixing operation.

### DESCRIPTION OF THE PREFERRED EMBODIMENTS

Embodiments of the present invention will be described in reference to the accompanying drawings in the following.

### First Embodiment

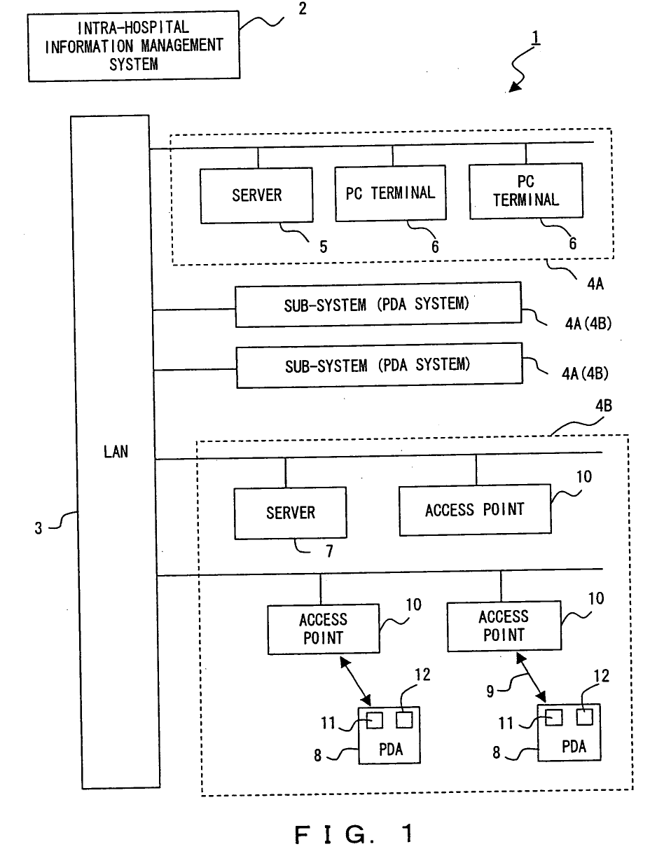

FIG. 1 is a block diagram showing an overall configuration of hospital information system according to a first embodiment.

As shown by FIG. 1, a hospital information system 1 according to the present embodiment comprises an intra-hospital information management system 2 being installed in a medical facility such as a hospital for recording information within the hospital and performing an integrated central management of the information; and a plurality of subsystems, such as a first subsystem 4A and a second subsystem 4B, which are connected with the intra-hospital information management system 2 by way of a wire-line LAN (Local Area Network) 3 and capable of information exchanges by way of the LAN 3.

The first subsystem 4A is connected with a server 5 for performing a control and an information processing and terminals which are personal computers (simply “PC” hereinafter), that is, PC terminals 6, by way of the wire-line LAN 3, respectively.

The PC terminal 6 is a stationary terminal on which the medical staff, such as a nurse, and the users, input data, refer to or confirm the data where the terminal is installed.

Meanwhile, the second subsystem (simply “PDA” hereinafter since the information system uses the PDA system) 4B comprises a server 7 for performing a control and an information processing, PDAs (Personal Digital Assistants) 8, for example, as mobile terminals allowing the medical staff such as a nurse on the move to use and the access points 10 which are data exchange means for enabling the PDA 8 to access through a wireless LAN, with the server 7 and each access point 10 being connected by way of the wire-line LAN 3.

The above described PDA 8 is built in with a wireless LAN card 11, i.e., data input and output means, enabling communications with server 7 wirelessly through wireless LAN and built in with an RF (radio frequency) reader 12 for performing communications in a radio frequency band.

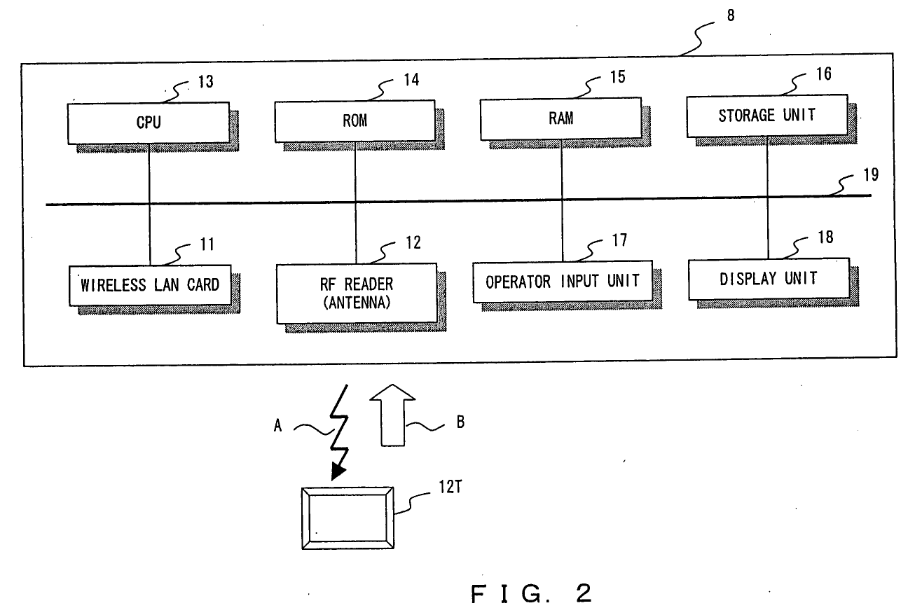

FIG. 2 shows a hardware configuration of the PDA 8, in which the following components are interconnected by a bus 19 so as to be enabled for mutual data exchanges under the control of CPU 13: wireless LAN card 11, RF reader 12, CPU 13, ROM 14, RAM 15, storage unit 16, operator input unit 17, and display unit 18.

The wireless LAN card 11 enables communications with the server 7 in the server system 4B for characters, images and any other kinds of data by way of the access points 10 installed in many corners of the hospital as the base stations.

The RF reader 12 is capable of non-contact communications with a RF tag 12t in the range of several centimeters to several meters depending on the radio field intensity that is discretionally adjustable.

The RF reader 12 is capable of reading data out of, and writing in, a memory built in RF tag 12t through the above noted non-contact communication.

In the present embodiment, however, the RF reader 12 mainly is used for reading identification information out of the memory built in the RF tag 12t.

The RF tag is comprised by a flexible chip of a size as small as 4 mm square, protected by a thin film plastic resin and comprises, for example, CPU, memory, antenna, and electromotive circuit (although they are not shown) to be motivated by a predetermined radio wave “a” in the radio frequency band transmitted from the RF reader 12 so that the electromotive force makes the CPU operate itself to transmit data b stored in the memory to the RF reader 12.

The CPU (Central Processing Unit) 13 is the central processing apparatus for controlling an overall operation of the PDA 8.

The ROM (Read Only Memory) 14 is a memory pre-storing the basic control program executed by the CPU 13.

When initiating the PDA 8, the overall basic control of the operation thereof is performed by the CPU 13 executing the above noted basic control program.

The RAM (Random Access Memory) 15 is used as work memory when the CPU 13 executes various application programs stored in the storage unit 16.

The RAM 15 is a memory also used as the main memory which is utilized as required for storing various data temporarily.

The storage unit 16 is a memory storing and retaining the various application programs and data.

The semiconductor memories, such as EEPROM (Electrically Erasable Programmable Read Only Memory), are suitable for the storage unit 16.

Particularly, an EEPROM is suitable because it is not only capable of rewriting the memory content electrically but also of retaining the memory content without a power supply thereto.

The operator input unit 17 is a touch panel equipped in the display unit 18 for example, is operated by the user of PDA 8 to detect the operation content for transmitting to the CPU 13 which in turn recognizes the user's instruction content corresponding to the operation content.

The display unit 18, is an LCD (Liquid Crystal Display) for example, provides a user of various kinds of information visually through displaying them, which has been transmitted from the CPU 13.

The above described RF reader 12, the operator input unit 17 and the display unit 18 are made capable of inputting and outputting various data by the CPU 13 executing a prescribed application program.

As described above, the PDA 8 comprises a wireless LAN 9 which has a limitation of distance from an access point 10 for communication capability.

Within the accessible range, however, the user of PDA 8 is enabled to access to the intra-hospital information management system 2 for obtaining a later described work schedule data and for displaying the obtained work schedule data on the display of the PDA 8.

The PDA 8 comprising the RF reader 12 is capable of reading identification information contained in a plurality of RF tags 12t simultaneously when reading such identification information out of the widely used RF tags 12t.

This enables the user, such as a nurse, carrying the PDA 8 to input (or read out) identification information such as the practitioner ID, the patient ID of a patient for whom a certain medical treatment is provided and the injection medicine ID accurately, simply and rapidly.

Meanwhile the PDA is waterproof with durability against medicinal solutions, hence configured to be conveniently usable in the places of medical practice.

The above described first subsystem 4A and PDA system 4B are specifically installed as out-patient or ward systems used for registering orders such as an injection, a pharmacy department system used for delivering medicines in accordance with the order registration for injection, et cetera, a medical office work system used for accounting processing relating to the medical practice, a nurse (station) system used for medicine mixing, et cetera, performed by a nurse, et cetera.

Note here that, in the nurse and ward systems where the nurses perform the medical practices, each nurse carrying the PDA 8 is enabled to input and output medical practice information in real time on the spot of medical practice, specifically at the bed side of patient (N.B.: sometimes referred to as “him/her” herein for the subject of medical practice) to perform the medical practice.

As a result, the state of medical practice can be recorded and grasped in real time. That is, the medical personnel are able to record or grasp the medical practice accurately without delaying from the time of the actual medical practice on the spot thereof.

Also, when performing a medical practice on the spot thereof, the medical personnel can confirm the content of work schedule by using the PDA 8 so as to perform the scheduled medical practice, thereafter performing the medical practice to be provided (i.e., scheduled) in an accurate condition, free of error.

The medical personnel is also enabled to record the content of the medical practice on the spot thereof by using the PDA 8, and therefore she or he can record the content of the provided medical practice right after the provision while confirming the content on the spot. This makes it possible to record in an accurate condition, free of mistake.

The medical personnel, when performing the medical practice, are also enabled to confirm or refer easily to the work schedule thereof almost at a discretionary time and place by using the PDA 8, and hence manage the medical practice smoothly.

When the content of work schedule is changed, the medical personnel are enabled to confirm the content thereof on the spot right before the actual work, thus able to respond to the change in the work schedule.

Also, having performed the medical practice as such, the medical personnel are able to record the actual practice accurately and in real time, enabling the medical personnel to improve the system appropriately by analyzing the data afterwards.

Incidentally in FIG. 1, a subsystem may be made by mixing the components of the first subsystem 4A and PDA system 4B. Specifically, the PDA system 4B may further comprise a stationary PC terminal 6 for instance.

Next description is about the present embodiment which deals specifically with a nursing assist function for assisting the medical practice performed by a nurse, that is, the nursing practice.

The nursing assist function is the one for assisting the medical practice relating to nursing such as “injection (including drip infusion)”, “nursing”, “treatment” and “sample test”, et cetera.

The above noted “injection” is a medical practice provided by a nurse injecting for a patient. The “nursing” is a medical practice provided by a nurse such as measuring the patient's body temperature, cleaning the patient's body, training a tub bathing, et cetera. The “treatment” is a medical practice of nursing procedure such as removing a catheter. The “sample test” is a medical practice performed by a nurse such as blood test and bodily fluid test.

Incidentally, the “injection” includes the one called “one shot injection” requiring very short time from the start to completion and the other such as “drip infusion (or injection)” taking a certain period of time from the start to completion, as described later.

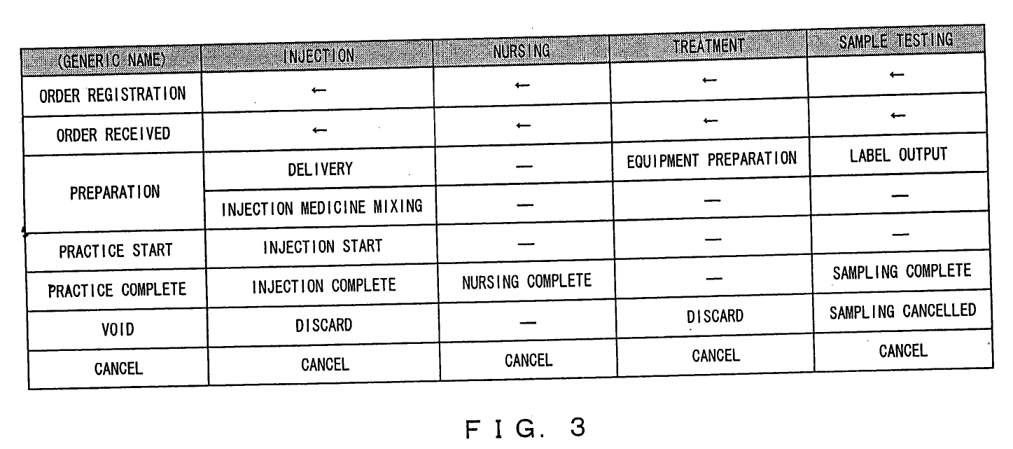

FIG. 3 is a table of medical practices ranging from injection to sample test and a detailed content of work schedule ranging from an order registration to practice of the medical practice.

In the above described medical practice, first, with a doctor issuing an order instruction, the terminal 6 instructs the order registration to the intra-hospital information management system 2.

Receiving the instruction, the intra-hospital information management system 2 automatically generates a work schedule data for each step corresponding to the order registration, from the order receiving step through the cancellation step as shown by FIG. 3 and register the automatically generated data in a data base therein.

That is, the intra-hospital information management system 2 comprises a function of generating work schedule data and storing the generated work schedule data in a database therein.

And a nurse is enabled to download for obtaining the work schedule data and store (i.e., record) it in the storage unit of the PDA 8 by accessing to the above described data base comprised by the server 7 by using the portable PDA 8.

And the nurse is able to refer to the work schedule data and grasp the progress by operating the operator input unit 17, e.g., a touch panel, of the PDA 8 so as to have the LCD display et cetera, i.e., display unit 18, display a list of the work schedule data stored in the storage unit.

And the nurse can also refer to the content of the work schedule data and grasp the progress from the PC terminal 6. Incidentally, an order registration is usually performed by a PC terminal 6 in the out-patient system, et cetera.

As shown by FIG. 3, each medical practice ranging from “injection” to “sample test” is performed by the steps of order registration, receiving order . . . et, cetera.

For instance, as described later, the medical practice of injection is performed in the steps of order registration for injection, followed by receiving the order responding to the order registration, requisition of medicine as a preparation for the injection, mixing the injection medicine, starting injection and completing the injection; and sometimes including the order cancellation due to a broken injection medicine bottle or the injection order being canceled (i.e., order change) due to a change in the condition of the patient, et cetera.

Meanwhile, in the case of nursing, order registration, receiving the order, et cetera, are generated as the same as for injection shown in its left column, as indicated by arrows meaning the same as the ones which are pointed thereby.

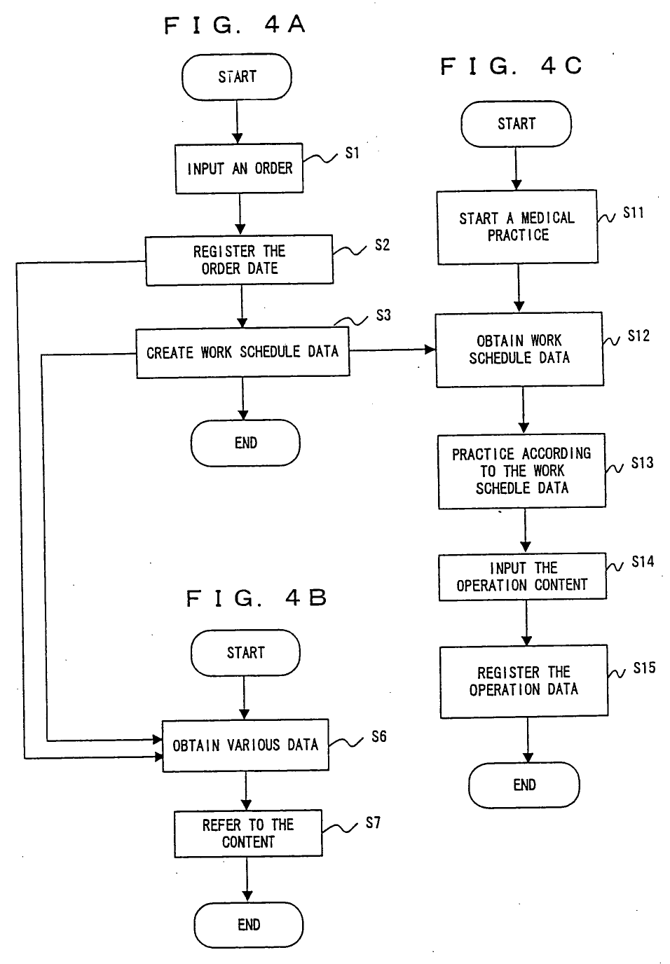

FIGS. 4A, 4B and 4C are flow charts respectively showing contents of operational procedures at an order registration, reference and practice which are common to the overall system. FIG. 4A shows the operation at the order registration; FIG. 4B at the reference; and FIG. 4C at the practice. In FIG. 4A, an order relating to each medical practice is instructed and inputted in the PC terminal 6 comprised by the out-patient system or ward system at times (step S1) (simply “S1” hereinafter when written in parenthesis).

The intra-hospital information management system 2 registers the order data therein (S2).

When the intra-hospital information management system 2 thus registers the order data therein, generates the work schedule data in the steps shown by the direction of column of the table shown by FIG. 3 (S3).

The first subsystem 4A or the PDA system 4B obtains the work schedule data (S6 in FIG. 4B).

Then, the instruction content and schedule content of the order are referred to (S7), making it possible to perform the medical practice (i.e., medical operation) based on the instruction and schedule of the order.

Then, when starting an operation of the medical practice actually (S11 in FIG. 4C), the nurse obtains the work schedule data by using the portable PDA 8 (S12).

Then the nurse goes to the operation spot of the medical practice such as the bed side according to the obtained work schedule data to provide the medical practice to the patient who is in the operation spot (S13).

Then, the nurse performs an input operation (i.e., work) of the practice content at the time of providing the medical practice by using the PDA 8 (S14) to register the operation data to the intra-hospital information management system 2 without delay (S15).

Note that the operation data registration also registers an error log as described later. Also, if there has been a change in the order content or the work schedule data, the change is also registered.

By this, the changed work schedule data is registered as such in the intra-hospital information management system 2 immediately.

Incidentally, order data, the schedule data developed therefrom, and the operation data are configured by XML (extensible Markup Language) files, et cetera which are defined by a tag with a hierarchical structure for example. The XML is an extension of HTML (Hyper Text Markup Language) as well known and therefore it will not be described herein.

The nurse is enabled to refer to the order data, work schedule data and actual operation data by the PC terminal comprised by the first subsystem 4A, et cetera, as required so as to grasp the content, schedule, progress, actual operation content, et cetera, of an order at a discretionary time.

The nurse is also enabled to grasp the content, schedule, progress, actual operation content, et cetera, of an order freely at a discretionary time and place by using the portable PDA 8.

And, when providing the medical practice to the patient at the bed side which is the operation spot by the work schedule, the nurse is also enabled to input the content of scheduled medical practice by using the portable PDA 8 so as to register in the intra-hospital information management system 2 in real time and accumulate or renew an accurate information relating to the medical practice.

Also in the process, the information indicating 5W IH (who, where, what, why, when and how) is recorded in addition to the time as described later, and therefore the medical personnel can easily improve the system by analyzing the information in detail (because information required for later analysis is near complete, enabling a detailed analysis).

The next description is about a system for the data input and output by the above described first subsystem 4A or PDA system 4B in order to enable a comprehension of progress, operation contents, et cetera, of the medical practice.

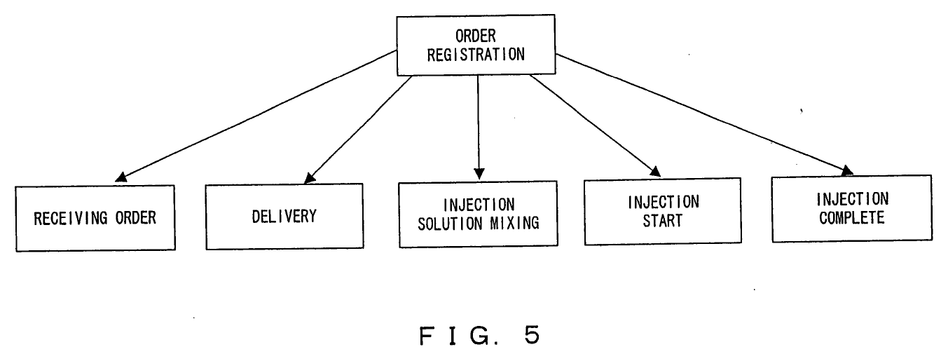

FIG. 5 shows a content of work schedule generated based on a registration of injection order. In the case of injection, a registration of the order prompts to generate a work schedule data as follows:
(1) Receiving order in the applicable ward (FIG. 5 simply shows “receiving order”);
(2) Delivery the medicine from the pharmacy dept. (FIG. 5 simply shows “delivery”);
(3) Mixing the injection medicine solution (mixing injection medicine) (FIG. 5 simply shows “mixing”);
(4) Starting the injection for the patient in the ward (FIG. 5 simply shows “injection start”); and
(5) Completing the injection for the patient in the ward (FIG. 5 simply shows “injection complete”).

A completion of all the work schedules constitutes the completion of the injection order.

Each of the above described work schedules are performed in the first subsystem 4A or PDA system 4B, the process of which is as follows:
“Receiving order”: performed by a nurse in the ward system;
“Delivery”: performed by a pharmaceutical chemist in the pharmacy department system;
“Mixing injection medicine”: performed by a nurse in the ward system; and
“Injection start” and “injection complete”: performed by a nurse in the PDA system 4B.

Note that the injection herein defines both the drip infusion and one shot injection. Since the drip infusion takes time for administering, the start and completion operations are usually separate.

The one-shot injection on the other hand takes one practice to complete, therefore the start and completion are almost simultaneous.

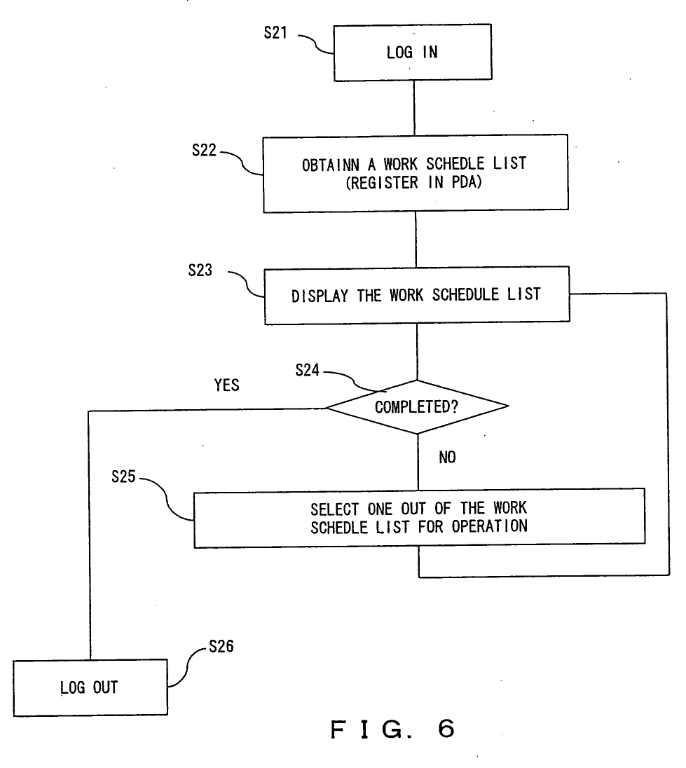

FIG. 6 is a flow chart showing a content of operational procedure of the PDA system at the time of performing an injection according to the registration of the injection order.

Note that the operational procedure is processed by way of communications between the server 7 comprised by the PDA system shown in FIG. 1 and the PDA 8 shown in FIGS. 1 and 2.

The PDA system 4B utilizes a portable PDA 8 enabling a nurse to carry the PDA 8 to a bed side, confirm the work schedule to be provided thereat in the ward and input the actual operation data, hence being used for inputting the actual operation data of the injection start and completion.

Usually the nurse first obtains a work schedule to be provided for the patients assigned to her during the work shift by using the PDA 8 in order to grasp the schedule for the day.

And the nurse dispatches herself to the bed side of the patient at the scheduled time, performs each of the scheduled medical practices and inputs the operation data through the PDA 8. The following description is about a detail of the operation in accordance with FIG. 6.

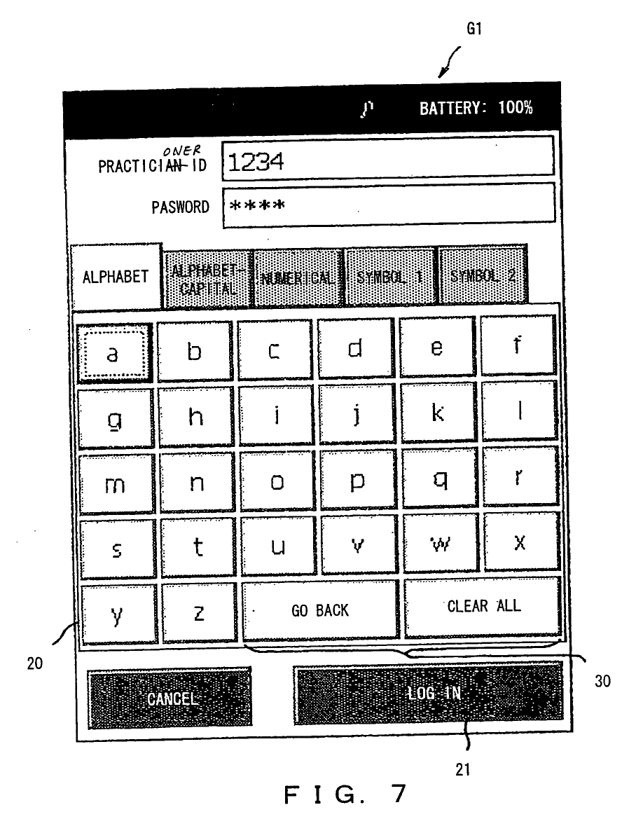

Note that the display unit 18 on the PDA 8 displays the screens shown by FIGS. 7 through 14 during the operational procedure as follows: log-in screen G1, work schedule list registration screen G2, patient specification registration screen G3, work shift ward specification screen G4, work shift selection screen G5, work schedule display screen G6, today's practice display screen G7 and actual practice content display screen G8.

In FIG. 6, the nurse first logs in (S21) which brings forth the log-in screen G1 shown by FIG. 7 in the display unit 18 of the PDA 8 when switching on the PDA 8.

In the log-in screen G1, the nurse inputs the practitioner ID and password of the practitioner of the injection, which is performed by the RF reader 12 comprised by the PDA 8 reading the identification information recorded by the RF tag built in on the name plate, et cetera, worn by the staff performing the medical practice.

Then the ID data readout of the identification information is inputted to the practitioner ID column. As such, the RF reader 12 comprised by the PDA 8 makes it possible to input the practitioner ID accurately by a simple operation.

And the password can be inputted by touching the touch panel of the PDA 8 with a finger or a pen when the display shows a key board 20 for inputting a letter, numeral or symbol.

Thus completing an input of the practitioner ID and password followed by pressing the log-in button 21 initiates a collation by sending the practitioner ID and password to the intra-hospital information management system 2 by way of the server 7.

Then the log-in is achieved if the practitioner ID and password are correct. Incidentally, if a wrong password has been inputted, the staff can erase the input by touching the “return” or “clear all” button to input it again.

When achieving the log-in, the processing proceeds to obtaining the work schedule list (i.e., registering it in the PDA 8) shown by FIG. 6 (S22).

As the processing proceeds to obtaining the work schedule list the PDA changes displays to the work schedule list registration screen G2 which displays a selection between “register by specifying patient name” and “register by specifying ward” (N.B.: the display screen of the PDA 8 such as the G2 simply abbreviates as “work list” for a work schedule list for simplicity, et cetera).

That is, the nurse selects to either obtain a work schedule list by specifying the patient or obtain a work schedule list for all-applicable patients by specifying the area where the patients are such as the ward.

As described above, the present PDA system provides a convenient selection screen by allowing the nurse performing a medical practice either to select, or narrow down to, a work schedule list suitable to her assignment.

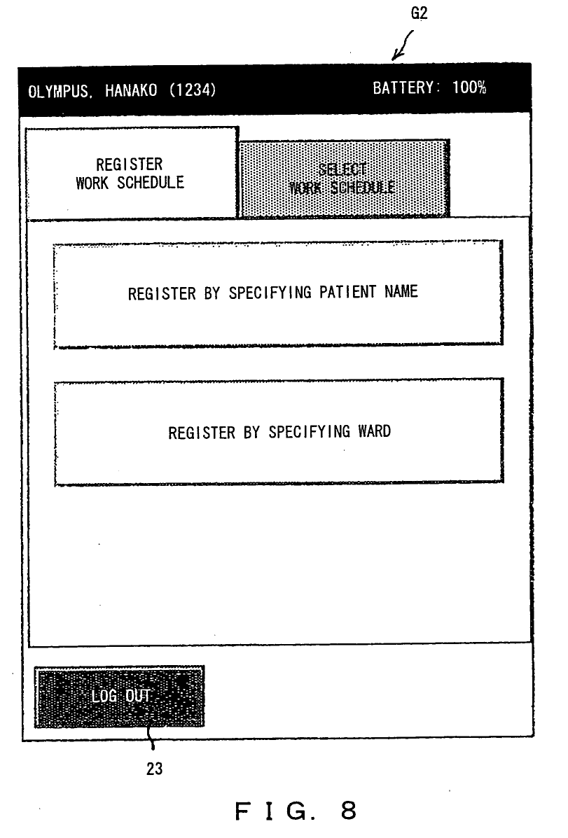

The nurse can also interrupt the work by pressing (i.e., touching) the logout button 23 shown by FIG. 8.

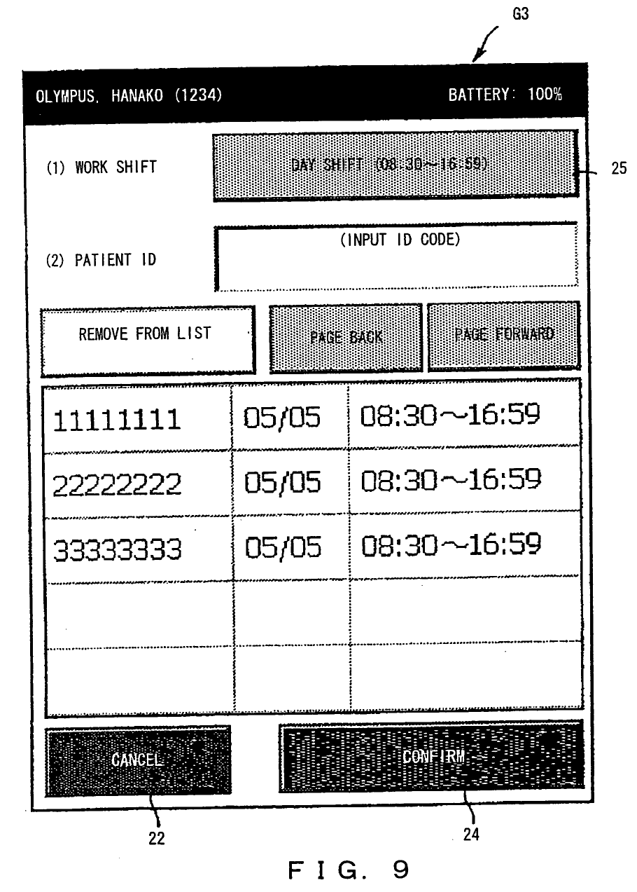

In FIG. 8, pressing the “register by specifying patient name” for instance changes the display screen of the PDA 8 changes to the patient specification registration screen G3 shown by FIG. 9 which shows input columns for (1) work shift and (2) patient ID so that the nurse specifies a work shift applicable to her (i.e., the day shift, 8:30 to 16:59, in the example shown by FIG. 9) and obtains a patient ID by reading the identification information of the patient out of the RF tag 12t built in the wrist band worn by the patient by using the RF reader.

Then the data corresponding to the identification information is obtained from the work schedule data registered in the intra-hospital information management system 2. As such, the patient specification registration screen G3 lists all the patients as the subjects of medical practices.

The patient specification registration screen G3 shown by FIG. 9 shows a state of obtaining the work schedule list for three patients (i.e., three patients by the respectively assigned ID numbers 11111111, 22222222 and 33333333) during the work shift (08:30 to 16:59).

Pressing the confirmation button 24 in the above described state formally registers the work schedule list for the three patients in the PDA 8. And touching the cancel button 22 can cancel a registration of the work schedule list.

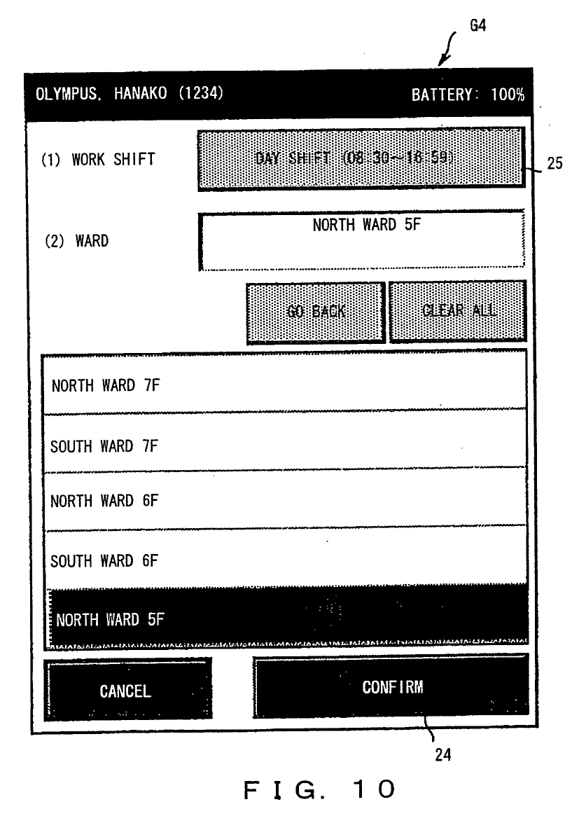

In the meantime, pressing the “register by specifying ward” in the work schedule list registration screen G2 will open the work shift ward specification screen G4 shown by FIG. 10, which shows input columns (1) work shift and (2) ward.

The nurse specifies the applicable work shift and ward (e.g., North Ward 5F) and presses the confirmation button 24. By this, the PDA 8 will obtain the work schedule data for all the patients in the specified ward.

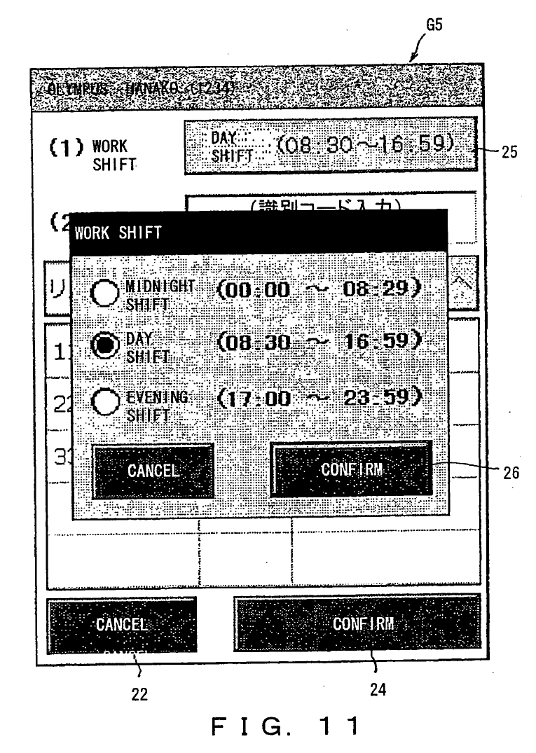

The input column, (1) work shift, for each of FIGS. 9 and 10 is configured as the work shift button 25 according to the present embodiment, and pressing the work shift button opens an overlapping window for selecting a work shift, that is, the work shift selection screen G5 as shown by FIG. 11.

Incidentally, while the shift hours are changeable according to the setting, the description of the present embodiment defines the work shifts as follows: 0:00 to 8:29 for the midnight shift, 8:30 to 16:59 for the day shift and 17:00 to 23:59 for the evening shift.

In this case, the log-in time will determine the default setting (i.e., initial setting) at the center of the three shift hours side by side in the display so as to make it easy to select the applicable shift.

Also in this screen, pressing the confirmation button following selecting the work shift will make it possible to obtain a work schedule of the selected shift.

Note that the obtained work schedule data in this case is so as to obtain additional work schedule by adding about one and a half hours plus the designated work shift hours in order to compensate for a shift (such as delay) in work schedule around the time of shift change and consider a handover between the medical staff of the respective work shifts.

Furthermore, the work schedule data for injection is obtained up to 24 hours prior to the work shift hours.

Although the description will be given later, this is because there is a period of drip infusion “being administered” between the two medical practices, i.e., injection start and injection completion, requiring the practice of completion for a drip infusion having started in the previous work shift during the current work shift hours.

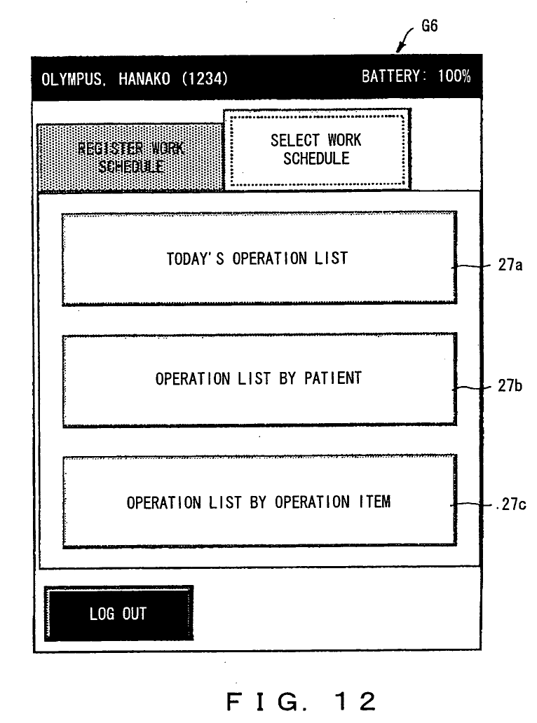

Now back to FIG. 6, finishing the obtainment of work schedule list in step S22, the processing proceeds to displaying the work schedule list (S23) which prompts the PDA 8 to display the work schedule display screen G6 shown by FIG. 12.

The work schedule display screen G6 shown by FIG. 12 is for selecting a way to display a work schedule list, showing the three selection buttons for the respective items, i.e., 27a for “today's operation list”, 27b for “operation list by patient” and 27c for “operation list by item”, with “log out” showing at the bottom of display screen.

Selecting the selection item 27a, “today's operation list”, displays all the work schedule list items registered in the PDA 8.

Selecting the selection item 27b, “operation list by patient”, displays the work schedule list for the specified patient only from among them registered in the PDA 8.

And selecting the selection item 27c, “operation list by item”, displays the work schedule list of the specified medical practice category only from among them registered in the PDA 8.

As described above, storing the work schedule data once in the storage unit 16 of the PDA 8 and allowing a list display (i.e., a catalog display) of the work schedule data to change reduces the frequency of query to the intra-hospital information management system 2, rendering effects of lightening the traffic relating to the communication and shortening the processing time.

And the work schedule data obtained by the PDA 8 enables the nurse to display the required work schedule data selectively, et cetera, while saving power therefor. Specifically, it is possible to make the PDA display the work schedule data only relating to the specified patient, et cetera, by operating the PDA 8 to specify the work shift, patient and work items without accessing to the data base in the intra-hospital information management system 2 by way of the server 7, that is, without making the wireless LAN card 11 active and in a power save state putting the wireless LAN card 11 inactive (N.B. The CPU comprised by the PDA 8 saves power by putting the wireless LAN card inactive when requiring no connection with the server 7 by an operating instruction).

Again back to FIG. 6, a modified configuration may be, after the log-in by the PDA 8 to access the data base comprised by the intra-hospital information management system 2 in step S21, to display the work list in step S23, instead of obtaining a work schedule list in step S22.

Particularly when wishing to confirm the latest information about a certain item only, such configuration enables a confirmation of the target information in a short time. Also, the more choices for the medical staff the better suitable configuration of displaying the work schedule data they can obtain or confirm.

As described above, the present embodiment makes it possible to select the display content of work schedule data, in which the selection by the obtaining means, i.e., the PDA 8 as mobile terminal, for the work schedule data is made possible and likewise by the commanding side of the display 18, thereby responding to the wide range of the PDA 8 users.

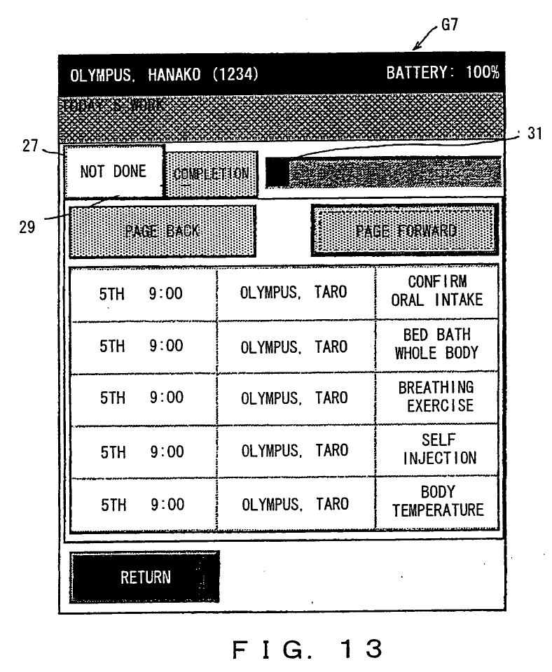

In the work schedule display screen G6 shown by FIG. 12, selecting the selecting item 27a, “today's work list”, will display the today's operation display screen G7 shown by FIG. 13.

The today's operation display screen G7 is configured to have either one of two buttons, i.e., “not done” button 28 for showing the work schedule list yet to be done or “completion” button 29 for showing the completed work schedule list.

That is, it is possible to show comprehensively what is not done and what is complete among the work schedule list, since pressing the “not done” button 28 will show what is not done, while pressing the “completion” button 29 will show what is completed.

There is also a display part called progress bar 31 on the top right corner of the screen, indicating the ratio of completed items to the work schedule items by a bar gauge. When the dark solid area of the bar gauge reaches at the right end, the work schedule items are all completed. The gauge shows a result of calculating the ratio of number of the completed items to the total scheduled items.

Each work schedule is shown by one line of the displayed list when pressing the “not done” button 28, showing the scheduled time, the patient name and the work name. Selecting one line of the scheduled list will display a screen for later described operation input.

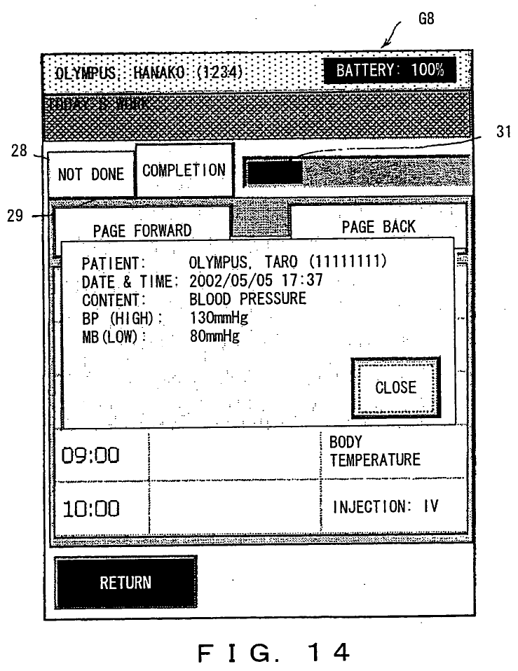

Meanwhile, the scheduled list that has been completed moves to the list which is displayed by pressing the completion button 29, and if one line of the list displayed by pressing the completion button 29 is selected, the content of completed operation (i.e., operation data) such as the actual practice content display screen G8 shown by FIG. 14 will be overlaid on the today's practice display screen G7 shown by FIG. 13.

FIG. 14 exemplifies a display screen showing an input result of measuring blood pressures (high) and (low).

In the present embodiment, since the not-done work schedule list is shown, meaning the processing is incomplete (“no” for S24), one of the work schedule lists to perform the selected medical practice (S25) is selected.

In this event, having performed the medical practice, the nurse inputs the actual operation on the spot thereof by using the portable PDA 8.

Having inputted the content of the actual operation, the content thereof is transmitted to the intra-hospital information management system 2 by way of the server 7.

Then the medical practice is registered in the database as the completed medical practice having been moved from the work schedule data, followed by notifying back to the PDA 8 upon completion of the registration processing in the database.

The information relating to the medical practice is thus accumulated in the database comprised by the intra-hospital information management system 2 correctly in real time. Note that the information registered in the database, while the detail thereof is described later, is not one simply containing a clock time, but a detailed piece of information.

Having received the above noted notification of completion, the medical practice displayed by selecting the not-done button 28 is now completed and the content of the work schedule now moves to the list data to be displayed by pressing the completion button 29.

Subsequently, now back to FIG. 6, going back to step S23 and repeating the process of selecting one of the work schedule lists to perform the selected medical practice will result in a completion of performing the scheduled medical practices.

Incidentally, in the above described display of work schedule list, when completing the all scheduled medical practices (“yes” for S24), a nurse presses the “log off” button to end the processing (S26).

In the end of the processing, error log information automatically stored and accumulated in a certain storage area of the PDA 8 as described later is transmitted to the server system together with the ending notification.

As described above, the present embodiment enables the nurse as a practitioner of medical practice, carrying the PDA 8, to confirm the work schedule services to be done by herself by having the display unit 18 comprised by the PDA 8 almost at discretionary time and spot.

In this case the not done work schedule services are collectively displayed by pressing the not-done button 28, and the displayed work schedule services by pressing the not-done button 28 are then performed on the respective spots, followed by inputting the actual practice contents will get registered in the data base comprised by the intra-hospital information management system 2.

In addition to the above, the list disappears from the one displayed by pressing the not-done button 28 to move to the list data to be displayed by pressing the completion button 29 in the display on the PDA 8.

This enables the nurse to perform the work schedule operations displayed by pressing the not-done button 28 on the respective operation spots where the patients are and thereby achieve the work schedule operations correctly, smoothly and efficiently.

The reason why the medical practices are made possible based on the above described work schedule and instruction items at the order is that the work schedule data (i.e., file structured by XML) contains the necessary information. The following description deals with the content of work schedule data and the operation of performing an injection.

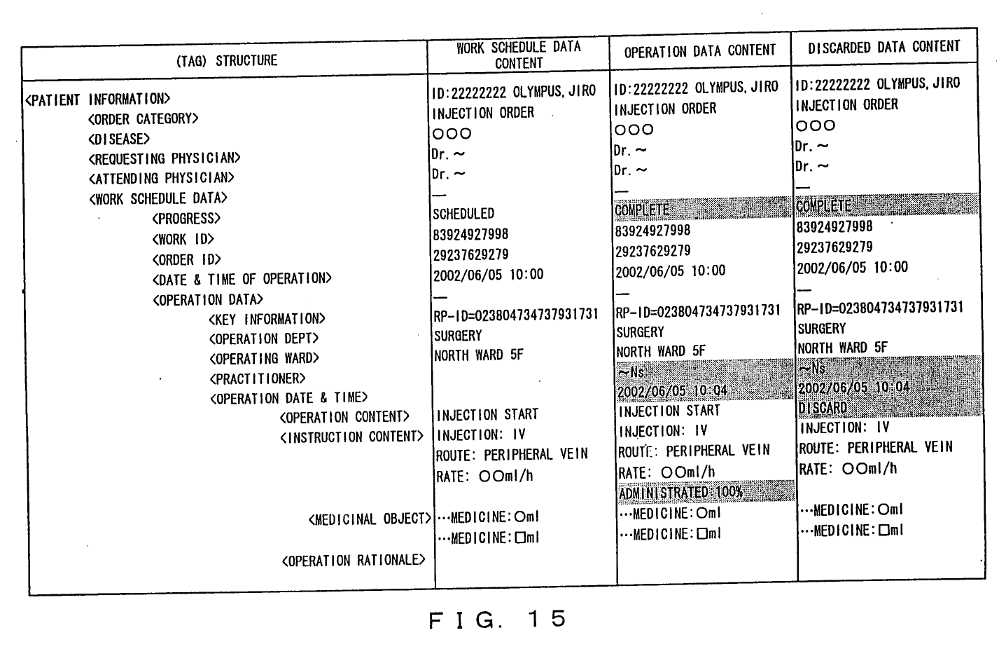

FIG. 15 shows a structure of work schedule data. The information registered in the database is not one containing only a clock time, but a detailed piece of information.

That is, the necessary information for respective medical practices in terms of so called 5W 1H (i.e., who, where, what, why, when and how) to begin with, enabling the nurse, having obtained the work schedule data, to refer to the instruction content specified at the order for performing the medical practice.

One order can register a plurality of injection schedules (abbreviated as “RP” in FIG. 15) and “a plurality of appearance possible” (i.e., set for a repetition) is enabled for tag data for <work schedule data>, <operation data>, <instruction content> and <medical object>.

The “content of operation data”, the third column from the left of the table shown by FIG. 15, shows the structure of operation data to be registered from the PDA 8 by way of the server 7 as a result of practicing an injection.

The data structure is the same as the work schedule data, containing the information indicating the 5W 1H performed in each medical practice. Unlike the work schedule data, the practitioner, the actual operation time of day, the administered amount of medicine, et cetera, are set in accordance with the actual operation content.

The third column from the left in the table shown by FIG. 15 indicates the example. The shaded areas are the added or changed data according to the actual operation content.

The data for <progress> of the work schedule data is changed from “scheduled” to “complete” and <practitioner>, <operation date/time> and <administered amount> are added according to the operation content, thus becoming the operation data.

Incidentally the name of the practitioner (Hanako Olympus) is abbreviated as Nurse Ns in FIG. 15.

Also described later, the right most column of FIG. 15 shows a data structure when a work is discarded, in which the shaded areas will become the changed data vis-a-vis the content of the work schedule data.

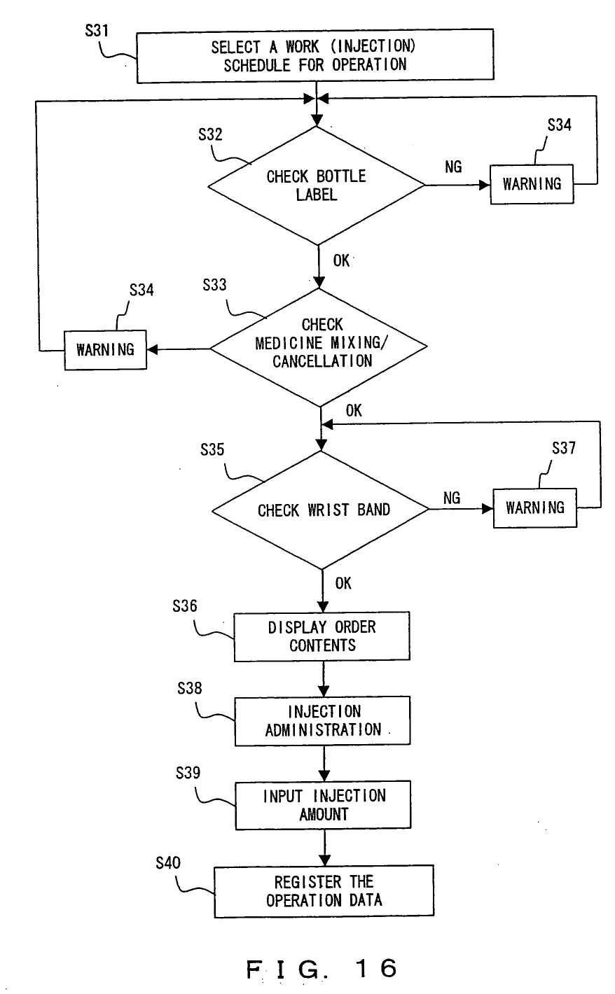

FIG. 16 is a flow chart showing a detailed operation content for carrying out an injection (i.e., administering) as an example. The following description is about the operation flow.

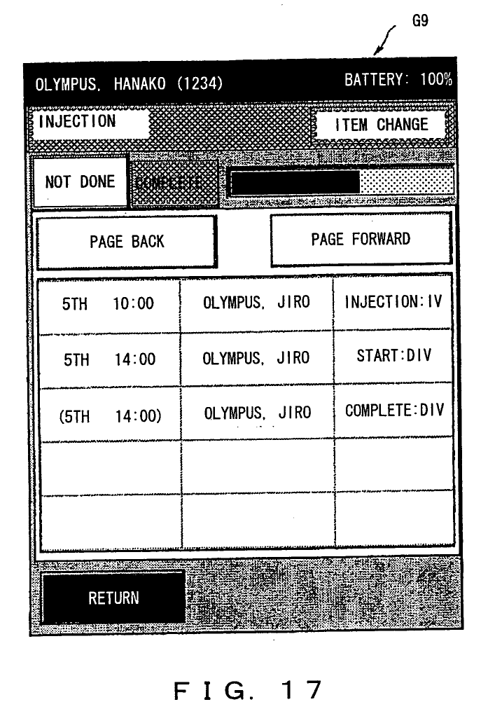

Incidentally, during the operation flow, the display unit of the PDA 8 displays the following screens shown in FIGS. 17 through 22: work schedule screen G9, bottle label check screen G10, warning display screen G11, wrist band check screen G12, injection confirmation screen G13 and administered amount input screen G14.

This operational procedure is also processed by communications between the server 7 comprised by the PDA system 4B shown by FIG. 1 and the PDA 8 shown by FIGS. 1 and 2.

In FIG. 16, a work schedule to perform is selected (i.e., injection in the example) (S31).

For the above, a medical service list by item shown by FIG. 12 for instance is selected, which brings about a state to display a work schedule only relating to injection. FIG. 17 shows the work schedule screen G9 displayed in the state to display a work schedule relating to injection.

In the work schedule screen G9, specifically if taking the example schedule of “Fifth (of a month), 10:00 am, Mr. Jiro Olympus, injection: IV”, scheduled for the fifth, 10 am, the information set up in the work schedule data is the ones as shown by the second column of the table shown by FIG. 15.

Now back to FIG. 16, if the nurse selects the line “Fifth, 10:00 am, Mr. Jiro Olympus, injection: IV”, the processing checks the bottle label (S32).

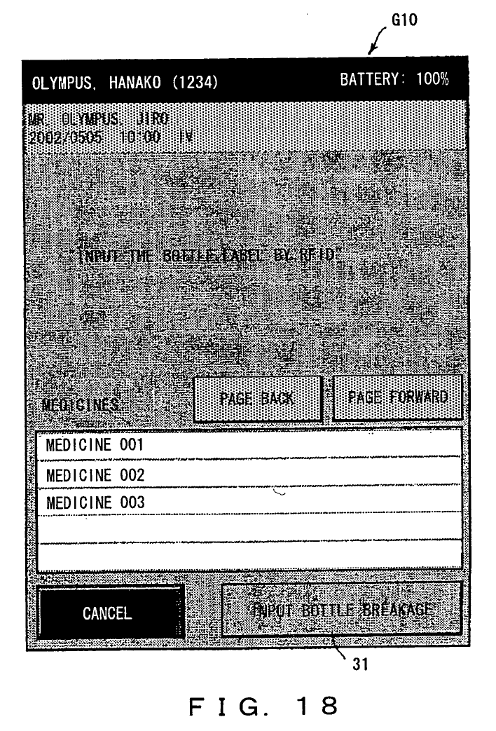

And the PDA 8 which the nurse is carrying displays the bottle label check screen G10 shown by FIG. 18 in this case. The bottle label check screen G10 shows messages such as “Input the bottle label by RFID” and also all medicines (i.e., names of medicines and the used capacities) mixed in the injection medicine bottle.

Therefore the nurse lets the RF reader 12 of the portable PDA 8 read in the identification information and other information (“tag data of injection medicine bottle”hereinafter) recorded by the memory of RF tag embedded in the bottle label of the injection medicine bottle.

Then, the processing collates the readout tag data of the injection medicine bottle with the RP-ID within the work schedule data for identity. If the collation indicates an identity with the RP-ID within the work schedule data, a mixing/cancellation check shown by FIG. 16 (S33) is performed.

On the other hand, if the read-in tag data of the injection medicine bottle does not identify with the RP-ID within the work schedule data, notifies a warning (S34) followed by returning to step S32.

If the injection medicine bottle is somehow wrong, the tag data of the injection medicine bottle does not identify with the RP-ID, thus the mistake is detected and a warning notification is enabled by displaying a warning message and sounding a warning beep.

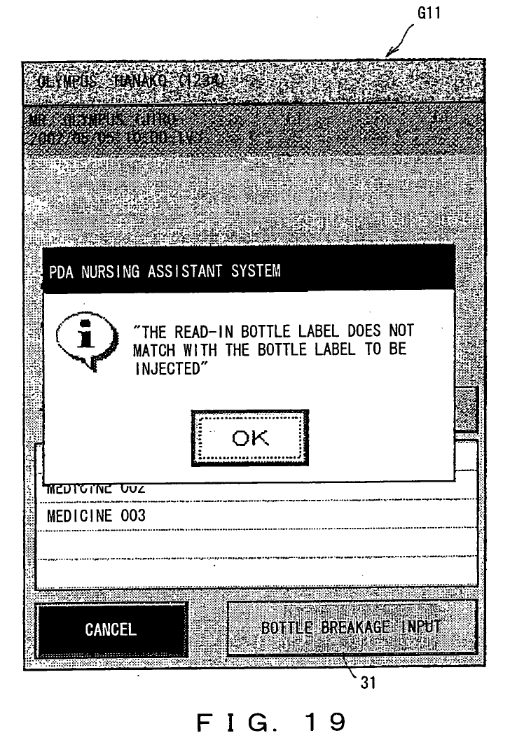

FIG. 19 shows the warning display screen G11 for this case, which exemplifies a warning message such as “Read-in medicine bottle label does not match with the medicine bottle label to be injected”, et cetera.

Having thus completed the bottle label check, that is, the injection medicine bottle check by reading out the tag data and proceeding to a mixing/cancellation check processing in the step S33, an injection medicine mixing operation data must be registered if an input for the injection medicine mixing is done, whereas an order cancellation must be registered if the order has been cancelled.

Therefore, the injection medicine mixing operation data is obtained from the intra-hospital information management system 2 to check whether or not the tag data of <progress> indicates “completed”, and it is checked whether or not an order cancellation is registered.

Then, if the injection medicine mixing has not been done, the warning is issued in step S34, such as sending a message “injection medicine mixing has not been confirmed”, while if the order has been cancelled, the warning will be issued, such as “the order has been cancelled”, followed by returning to the processing of the step S32.

Here, the reasons for confirming whether or not a confirmation of injection medicine mixing operation is done and whether or not the order has been cancelled are as follows.

The fact that the confirmation of injection medicine mixing operation is not done is that the tag data of the injection medicine bottle and pieces of tag data of respective medicines are not checked for collation. Therefore, it is necessary to confirm whether or not the injection medicine mixing has been confirmed by the system in order to make certain that the prescribed medicines are mixed and put into the injection medicine bottle.

The hospital information system according to the present embodiment controls not to allow inputting a modified order because it is difficult to respond to an order modification immediately before the administration, even if the order modification input is possible immediately theretofore.

Also, if a change of medicine occurs after the injection medicine mixing, the medicine already mixed will be wasted (incidentally, an order modification immediately before the administration can be handled by an order cancellation, new emergency order and bottle discarding processing.

Therefore, if the tag data of the injection medicine bottle collates with the work schedule data code (i.e., RP-ID), it is possible to make certain that the confirmation input for the injection medicine mixing is confirmed and, if the order is not cancelled, then the work schedule data is neither modified nor cancelled and therefore the operation is to be carried out.

Once confirming that the operation is to be carried out through the above described check for mixing/cancellation, the processing performs a patient wrist band check as shown by FIG. 16 (S35).

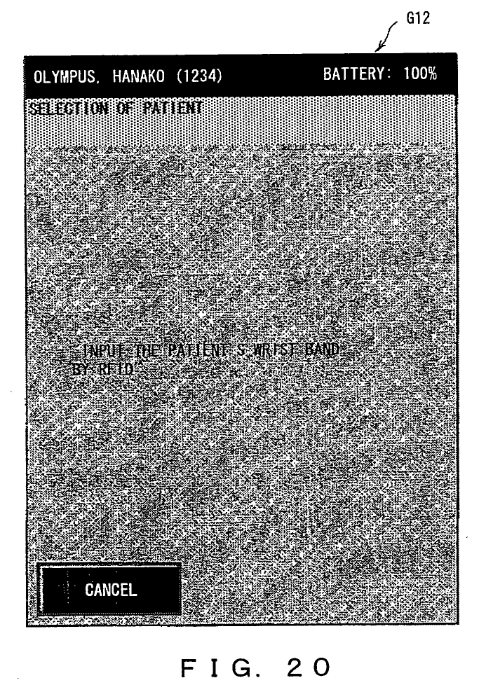

FIG. 20 shows the wrist band check screen G12 for checking the patient wrist band.

Once passing the bottle label check and injection medicine mixing/cancellation check as described above, the display of the PDA 8 changes to the wrist band check screen G12.

In the wrist band check screen G12, a message such as “Input the patient wrist band by RFID” is displayed.

The nurse then lets the RF reader 12 of the PDA 8 read the tag data out of the RF tag embedded in the patient wrist band to collate with the patient ID in the work schedule data.

If collated for identity, it proceeds to the step S36 shown by FIG. 16. If not collated for identity, on the other hand, it proceeds to the step 37 to issue a warning, followed by going back to the step S35.

If the patient for treatment is mistaken, the tag data of RF tag of the wrist band does not identify with the patient ID, the mistake is detected for enabling a warning notification by a warning message and alarm.

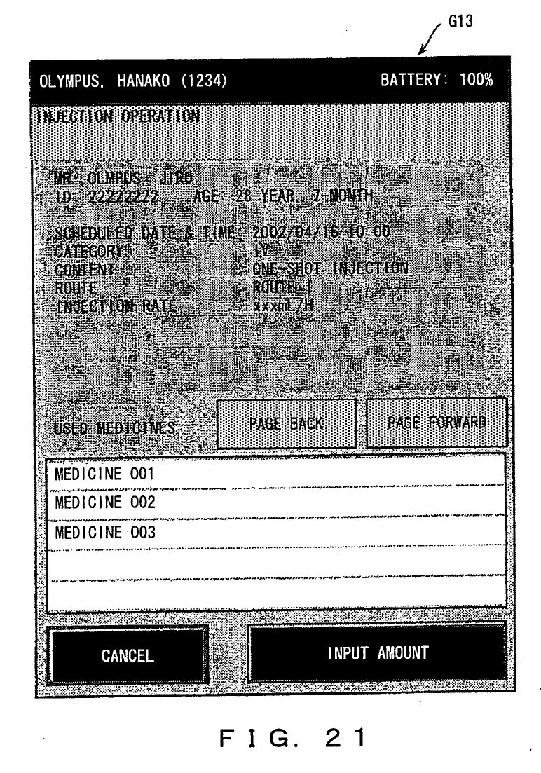

When completing the wrist band check in the step S35, the PDA 8 display changes to the order content (S36), that is to the injection confirmation screen G13 shown by FIG. 21.

The injection confirmation screen G13 displays the instruction content which has been specified at the time of the injection order, that is, the patient information, the scheduled date and time, the category/contents/route/injection rate of the injection and the information about the mixed medicines, et cetera.

Having confirmed the instruction content of the order, the nurse administers the injection (S38 shown by FIG. 16).

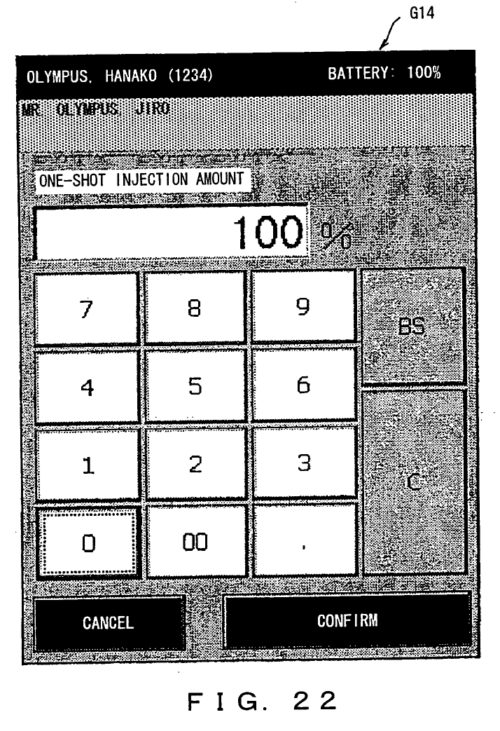

And upon completing the injection, the nurse inputs the actual administered amount (S39). FIG. 22 shows the administered amount input screen G14 for inputting the actual administered amount displayed by the PDA 8.

The administered amount input screen G14 closely resembles a calculator with input buttons, enabling the nurse to input a percentage of actual administered amount by a percentage (N.B.: the default display shows “100%” so as to allow the “confirm” button if there is no change thereof).

Inputting the actual administered amount prompts the PDA to initiate a registration processing for the operation data so as to be registered in the intra-hospital information management system 2 by way of the server 7 (S40 shown by FIG. 16).

Note that the configuration allows a record of accurate administered amount since the above described injection does not necessarily inject all the medicine content in the bottle, because a change in the patient condition, the order instruction, et cetera, may cause to stop the injection at 50% or 75%. Here, the input is done inunit of percentage, the unit maybe “milliliter” based on the injected amount.

The next description is about the operation for bottle label check in the step 32 shown by FIG. 16 in further detail.

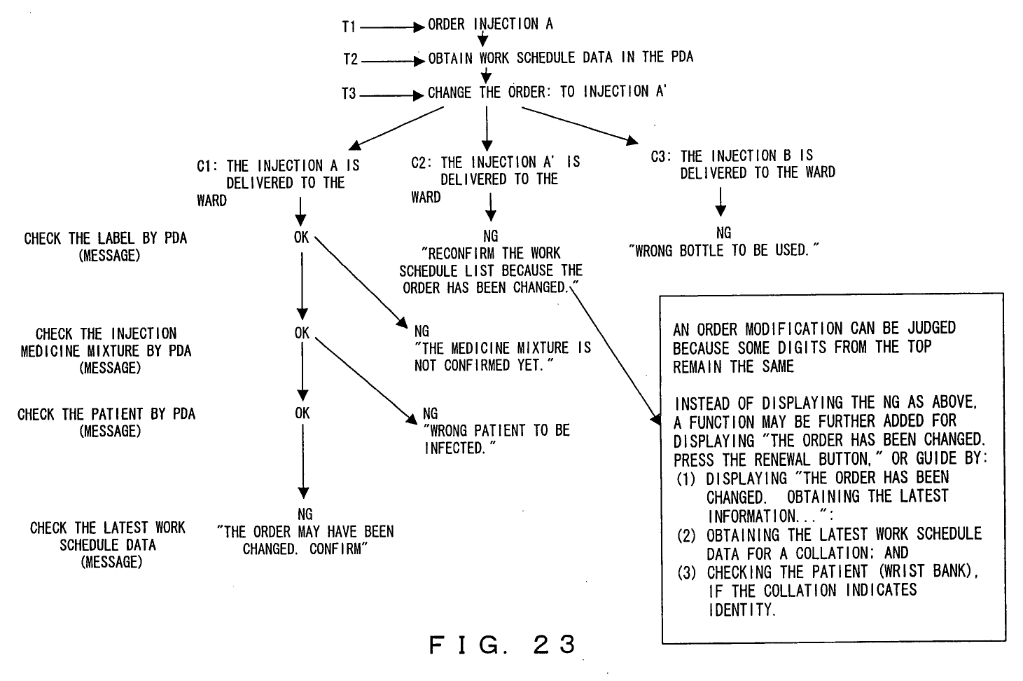

FIG. 23 is a flow chart of checking bottle label in operating an injection, which incidentally shows the operation content in the case of the order content being changed.

Generally speaking, orders for injection, et cetera, are sometimes modified. Specifically, a modified order registration may be made through the PC terminal 6, et cetera, comprised by the first subsystem 4A.

If a change in the content of an order is made, the medical practice must be performed in compliance with the changed content.

If the medical practice is going to be performed based on the content prior to the modification, et cetera, the mistake must be checked, a warning must be displayed, et cetera. The processing of bottle label check shown by FIG. 23 corresponds to such a consideration.

That is, FIG. 23 shows a system capable of checking if the order content is modified. The following describes a case where the kind of injection is changed to A′′(i.e., A-dash) after the injection order A.

If the order for injection A is registered at the clock time T1, followed by the PDA 8 obtaining the work schedule list at the time T2 for instance, followed by issuing an order modification at the time T3, the PDA 8 ends up with not registering the modified content (i.e., the order being changed to A′).

Even in such a situation, however, the hospital information system 1 according to the present embodiment is furnished with a function for preventing a wrong medical practice.

If the injection is tried to be carried out in the above described situation, three cases can be considered as follows. That is, C1: the injection A as per the order prior to the order change is delivered to the ward; C2: the injection A′ as per the order change is delivered to the ward; or C3: a totally different injection B is delivered to the ward.

The hospital information system 1 is contrived to achieve the check function for each of the above described cases. The following description starts with the case C1 followed by the other cases.

Case C1: the Injection A as per the Order Prior to the Order Change is Delivered to the Ward

Usually, the ward system reads the tag data on a bottle label and checks with the tag data of each medicine to be mixed based on the content of the work schedule data of the modified order, hence displaying an alarm and detecting a mistake (i.e., injection medicine mixing confirmation operation).

In the PDA system 4B, it is possible to check whether or not a bottle containing the rightful content has been delivered by checking whether of not the injection medicine mixing confirmation operation has been carried out.

An alternative configuration may be such that an order change can be recognized by having the function of checking the latest work schedule data as shown by FIG. 23.

That is, it is possible to make certain the confirmation result is “not okay” by having a nurse perform the processing of checking the latest work schedule data, even if a label check by PDA 8 is okay and the subsequent mixing check also is okay (if it is not okay, then “mixing check is not yet done” message will be displayed) and even the patient check is okay (if it is not okay, then “it is not the patient to be treated” message will be displayed.

Specifically, for instance, the contrivance may be to let the latest work schedule data be checked following a patient check by the PDA 8 to display a message such as “the order may have been changed. Please confirm” if there is a change.

For example, describing by using the flow chart shown by FIG. 16, the contrivance may be to make certain the wrist band check is okay in the step S35, followed by the PDA 8 displaying so as to prompt to check the above described latest work schedule data, and followed by displaying the order content in the step S36.

Thus displaying the message to prompt to check the latest work schedule data enables the practitioner of the injection to know of the order change by letting the portable PDA 8 obtain the latest work schedule data for confirmation.

C2: the Injection A′ as per the Order Change is Delivered to the Ward

If the injection A′ as per the order change is delivered to the ward and if the pre-modified old work schedule data is registered in the PDA 8, the bottle label check becomes a nonidentity to display a warning message.

If the order has been modified, it is possible to know whether or not the nonidentity is caused by an order modification by judging the identity down to a certain number of digits since the ID (i.e., RP-ID) attached to each injection (i.e., RP) is the same as the previous one down to a certain number of digits from the top thereof, with some digits below there having been incremented.

Incidentally, it goes without saying that the above described same ID number down to certain digits is uniquely assigned to each injection medicine.

If a result of checking thusly the tag data on the bottle label for collation shows a nonidentity of the bottle label due to a modification of the order content, a message in effect meaning “the order may have been changed. Please obtain the scheduled operation list again” will be displayed.

At this stage, the post-change work schedule data will be recorded in the PDA 8, with the injection A being changed to the injection A′, by the user operating the PDA 8 to obtain the latest work schedule data.

After this, the injection A′ can be administered since the bottle label check and wrist band check will both be okay.

This operation is effective in terms of notifying the medical staff about to carry out an injection of the post-order modification new instruction item, thereby preventing the staff from administering the injection knowing only the old information.

Meanwhile, another contrivance may be such that displaying a guidance message “since the order has been changed. Press the renewal button” in addition to a warning or “since the order has been changed, now retrieving the latest information . . . ”, instead of displaying a “not okay”, followed by obtaining the latest work schedule data for collation and, if the collation result becomes okay, then proceeding to the patient (i.e., wrist band) check.

C3: a Totally Different Injection B is Delivered to the Ward

If a totally different injection B is delivered to the ward, the tag data on the bottle label and the injection RP code (i.e., RP-ID) are totally different from each other, prompting to issue a warning as not okay.

Specifically, displaying a warning “it is not a bottle to be used” will prevent a wrong administration of injection.

Incidentally, the above described method is particularly effective for a one-shot injection, the case of drip infusion, however, requires a length of time to complete, an “injection start” and an “injection completion” are respectively inputted, unlike the one-shot injection.

That is, while the procedure for the one-shot injection is in the sequence of (1) bottle label check, (2) wrist band check, (3) administration and (4) injection completion (i.e., administered amount) input, the drip infusion requires the two work schedules as follows:
Drip infusion start: (1) bottle label check, (2) wrist band check and (3) drip infusion start; and
drip infusion completion: (1) bottle label check, (2) administration completion (extract injection needle) and (3) infusion completion (administered amount) input.

Describing by the work schedule data, they are registered for both the “injection start” and “injection completion” at the same time in the case of one shot injection, whereas the “injection start” (i.e., “infusion start”) and the “injection completion” (i.e., “infusion completion”) are registered in the respective timing in the case of a drip infusion.

The next description is about a processing for breakage such as breaking an injection medicine bottle. The screen for inputting breakage such as breaking the injection medicine bottle, et cetera, is opened by way of the screen relating to administering an injection.

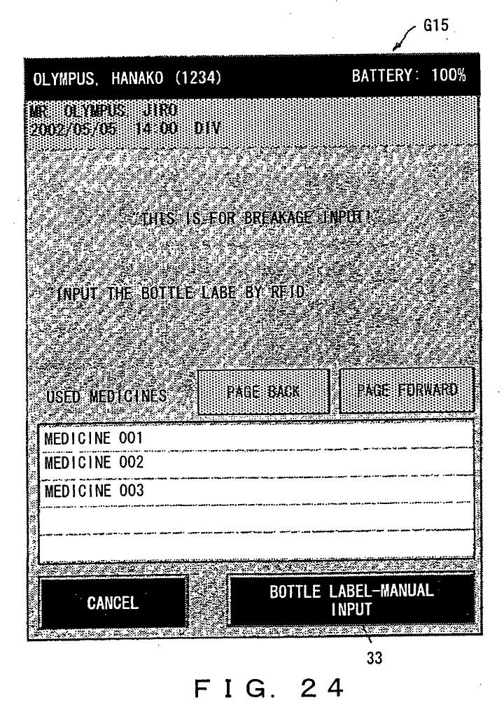

That is, the configuration is such that pressing the input breakage button 31 located on the right bottom corner of the bottle label check screen G10 will open a breakage input bottle check screen G15 shown by FIG. 24.

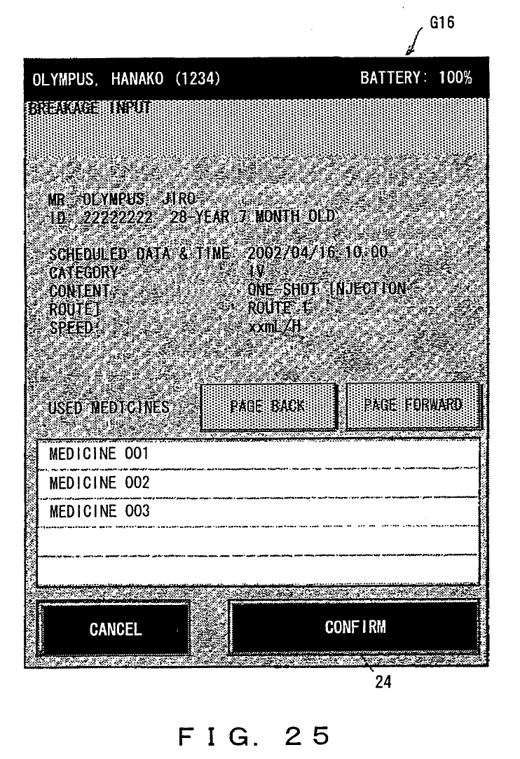

In the state of displaying the breakage input bottle check screen G15, reading the tag data of broken injection medicine bottle first checks the broken injection medicine bottle. Upon finishing it, a breakage input confirmation screen G16 shown by FIG. 25 will open.

Incidentally, even if the bottle label is soiled by the fluid so that the data written thereon has become illegible by the naked eye after breaking the bottle, the function of the RF tag 12t is still retained because the RF tag either attached to, or embedded in, the bottle label is sealed in a flexible plastic protective film, allowing the RF reader 12 to read the tag data.

Meanwhile, if apart of the RF tag 12t is physically damaged to preclude reading out by the RF reader 12, the nurse can input the ID data written on the surface of the RF tag 12t by pressing the bottle label manual input button 33.

The breakage input confirmation screen G16 shown by FIG. 25 displays the instruction content of the injection at the time of the order as with the injection confirmation screen G13. The example shown by FIG. 25 displays patient information, scheduled date & time, injection category/content/route/injection speed, mixed medicines, et cetera.

At this stage, the nurse confirms the instruction content, and, if it is indeed the bottle for a breakage input, presses the confirm button 24 for the input.

Pressing the confirm button 24 will register the breakage input data (i.e., the “discard data” shown by the table in FIG. 3) in the intra-hospital information management system 2, the information thereof is commonly used by the information system in a logistics department, pharmacy management department, et cetera.

Note that a breakage input makes the injection practice remain as “scheduled” in the work schedule list shown by FIGS. 12 through 14 (i.e., it does not move to the “completed” list) since the injection has not made “completed” unlike the injection operation input.

Having registered the “discard data”, the nurse can select the applicable work schedule from the work schedule list, check the bottle and the wrist band to administer the injection as with the normal administration of injection, if the same content bottle has been prepared and received.

While the above example deals with a breakage of bottle containing a mixed medicine solution, a breakage input is likewise possible in the event that one medicine bottle among a plurality thereof is broken as well prior to an injection medicine mixing.

In such a case, the nurse can proceed to the breakage input confirmation screen by selecting the broken medicine from among them displayed on the bottom of the screen in the bottle label check screen G10 for a breakage input shown by FIG. 18.

Incidentally, it is possible to input either by reading an RF tag of each of the medicine bottles if it is attached, or selecting the displayed medicine if an RF tag is not attached or embedded.

On the other hand, if the bottle is broken after the administration start (i.e., after drip infusion start) instead of being prior thereto, a percentage input is possible by inputting as a part administration of the injection completion.

The content of “discard data” appearing in the right-most column shown by FIG. 15 shows the structure of the discard-processing data registered by the PDA 8 by way of the server 7 through the breakage input for the injection.

The data structure is the same as the work schedule data which contains the information indicating the 5W1H performed in each work and sets the data such as the practitioner and the actual practiced date & time according to the content at the time of input. The shaded areas of FIG. 15 are the data added or changed in accordance with the content at the time of breakage input.

In FIG. 15, the <progress> data among the work schedule data is changed from “scheduled” to “completed”, the <practitioner> and <practiced date & time> are added in accordance with the operation content, and the category of the <operation content> is entered with “discard”. And the data for <medical object> is set up with the data of medicines to be mixed.

Note that the data for all the mixed medicines are set in the case of breaking a bottle, whereas the broken medicine bottle only is entered here in the case of breaking a single medicine bottle prior to an injection medicine mixing. Then, the medical practice of drip infusion starts.

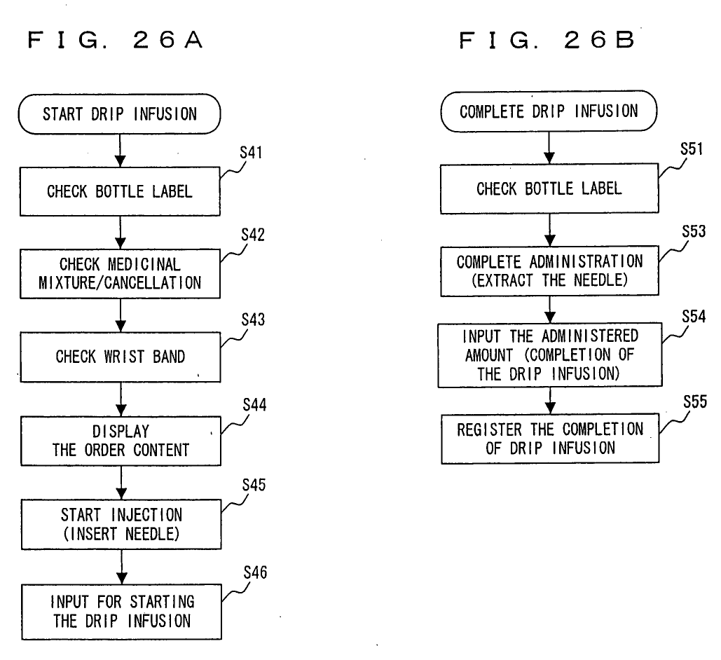

FIG. 26 shows an operational content of medical practice of drip infusion, with FIG. 26A showing the operational content of starting the drip infusion and FIG, 26B showing that of completing it.

As shown by FIG. 26A, starting the drip infusion initiates the processing of checking the bottle label (S41).

The bottle label check accompanies “not okay” if it is not properly done, ending up issuing a warning followed by going back to the step S41 as described in association with FIG. 16 (as with the mixing/cancellation check and the wrist band check in the description below), the description here assumes the bottle label check being done properly for simplicity, however.

Upon completing the above described bottle label check, the processing proceeds to a mixing/cancellation check in the subsequent step S42, followed by proceeding to the step S43 for a wrist band check upon completion of the mixing/cancellation check, and followed by an order content display in the step 44 upon completion of the wrist band check.

Following the order content display, an injection starts in the step S45. That is, the medical practice of the medicine administration starts by inserting the injection needle into the patient checked by the above described wrist band.

Having started the medical practice, the nurse inputs the drip infusion start by the PDA 8 to transmit to the intra-hospital information management system 2 so as to register the actual operation data of the drip infusion start in the database therein at the time (i.e., at the timing) as shown by the step S46. This starts the scheduled administration of medicine by the drip infusion for the patient.

After starting the drip infusion, a nurse who practices a completion of the drip infusion checks the bottle label in the step S51 shown by FIG. 26B followed by performing the completion of the drip infusion (i.e., needle extraction) at the clock time of the drip infusion completing the administration of the medicine by extracting the injection needle for the infusion in the step S53, followed by inputting the infusion amount by using the PDA 8 to complete the drip infusion in the step S54.

Inputting the administered amount prompts the PDA 8 to transmit the information about the completion of drip infusion to the intra-hospital information management system 2 so that the operation data of the completion of drip infusion will be registered therein.

Also in such medical practice that takes time to complete, the detailed information at the time of completing a medical practice as well as at the time of starting it is registered in the data base of the intra-hospital information management system 2 accurately.

Thus, even in such medical practice that takes time to complete, the detailed information at the time of completing a medical practice as well as at the time of starting are registered, thereby an appropriate assistance can be performed as follows.

For instance, if a drip infusion starts later than the work schedule time, the completion scheduled time delays accordingly. The intra-hospital information management system 2 refers to the actual delayed clock time to change the corresponding schedule time for performing the practice of completing the drip infusion in the data base.

By this change, when the nurse who has the work schedule data for a completion of the drip infusion downloads, et cetera, the work schedule data from the data base of the intra-hospital information management system 2 to refer to, or view, she can comprehend the change of the scheduled time for completing the drip infusion and therefore quickly respond to the work.

In such medical practice, there are many cases where a nurse who performs both the drip infusion start and the completion, the nurse can comprehend the scheduled time for completing the drip infusion accurately and ahead of the scheduled completion time. Therefore it is easy to respond to the work schedule operations thereafter.

And, if the administering time between the drip infusion start to the completion is long, not necessitating the nurse to be present on the spot during the time, she can perform other work schedule services effectively in the meantime.

Also in such a case it is easy to perform other work schedule services by knowing the scheduled completion time of the drip infusion accurately.

Also, if the nurse who started a drip infusion toward the end of her work shift hours is scheduled to hand over the completion operation of the drip infusion to another nurse, the other nurse can comprehend quickly the fact that the scheduled time of completing the drip infusion is actually delayed due to the delayed start thereof by accessing to the data base by using the PDA 8 to refer to or view the work schedule data, hence responding to it easily.

The nurse can perform the other scheduled medical practice during the delayed time as described above for instance to reduce the effect on the subsequent work schedule services, thereby performing the scheduled medical practices smoothly.

In such medical practice that takes time to complete, if there is a difference between a scheduled start time and the actual start time, it is possible to grasp the information quickly, thereby reducing the effect on performing the subsequent medical practices and assisting the medical practices to be carried out smoothly (or making it possible to provide an environment for carrying out the medical practices smoothly).

Also, it is possible to investigate a cause, et cetera, of the delay in medical practice for more appropriately improving by analyzing such information in detail later from the data base.

That is, in such event, the information containing the above described 5W1H is registered in the data base both at the drip infusion start and the completion, not just the clock time, and therefore an ample amount of information for later analysis is contained so as to enable a detailed analysis.

For instance, the pieces of information registered at the times of drip infusion start and the completion contain the data of practitioner, operation spot, operation content, et cetera, in addition to the respective operation date & time. In detail, the data corresponds to the ones shown in the column “content of work schedule data” shown by FIG. 15.

FIG. 15 shows how the work schedule data are changed as a result of performing the work or discarding the work schedule by exemplifying a one-shot injection for simply describing (i.e., almost the same clock time for the start and completion) the overview for easy understanding.

Therefore, if starting a drip infusion that takes a long time to complete, the <progress> data changes from “scheduled” in <work schedule data content> to “complete” in <operation data content> (in more detail, drip infusion started), while the <instruction content> data will not be inputted as administered for the “operation data content” column shown by shaded area in FIG. 15. The shading for the administered will be done at the time of completing the drip infusion.

Then, having received a registration of performing the drip infusion start, the intra-hospital information management system 2 changes the <work schedule date & time> data based on the date & time of the actual drip start data in the “work schedule data content” column for the drip infusion completion pairing with the drip infusion start, thereby making it possible to build a more accurate data base and provide the referring user with accurate information.

It is possible to use the information for grasping the capability, load, et cetera, of each nurse performing the medical service in addition to analysis for further improving the program of the system since the information is recorded in detail as described above.

Note that the above description has dealt with an example of a data base recording and accumulating accurate information. For a medical practice that takes a long time from the work start to completion (such as drip infusion), however, the processing maybe such that, at the time of registering the information about an actual start time of a work vis-á-vis the scheduled start time thereof, a CPU (not shown) comprised by the intra-hospital information management system 2 judges whether or not the time delay is exceeding a predetermined length of time and, if the judgment is “yes”, then notifies the PDA 8 carried by the practitioner of the work schedule clock time change of completing the drip infusion.

The method for notification is comprehensible if it is notifying that the work schedule clock time for completing the drip infusion has been changed, but it is not limited as such and, it may be a simple message to prompt the practitioner for obtaining the latest work schedule time. Such a message can be used for another purpose and simplify the program.

Meanwhile, if starting a drip infusion and completing it require different practitioners, a notification of a delayed starting of the drip infusion having caused the scheduled clock time for completing it delay may be sent from the practitioner of starting it to the one of completing it by using the mail function of the PDA 8.

Also, while the above description has dealt with the drip infusion as a case of medical practice that takes time to complete, the above described method may be applied to other medical practices including the one for obtaining an electrocardiogram, et cetera.

Incidentally, the PDA 8 reads the tag data out of the RF tag 12t already attached to the patient wrist band, injection medicine bottle label, or medical instrument case that have been described above by using the RF reader 12, which will be further described in the following.

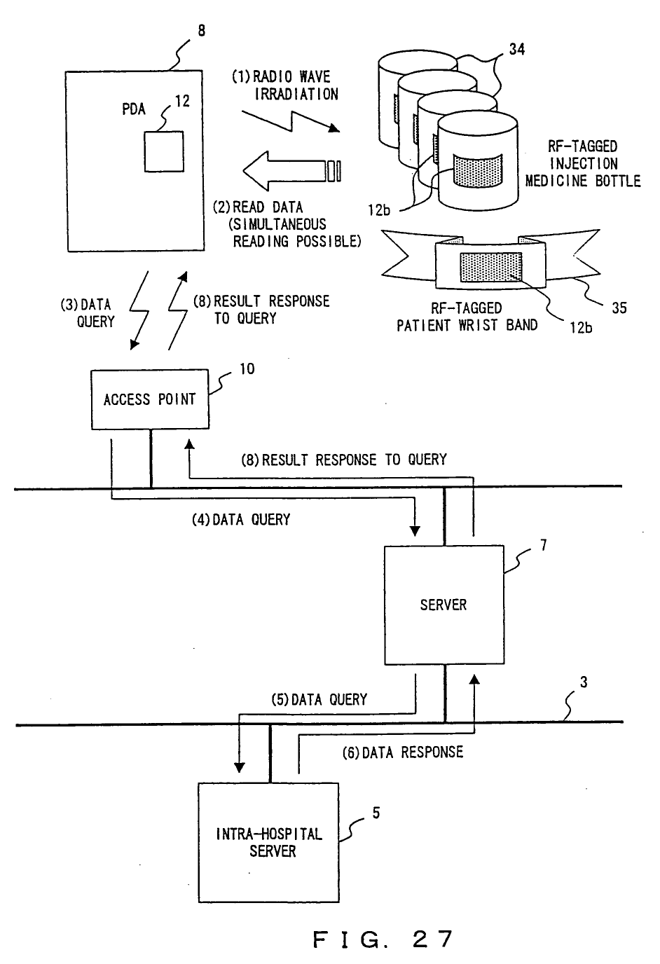

FIG. 27 illustrates reading the tag data of an injection medicine bottle described in association with FIG. 18 and that of the tag data a patient wrist band described in association with FIG. 20.

Note that FIG. 27 illustrates a plurality of injection medicine bottle 34 attached by an RF tag and a patient wrist band 35 embedded with an RF tag, and in addition, the LAN 3, the intra-hospital server 5 comprised by the first subsystem 4A, the server 7 comprised by the second subsystem 4B, the access points 10 and the PDA 8, all of the above comprised by the hospital information system 1 shown by FIG. 1.

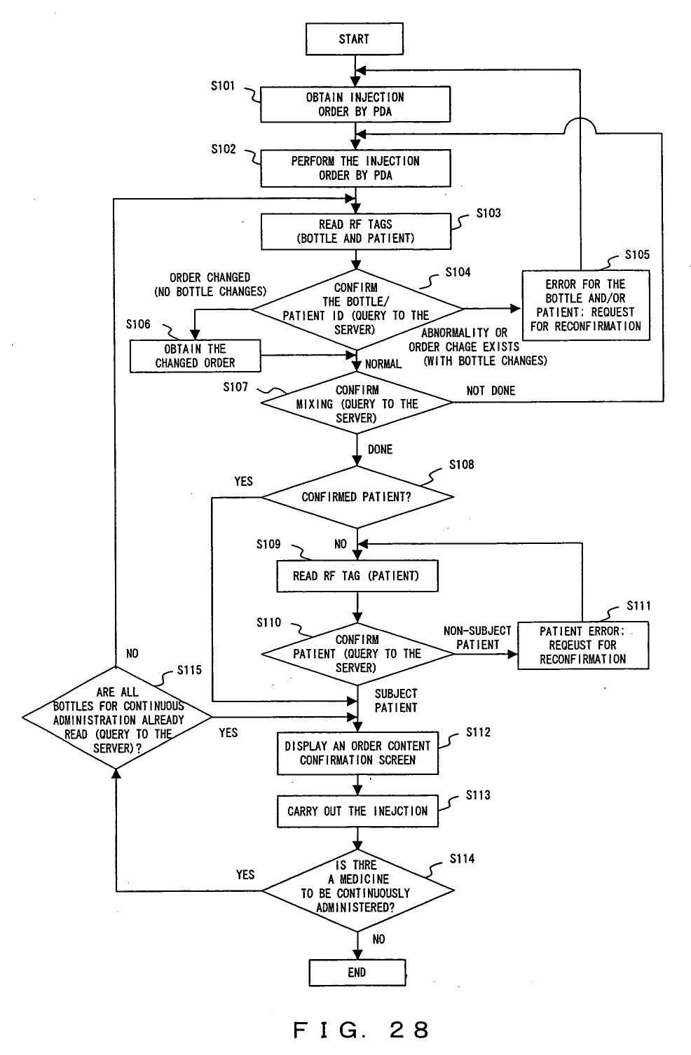

FIG. 28 is a flow chart describing processing operations of the hospital information system 1 relating to reading the above described tag data of the injection medicine bottles 34 and that of the patient wrist band 35. The description is about the processings shown by FIG. 28 while referring to FIG. 27.

First of all, the nurse logs in on the PDA 8 to obtain the injection order contained by the medical practice order for today's work shift (S101). The processing is the same as the ones described for S12 shown by FIG. 4 and FIG. 17.

She then performs the injection order (S102) by using the PDA 8. This processing for example is to select the line “5^{th} (of a month) 10:00 Olympus, Jiro injection: IV” for input in the work schedule screen G9 shown by FIG. 17.

The subsequent processing reads the RF tag (S103), in which the nurse prepares the injection medicine bottle (a plurality thereof if required) to be administered to the patient she attends to and asks the patient to show the wrist band.

Then, she lets the PDA 8 read the tag data of the injection medicine bottle(s) described in association with FIG. 18 and that of the patient wrist band described in association with FIG. 20.

In these readings, the nurse may let it read the tag data of the injection medicine bottle and that of the patient wrist band separately, which is actually wasting the versatile function of the RF reader 12; and therefore she may instead line up a plurality of injection medicine bottles 34 on the wagon, move the wagon close to the RF tagged wrist band 35 of the patient who is either laying down or sitting up and perform the readings of the tag data of both the injection medicine bottles and the patient wrist band all at once by letting the RF reader of the PDA 8 transmit a predetermined radio frequency waves as shown by FIG. 27.

The RF reader 12, unlike an optical reader, does not require considerations such as orientation, angle or distance to the object of reading, and instead, allows the CPU 13 comprised by the RF tag 12b to recognize the RF tag 12b by transmitting a predetermined radio frequency wave and receiving the response even if there is a shielding object (only a nonmetallic material) is in between as long as a communicable distance for the radio frequency intensity is maintained. The tag data stored in the memory of the RF tag 12b can be read out.

The amount of information storable in the memory of the RF tag 12b is relatively large so that the tag data herein is not just limited to plural lines of identification code, but additionally may contain a detailed pieces of information such as medicine name, amount, manufacturing year, month and date, injection region, injecting method (i.e., either one shot or drip infusion) in the case of the RF tag of the injection medicine bottle 34.

For the application to the RF tag 12b of patient wrist band 35, it is desirable to record the detailed information such as patient name, age, gender, hospitalized date, disease, emergency contact.

This will save a nurse's procedure just by letting a server sendback a confirmation to a query, instead of transmitting the tag data to the server and having the server send back the detailed information corresponding to the tag data.

Now back to FIG. 28, having read the RF tag 12b, the subsequent processing confirms the just readout data of the RF tag 12b (S104) in which the PDA 8 transmits the read data to the server 5 comprised by the first subsystem 4A, which is the intra-hospital server, by way of the access point 10 and the server 7 comprised by the PDA system 4B as a query for confirmation.

Then, the response to the query is sent back from the server 5 to the PDA 8 by way of the server 7 and the access point 10.

Then, if the response to the query indicates “normal” data in step S104 shown by FIG. 28, the processing proceeds to the subsequent step S107. Meanwhile, if the order has been changed without changing the medicine bottle, the processing obtains the changed order (S106), followed by proceeding to the subsequent S107.

On the other hand, if the response to the query indicated the data “abnormal” in the above described step S104, or the order has been changed with a bottle change, the display unit 18 of the PDA 8 displays a warning to effect that either or both of the bottle and patient is/are in error and prompt a reconfirmation (S105).

The processing displays a warning message in addition to issuing an alarm in which case the nurse retries to obtain the order of the step S101.

Also in this case error log information is automatically recorded in a predetermined memory area of the PDA 8, although it is not shown.

Then, if the data queried in step S104 is confirmed as normal, a mixing is confirmed in step S107.

The processing is to query for a confirmation as to whether or not the RF tags 12b of all the injection medicine bottles 34 instructed by the order having been read.

Also in this processing the PDA 8 transmits the query for confirmation to the server 5 comprised by the first subsystem 4A, which is the intra-hospital server, by way of the access point 10 and the server 7 comprised by the PDA system 4B, and then the response to the query is sent back from the server 5 to the PDA 8 by way of the server 7 and the access point 10.

And if there is an injection medicine bottle 34 of which the RF tag 12b is not yet read among the injection medicine bottles instructed by the order (i.e., not done for the processing of S107), the display unit 18 of the PDA 8 displays a warning message and sounds an alarm although not shown, and error log will also be recorded in a predetermined storage area of the PDA 8.

Here, the nurse lets it go back to the processing of S102 and reopens the work schedule screen G9 to select the line “5^{th} (of a month) 10:00 Olympus, Jiro injection: IV” for input and reads the RF tag 12b of the injection medicine bottle 34 which has not been read.

Then, if the RF tags 12b of all the injection medicine bottles 34 instructed by the order are read (i.e., done for the processing of S107) through transmission of the data query and the confirmation of the transmitted data, whether or not the patient is confirmed is judged (S108).

And, if the patient is not confirmed (“no” for S108), which is a case where the RF tag 12b of the injection medicine bottle 34 has been read, whereas not the RF tag 12b of the patient wrist band. In this case, the PDA 8 displays the wrist band check screen G12 shown by FIG. 20 so that the nurse reads the RF tag 12b of the patient wrist band 35 (S109).

Then, she transmits a query for the read data (S110) and, if the response result sent back from the server 5 to the PDA 8 by way of the server 7 and the access point 10 is not normal (i.e., the patient is not a subject for the judgment in S110), meaning the nurse selecting a wrong patient, resulting in the PDA 8 displaying a warning message such as, “patient error” and, additionally, a message prompting a reconfirmation such as “reconfirm the patient” in the display unit, followed by recording error log information automatically in a predetermined storage area of the PDA 8 (S111).

And, if the result of reading the RF tag 12b of the patient wrist band 35 performed in S109 is normal (i.e., the patient is the subject of treatment for S110), then the display unit of the PDA 8 displays the injection confirmation screen G13 shown by FIG. 21 (S112), prompting the nurse to input a confirmation for injection practice (S113).

When a confirmation for injection practice is inputted, information such as a practitioner of injection, name of patient injected, medicine for it and the time performed are inputted as well at least to be transmitted to the sever system and recorded.

Once the input of the injection practice is done, the PDA 8 transmits a query for the presence or absence of medicine for continuous administration, followed by the server 5 responding with a result to the query (S114).

This processing judges whether or not the RF tags 12b of all the injection medicine bottles 34 have been read and the confirmation has been inputted by the nurse.

And, if there is a medicine for continuous administration which has not been inputted for confirmation by the nurse (“yes” for S114), the processing judges whether or not the RF tags 12b of all the injection medicine bottles 34 for continuous administration have been read (S115).

Also this processing is done by a transmission of data query to the server 5 and the response of the result to the query therefrom.

If the response of the result to the query indicates a completion of reading the RF tags 12b of all the injection medicine bottles 34 for continuous administration (“yes” for S115), the processing of the above described S112 and S113 are performed, thereby a confirmation input being done by the nurse, the judgment result for S114 becoming “no” and hence ending all the processing.

Meanwhile in the judgment of S115, if the response of the result to the query indicates that not all of the RF tags 12b of the injection medicine bottles 34 are read (“no” for S115), the processing goes back to S103 for performing the processing of S103 through S113. Then, if the judgment for S114 becomes “no”, all the processing comes to an end.

In the processing end, although not particularly shown, if either one of the certifications for confirmation in S104, S107 and S110 is not right, then the PDA 8 displays a warning message and sounding an alarm either in S105, during S107 through S102, or S111 for indicating that the certification is not correct, error log information indicating that the certification is not correct is recorded in a predetermined storage area of the PDA 8 and the error log information will be transmitted to the server system for recording therein at the time of the PDA processing coming to an end.

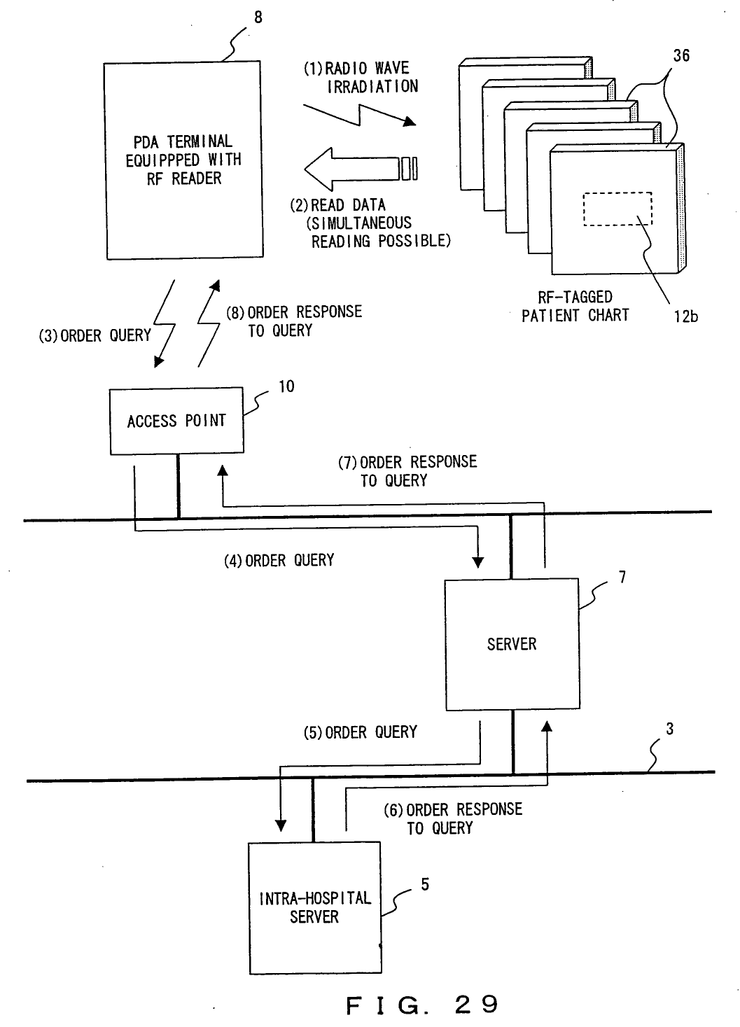

FIG. 29 illustrates an operation of reading out of an RF-tagged patient chart as another embodiment of reading the RF tag 12b by the RF reader 12 equipped by the PDA 8.

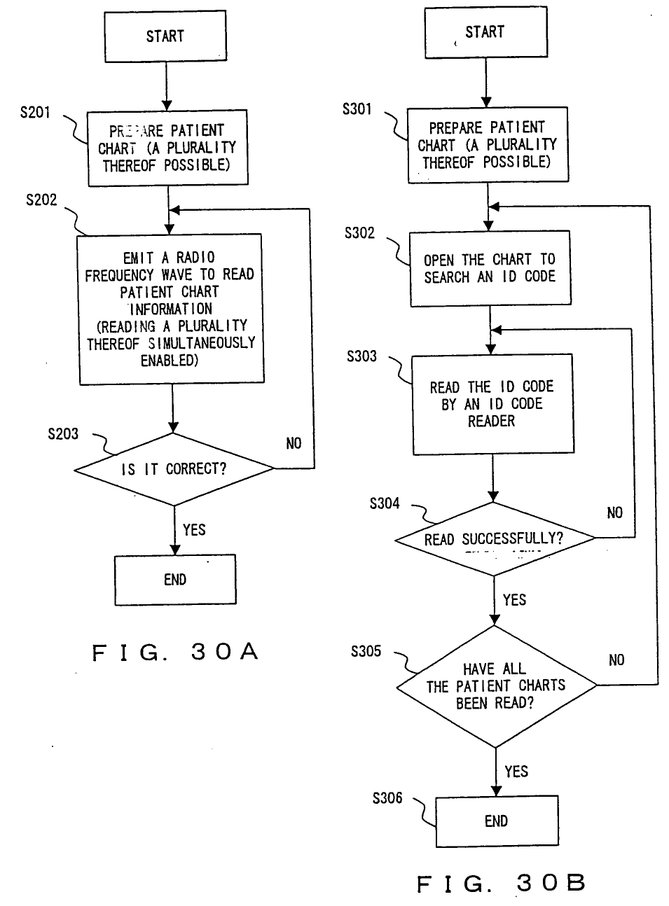

FIG. 30A is a flow chart describing a processing operation of the hospital information system 1 relating to a reading operation of patient chart information which is the tag data of the above described RF-tagged patient chart.

FIG. 30B is a flow chart describing a processing operation of the same system in the case of reading a patient chart data by an optical reading apparatus for reference.

These processing are done after the nurse logs in the PDA 8 to obtain a medical practice order for the work shift of the day.

In FIG. 30A, the nurse prepares the RF-tagged patient chart instructed by the medical practice order. If she is going to attend to a plurality of patients, she prepares a plurality of RF-tagged patient charts for them, as shown by the top right corner of FIG. 29 (S201).

And she lets the RF reader 12 comprised by the PDA 8 emit a predetermined radio frequency wave to read chart information as tag data out of the RF tag 12b of RF tagged patient chart 36. If there is a plurality of RF-tagged patient charts, read the tag data out of the plurality of tags all at once (S202).

Then confirm whether or not the read tag data are right (S203).

In this processing, the PDA 8 transmits the read-out tag data to the server 5, as a query for confirmation, comprised by the first subsystem 4A, that is the intra-hospital server, by way of the access point 10 and the server 7 comprised by the PDA system 4B as shown by FIG. 29.

Then the result response to the query is sent back from the server 5 to the PDA 8 by way of the server 7 and the access point 10.

And, if the result response to the query indicates that the read-out tag data is correct (“yes” for S203), the process of reading the RF tagged patient chart 36 ends.

On the other hand, if the result response to the query indicates that the readout tag data is incorrect (“no” for S203), the nurse checks the RF tagged patient chart 36 once again, going back to S202 for reading the data out of the RF tagged patient chart 36 again.

Then, having confirmed “yes” for S203, finishes the readout processing of the RF tagged patient chart 36.

If the tag data reading by the PDA 8 were done by an optical data reader reading an identification code printed on patient chart instead of the RF reader 12, the process would be the same down to preparing the patient chart (S301), which is followed by first opening the patient chart to find the part printing the identification code (S302); reading the found identification code by using the optical data reader (S303); confirming if read correctly (S304) and, if not read correctly (“no” for S304), reading the patient chart again; if read correctly, confirming if all the patient charts are read (S305) and, if still there is a patient chart to be read (“no” for S305), repeating the reading of unread patient charts until all the patient charts are read (“yes” for S305); and followed by finishing reading the patient charts.

As described above, the optical data reader is cumbersome, whereas the PDA comprising the RF reader makes it possible to conveniently read the patient chart information all at once just by preparing all the RF tagged patient charts 36, specified by the medical practice order, gathered in one spot.

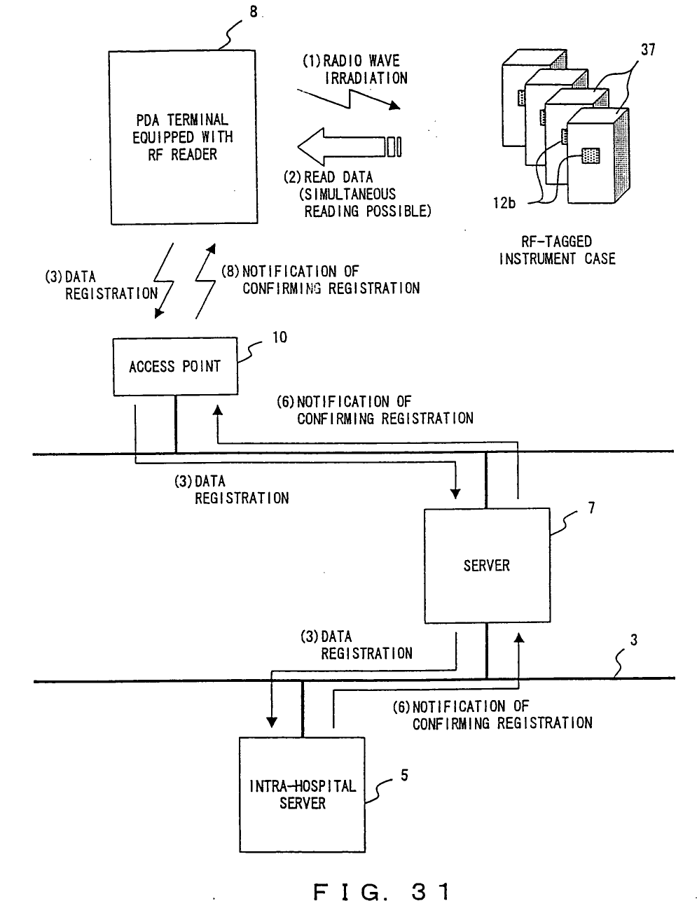

FIG. 31 illustrates a reading operation of RF-tagged medical instrument cases as yet another embodiment of tag reading of the RF tag 12b by the RF reader 12 comprised by the PDA 8.

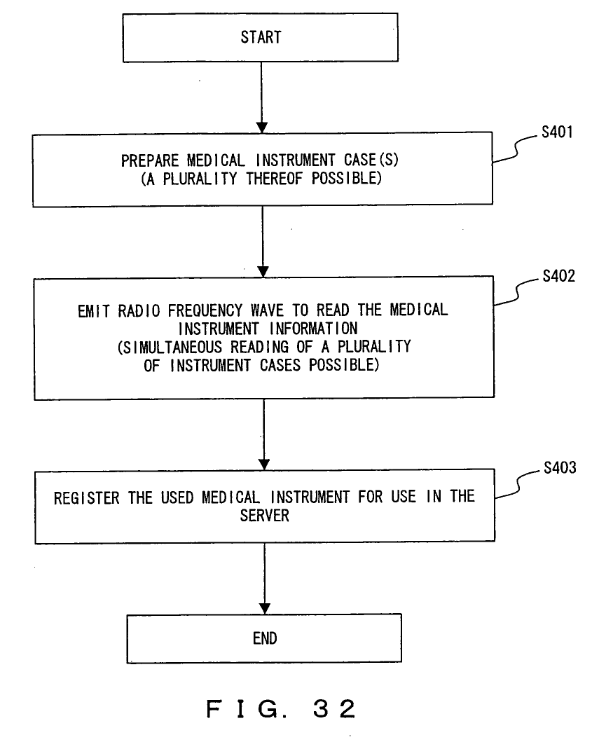

FIG. 32 is a flow chart describing a processing operation of the hospital information system 1 relating to tag reading operation of tag data of the above described RF-tagged medical instrument cases. Note that the medical instrument is for doctor to use for the medical practice directly for the patient other than injection, such as catheter.

In FIG. 32, the nurse first prepares a medical instrument case storing medical instruments specified by the medical practice order. If a plurality of medical instruments is specified, she prepares a plurality of instrument cases required for housing the plurality of medical instruments (S401).

Then she lets the RF reader 12, comprised by the PDA 8, emit a predetermined wave of radio frequency to read medical instrument information as tag data out of the tags of RF tagged medical instrument cases. If there is a plurality of instrument cases then, it reads the instrument information contained in the tags of the plurality of instrument cases all at once (S402).

Then, registers in the server 5 the medical instruments to be used (S403). The processing is for registering, in the medical practice order on the data base, the fact that the medical instruments corresponding to the above described readout tag data are prepared.

That is, the PDA 8 transmits the readout data to the server 5 comprised by the first subsystem 4A, that is the intra-hospital server, by way of the access point 10 and the server 7 comprised by the PDA system 4B for confirming if there is an error and, if there is no error, the readout data is registered in the medical practice order within the data base as shown by FIG. 31. Then, the response indicating “okay” for confirming the registration will be sent back from the server 5 to the PDA 8 by way of the server 7 and access point 10.

As such, the medical instrument information can be read all at once just by preparing all the RF tagged instrument cases specified by the medical practice order on one spot.

As described before, an RF reader outputs a radio frequency wave and reads the data out of the RF tag responding to the radio wave and therefore is convenient to handle.

Also, it is possible to read data out of the RF tag as long as the radio wave reaches it even if it is shielded by a non-metallic material, and therefore no consideration is necessary for orientation or angle to the object to be read, making it easy to handle.

Also, a plurality of RF tags can be read at once (at substantially the same time), providing efficient data reading.

Also, it is possible not only to be read out but also write in, making it possible to apply widely to usages in the system.

Also, the RF tag excels in environmental durability, resistive to contamination such as water, oil, chemicals, et cetera, and unaffected by a stray light, making it possible to consistently prepare highly reliable read-out data.

Also, RF tags can be formed into various shapes, miniaturized so as to fit in a small mounting space, making it possible to attach to a diverse medical instrument.

Also, a non-contact power transmission from an RF reader can eliminate a battery and therefore the usage becomes almost permanent.

As described so far, according to the present embodiment, equipping an RF reader with a mobile terminal in addition to a wireless LAN and attaching an RF tag to an object required for identification data enable a medical practitioner, by reading the tag data rapidly by using the PDA 8 as mobile terminal, to confirm and comprehend the content of work schedule for medical practice on the spot where the medical practice will be taken place before performing the scheduled medical practice, and thereby to perform the medical practice to be carried out (i.e., scheduled) accurately and substantially free of error.

And, a medical practice that takes time to complete can be grasped correctly so that, if such a medical practice delays, the information is available quickly to be able to be responded thereto, hence providing an environment for a smooth medical practice.

It is also possible to input the record of medical practice content by using the PDA 8 on the operation spot of medical practice and therefore the recording is done while confirming it on the spot and right thereafter, thus enabling an accurate and error free recording.

When completing the scheduled medical practice correctly, and recorded, after confirming the work schedule for the ordered medical practice by using the portable PDA 8, the content of the work schedule moves to the completed list, thereby enabling the practitioner to carry out a plurality of medical practices as per the work schedule smoothly by referring to the list of work schedule.

Also, when carrying out the medical practice, the portable PDA 8 allows the work schedule contents of the medical practice to be easily referred to, or confirmed, mostly on the discretionary spot and time, enabling a smooth medical practice.

Also, in the case of the work schedule content being changed, it is possible to respond to the change therein by doing a confirmation processing thereof on the operation spot and just prior to the practice time.

Also, when carrying out the medical practice as such, it is possible to record the content of actual practice accurately, that is, in real time, enabling an improvement of the system through analysis of the recorded data thereafter.

Note that, while the above description has dealt with the case where an input of actual medical practice content, following the medical practice as per the work schedule, is transmitted by way of the server 7 to the intra-hospital information management system 2 for registering in the data base therein, an alternative configuration may be such that the confirmation of the input content will immediately be followed by a transmission thereof to the intra-hospital information management system 2.

An example configuration may be such that the PDA 8 displays the inputted practice content for a confirmation through a “confirm” button, pressing it opens another confirmation message such as “Sending your input for registration?” and pressing an “OK” button or the like initiates a transmission of the input.

If the intra-hospital information management system 2 is in a state of standing by to receive a transmission for some ongoing processing at the time of the transmission for registration, an alternative configuration may be such that the server 7 comprised by the PDA system 4B for instance receives the transmitted content until such standby state of the intra-hospital information management system 2 is released, followed by registering the content received by the server 7 in the database comprised by the intra-hospital information management system 2, and followed by notifying the PDA 8 of completing the registration right after the completion thereof.

Such configuration relieves the practitioner who is trying to operate the PDA 8 for the registration from waiting for the intra-hospital information management system 2 being released from such standby state.

Meanwhile, the medicines delivered from the pharmacy department (“dept.” hereinafter) to the nurse dept. have conventionally been verified in reference with the medicine order list one by one, hence time consuming, low efficiency work, the present embodiment, however, enables a data exchange with the pharmacy dept. simultaneous with issuing the medicine order.

In this case, the pharmacy dept. takes out the medicine that has been ordered and changes the status of the tag data of the RF tag to “taken out” before sending the medicine out.

The status change of the tag data can be well achieved by continuous reading of the tag data of the stocked medicines on the shelf by using the RF reader, and changing the status by letting the RF reader write it when taking the medicine out of the stock.

Back at the nurse dept. an excess or deficiency, or mistake, of the delivered medicines can be judged just by letting the RF reader read the RF tags thereof all at once, instead of verifying them one by one.

Incidentally, the pharmacy dept. enjoys the convenience of a simultaneous stock management by changing the status at the time of delivery therefrom. Back at the pharmacy dept. the status of delivery therefrom can be recognized so as to figure out the usage frequency from the delivery status. Therefore, a stock management is possible to eliminate an excess inventory.

Note that the above described embodiment takes four examples, that is, the injection medicine bottle, patient wrist band, patient chart and instrument case as the object of attaching the RF tag for reading data by the RF reader, the object of attaching it, however, is in no way limited as such.

For instance, surgery assistance can be applied to in the first place. Embedding the RF tag in a sheet of gauze for example makes it possible to count the number of sheets by the RF reader all at once even if sheets thereof are closely overlapping with one another due to clogged blood or the like, instead of counting them sheet by sheet. Also an accurate counting makes it easy for stock and usage management.

Also, if there is a missing sheet of gauze after use, scanning the operated part of patient body is possible by the RF reader to search for a sheet remaining in the body. Doing this before the suture will avoid an inexpedience such as a repeated surgery for taking it out of the body.

Incidentally, many surgical instruments are basically made of metallic materials, precluding a use of conventional RF tag. Recently, however, the RF tag types usable with metallic materials are becoming commercially available, and if they are reduced in size and weight, it is possible to mount in surgical knives and forceps, making it possible to prevent them from leaving in the patient body by the above described method.

Second, the RF tag can be applied to a positional information management within a hospital. Having the nurses wear RF tag and placing the RF readers within the moving range of the nurses make it possible to grasp the whereabouts of each of them. Such application can produce a good effect in the night shift when less number of medical staff is available or for an emergency when additional hands are required.

Also, having a roaming patient (of ambulatory automatism, et cetera) wear the RF tag will grasp the whereabouts of her/him, eliminating a conventional need of continuous watching out by the nurses, lightening the load on them.

Also, equipping the RF reader in the toilet or bath room and assuming that there is a problem of sorts happening therein, if a patient does not come out in a certain time, so as to respond to such event, hence preventing an emergency situation from happening.

Third, the RF reader can be applied to a personal identification, considering applications such as automatic ID registration at the time of log-in on the PDA system, automatic management of sign in and -out by installing an antenna at the employee entrance.

Fourth, the RF reader can be applied to patient services. Issue the private use-only RF tag to the patients for instance. Equipping the RF reader to an automatic vending machines installed in the hospital premise to read the RF tag of a patient and register in the data base at the time of purchasing something on the vending machine.

Also, the RF tag can be attached to the merchandizes carried by the concession store to account by the POS (point of sale) register equipped with the RF reader. The patient account will be certified by her/his RF tag, instead of paying cash for the purchase. Likewise in the cafeteria, install a meal coupon machine for a patient to purchase a meal coupon by the RF tag certification.

Also, for something rented for a fee such as bed sheet and pillow case will be recorded in the RF tag as renting record data.

The accounting information for the above described applications is managed by servers, et cetera, and the payment will be put together with the accounting for the inpatient medical expense.

The introduction of a bonus point service for instance can be considered to prevent a dissatisfaction of the patients caused by a sentiment of being controlled by the RF tag and RF reader.

In any event, such a system eliminates a need for carrying loose money for purchase from a vending machine or at a concession store, or for a meal in the cafeteria, eliminating hassle and increasing convenience.

### Second Embodiment

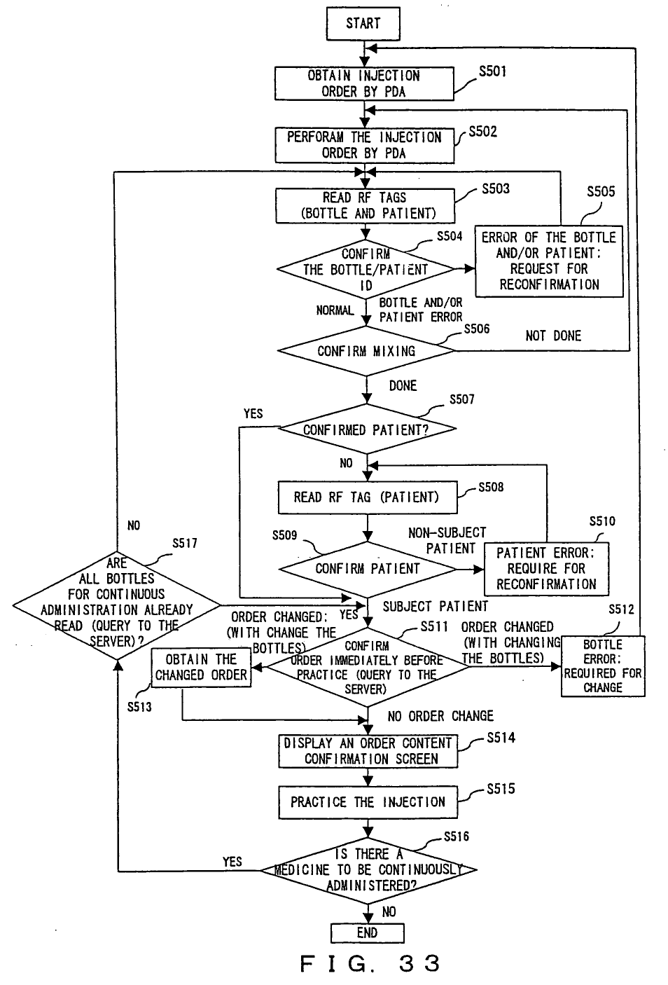

FIG. 33 is a flow chart describing another example processing operation of the hospital information system 1 relating to reading the tag data of the injection medicine bottle 34 and that of patient wrist band 35, as a second embodiment.

First, a nurse logs in on the PDA 8 to obtain an injection order within the medical practice order for the work shift on the day (S501), which is the same as the processing of S101 shown by FIG. 28.

Then the nurse performs an injection order by the PDA 8 (S502), which is the same as the processing of S102 shown by FIG. 28.

The subsequent processing is to read the RF tag (S503), which is the same as the processing of S103 shown by FIG. 28.

Then the read data out of the RF tag 12b by the above described processing is confirmed (S504), which processing collates with the injection order recorded in the PDA 8 as a result of the above described S501, instead of sending a query to the server system, in the present embodiment.

Then, upon confirming the collation result is correct (“normal” for S504), that is, completing certification of both the injection medicine bottle and the patient, she confirms a mixing (S506).

On the other hand, if either the injection medicine bottle or the patient, or the both, is different from the injection order (“error” for S504), the display unit of the PDA 8 displays a warning to prompt a reconfirmation of either the injection medicine bottle or the patient, or the both (S505).

In the processing, although it is not shown, an alarm is sounded and error log information is automatically recorded in a certain storage area of the PDA 8.

Then the nurse goes back to the processing of S503 to read the RF tags 12b of both the injection medicine bottle and the patient wrist band.

Then a collation with the injection order is performed and upon confirming that the collation result is correct (“normal” for S504), she proceeds to the confirmation processing for mixing in S506.

If the mixing is not done (“not done” for S506) in the confirmation processing for mixing, there must have been a change in either the injection order or the bottle, or both.

In this case the nurse goes back to the processing of S501 to obtain an injection order within the medical practice order for the work shift on the day again.

Then, having confirmed the normality for the collation of S504, and the confirmation of mixing done in S505, the processing judges whether the patient has been confirmed (S507), which is the same as the processing of S108 shown by FIG. 28.

In the processing of S507, if the confirmation of the patient is not done (“no” for S507), the processing of the subsequent S508 and S510 are the same as that of S109 and S111. In the processing of S509, a collation is done with the patient data of the injection order recorded by the PDA 8 as a result of reading in the processing of the above described S501, instead of transmitting a query to the server system.

Then, having confirmed that the patient is the one as the object of the injection order in the processing of S509, the PDA 8 transmits a query to the server system for confirmation immediately before carrying out the injection order (S511).

If there has been a change of the injection order, with the bottle changes, the display unit 18 of the PDA 8 displays the messages to notify of a bottle error and instruction for changing the bottle (S512).

In this case, the nurse does it over again from the first step S501 to obtain the injection order.

Meanwhile, if the injection order does not accompany an injection medicine bottle change, then obtaining the changed injection order (S513), followed by the display screen of the PDA 8 displaying the order content confirmation screen (S514).

The processing of S514 and those of the subsequent S515, S516 and S517 are the same as those of S112, S113, S114 and S115, respectively, shown by FIG. 28.

As described above, if there is an error found in the certification of the injection medicine bottle or patient, the reconfirmation is done based on the injection order first read by the PDA 8, and a query to the server system relating to a change in the injection order is done immediately before the injection practice in the present second embodiment.

Therefore, if there is no change of the injection order, the work progresses at the same rate as if there were no query to the server system in the interim.

This is effective for practicing an injection order to a patient whose condition is stable.

### Third Embodiment

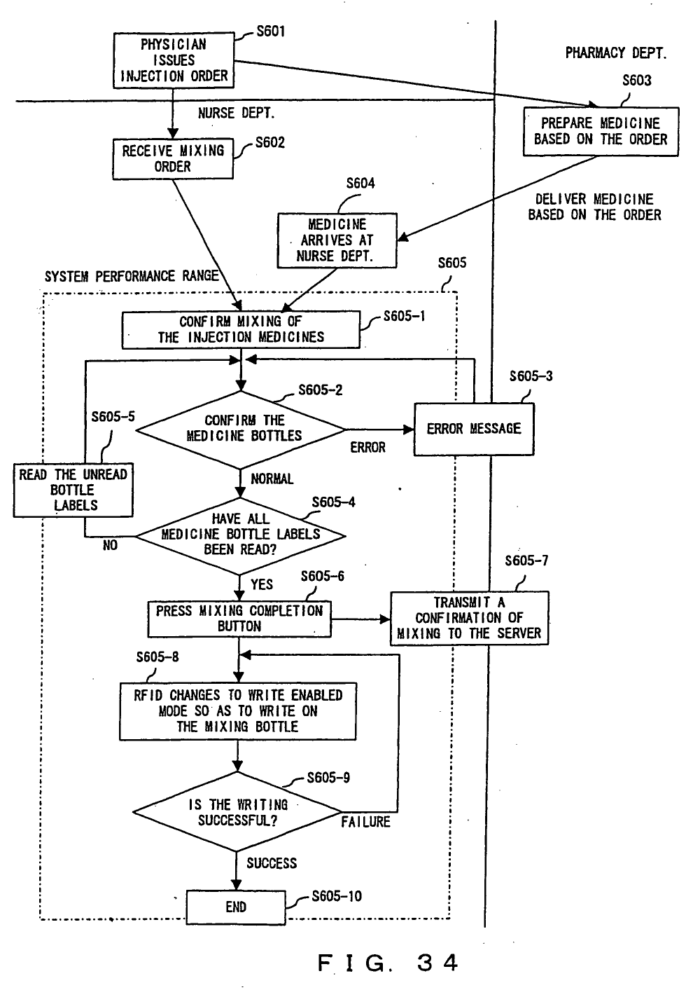

FIG. 34 is a flow chart describing an example processing operation of the hospital information system 1 relating to an injection medicine mixing according to a third embodiment. The mixing operation shown by FIG. 34 is a flow chart indicating the processing of mixing operation among the one based on the work schedule data generated as shown by FIG. 5 as a result of an injection order being registered in the server system.

As shown by FIG. 34, a physician issues an injection order (S601), in which the injection order directly inputted by the physician, or by a nurse based on the instruction by the physician, is registered in the server system.

The injection order registered in the server system contains data consisting of at least patient name, ward name, kinds of medicines to be mixed, amount, date and time of injection start, et cetera.

The injection order registered in the server system is notified to the terminals in the pharmacy dept. and the nurse dept., respectively.

The nurse dept. receives the above described injection order as a mixing order (S602).

On the other hand, the pharmacy dept. prepares the medicines for mixing based on the injection order displayed by the terminal (S603) and takes the prepared medicines for mixing out to deliver to the nurse dept.

Having received the above described medicines for mixing delivered from the pharmacy dept. (S604), the nurse on duty for the day starts mixing the medicines based on the received medicines for mixing and above described received mixing order (S605).

In the mixing operation the nurse first confirms the mixing injection medicines (S605-1), which is the processing to judge whether or not the data contained by the mixing order such as the patient name, ward name, kinds of medicines to be mixed, amount, et cetera, are identical with the data in the list of medicines to be mixed, which has been delivered from the pharmacy dept.

Having confirmed the identity, the nurse confirms the actual medicine bottles (S605-2), which is the processing for reading the medicine bottle labels followed by an automatic comparison and identity judgment processing between the medicine data obtained by the read medicine bottle labels and the medicine list specified by the mixing order.

Then, if the reading is not correctly done, the reading is in a wrong sequence or the reading of a medicine bottle label is not related to the mixing, the mobile terminal displays an error message (S605-3).

This firmly certifies the medicines to be mixed.

If the above described error message is displayed, the nurse reads the medicine bottle labels again while referring to both the medicine list of the mixing order and the medicine bottles in the processing of S605-2.

Once the reading finishes normally, the subsequent processing judges whether or not all the medicine bottles are read (S605-4). Then, if not all the bottles are read (“no” for S605-4), the mobile terminal displays as such, prompting the nurse to finish reading the unread medicine bottles and confirms the completion in S605-2.

When thus completing to read all the medicine bottles to be mixed (“yes” for S605-4), the mobile terminal displays the screen as such, in which a mixing complete button is shown on the bottom corner for instance so that the nurse presses the aforementioned button (S605-6).

With this, the mobile terminal transmits a notification, to the server system, of completing the mixing confirmation as per the injection order registered in the above described server system (S605-7).

Simultaneous with the above, since the RFID of the mixing bottle changes from “write inhibit” to “write enabled,” the nurse operates the indicated button of the display unit so as to write the information about the medicines used for the mixing as mixing information in the RFID of the mixing bottle (S605-8), which writes the information about the medicine used for the mixing in the medicine identification information sector of the RFID of the mixing bottle.

Although this processing is done automatically by the input operation of the above described instruction button, there is a possibility of failure in the writing caused by the strength of signal or the writing sector and therefore is judged whether or not the writing is successful (S605-9).

This processing performs a communication between the mixing bottle label and the mobile terminal for comparing the content of the writing.

Then, if the writing is not successful, the mobile terminal displays “writing failed” for indicating the failure thereof, the nurse operates the indicated button for input again and, when the writing becomes a success, the mobile terminal displays “writing succeeded” for indicating the success so that the nurse completes the mixing operation (S605-10).

According to the first, second and third embodiments of the present invention, attaching or embedding an RF tag in the patient wrist band, injection medicine bottle, patient chart, medical instrument case, reading information out of a plurality of RF tags of plural kinds all at once by an RF reader comprised by a PDA and confirming the readout information with a server by way of a wireless LAN make it possible to provide a hospital information system for assisting to operate a medical practice smoothly by an integral, central management, by a data base, of the data exchanges on the spot where the medical practice is carried out to grasp the information about the medical practice in real time.

### Fourth Embodiment

Incidentally, information attached to a medicine per se has not conventionally indicated which injection order the medicine is for. Therefore, when using a plurality of medicines such as mixing an injection medicine for administering to a patient by mixing a plurality of medicines, the mixing work requires a very careful attention.

Also, what is conventionally been attached to a medicine is just identification information, whereas the performance record of each operation is recorded in another information processing apparatus in the system. Therefore, such performance record has not necessarily been accessible for reference from all the work places.

Meanwhile, if an injection order is changed between the mixing operation and administration, making the mixing content change, the mixed medicine becomes useless and therefore will be discarded.

Even if another injection order happens to be able to use the same mixing contents, the already mixed medicine cannot be used for the other order because an ID for medicine is unique for each order.

The fourth embodiment, in consideration of the above described conventional inadequacy, provides a hospital information system particularly capable of checking relating medicines mutually and confirming an order.

In the hospital information system according to the fourth embodiment, bottle labels attached to containers for medicine and mixed medicine handled within the hospital are attached by wireless RF tags using a technique such as RFID (Radio Frequency Identification).

The wireless RF tag allows the information recorded therein to be read and written by communication with an RF reader/writer.

The fourth embodiment makes the RF tag store various information relating to operation for medicine and syringe tag such as the information about the order relating to the medicines, et cetera, the information about the medicine to be mixed therewith when mixing, the work date & time, the identification information about the practitioner, in addition to the identification information, in order to manage the medicines by using the aforementioned information.

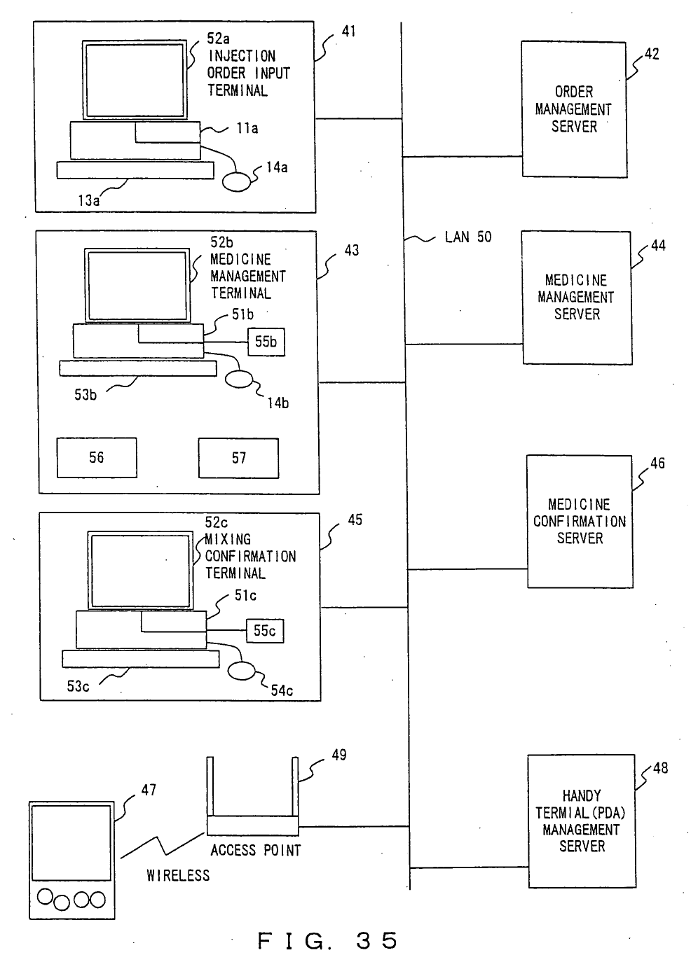

FIG. 35 exemplifies a configuration of hospital information system according to the present embodiment.

The hospital information system shown by FIG. 35 includes an injection order input terminal 41, an order management server 42, a medicine management terminal 43, a medicine management server 44, a mixing confirmation terminal 45, a mixing confirmation server 46, an injection practice recording PDA 47 and a PDA management server 48, all of which are connected by a LAN 50 routed in the hospital premise.

Incidentally, the injection practice recording PDA 47 is wirelessly connected with access points 49 and connected with a LAN 50 by way thereof.

The injection order input terminal 41 is a terminal for inputting an instruction of injection when a physician diagnoses a patient and instructs an administration of medicine such as injection, drip infusion for her/him.

The order management server 42 is the server for accumulating and managing the order information which is the information about the order inputted by the physician on the injection order input terminal 41.

Having received a notification of new order from the injection order input terminal 41, the order management server 42 records the order information as data base and, in addition, transmits the order to the servers related to the order, i.e., medicine management server 44, mixing confirmation server 46 and PDA management server 48; and searches a relating order and responds when receiving a query for an order.

The medicine management terminal 43 is the terminal installed in the pharmacy dept. used for displaying the information about the medicine for confirmation and inputting the information about a delivery when delivering the medicine.

The medicine management server 44 is the server for managing the information about the delivered medicine, which is notified by the medicine management terminal 43.

The mixing confirmation terminal 45 is the terminal apparatus for checking the medicines to be mixed when carrying out the mixing operation.

The mixing confirmation server 46 is the server for managing the information used by the mixing confirmation terminal 45 checking the medicines to be mixed.

The mixing confirmation server 46 collates the information read out of the medicines by the mixing confirmation terminal 45, when carrying out the mixing, with the order for confirming the medicines to be mixed.

The injection practice recording PDA 47 is a terminal apparatus carried around within the premise of a medical services facility, which is used for inputting the information at spots such as the patient room when administering the medicine to a patient such as injection and drip infusion.

The PDA management server 48 is the server for managing the information about the administration of medicine to a patient, which accumulates and manages the information inputted by the injection practice recording PDA 47; and judges whether or not there has been a change of the order at the time of administering the medicine.

Note that, while FIG. 35 only shows only one terminal each for the injection order input terminal 41, medicine management terminal 43 and mixing confirmation terminal 45 among the equipment constituting the hospital information system, one or a plurality of the aforementioned terminals will be installed, respectively, depending on the scale of hospital, et cetera.

Likewise, one or a plurality of the injection practice recording PDA(S) 47 will be installed. Also, one or a plurality of the access point(s) 9 will be installed for enabling the wireless LAN communication since the usage of the injection practice recording PDA(s) 47 goes across a plurality of wards and patient rooms within the hospital premises.

On the other hand, one of each will be installed within the hospital theoretically, including: the order management server 42, medicine management server 44, mixing confirmation server 46 and PDA management server 48.

Physically, however, a plurality of information management apparatuses can respectively comprise these servers for safety such as dualization, or one information management apparatus can comprise some, or all, of the respective functions of the following, i.e., order management server 42, medicine management server 44, mixing confirmation server 46 and PDA management server 48.

Meanwhile in FIG. 35, the injection order input terminal 41 comprises information processing terminal equipment 51a such as personal computer, a display 52a, a keyboard 53a and a pointing device 54a such as a mouse.

And the medicine management terminal 43 comprises an RF tag reader/writer 55b, a syringe tag printer 56 for printing to output a syringe tag and a bottle label printer 57 for printing to output a bottle label, in addition to the same comprisal as the injection order input terminal 41, i. e., information processing terminal equipment 51b, a display 52b, a keyboard 53b and a pointing device 54b.

And the mixing confirmation terminal 45 comprises an RF tag reader/writer 55c in addition to the same comprisal as the injection order input terminal 41, i. e ., information processing terminal equipment 51c, a display 52c, a keyboard 53c and a pointing device 54c.

The RF tag reader/writers 55b and 55c comprised by the medicine management terminal 43 and mixing confirmation terminal 45, respectively, are used for reading the information out of, or writing in, the RF tag attached to a medicine container by the wireless communication.

Incidentally, the syringe tag printer 56 and the bottle label printer 57 both comprised by the medicine management terminal 43 may be one printer apparatus instead of separate comprisals.

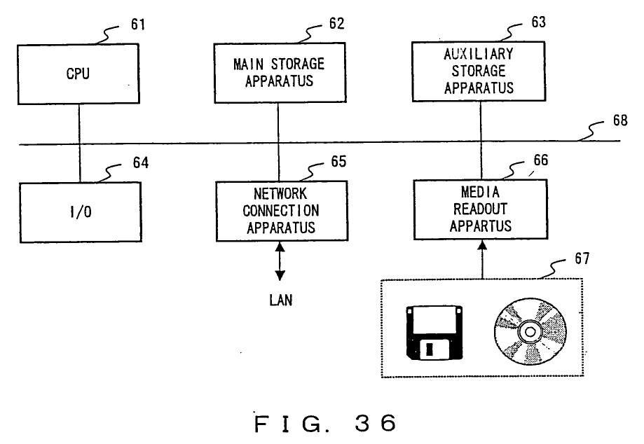

FIG. 36 shows an example configuration of the terminal apparatus and that of the server shown by FIG. 35.

The terminal apparatus or server shown by FIG. 36 comprises a CPU 61, a main storage apparatus 62 comprising ROM, RAM, et cetera, an auxiliary storage apparatus 63 having a large storage capacity such as hard disk, an input/output apparatus 64 comprising a display, keyboard, et cetera, a network connection apparatus 65 such as modem for enabling a network connection with a LAN 10, and a media readout apparatus 66 for reading information stored in a portable storage media 67 such as CD-ROM, DVD, optical disk, flexible disk, memory card, et cetera, when they are inserted in the media drive therein; with a bus 68 interconnecting the aforementioned components.

Incidentally, the medicine management terminal 43 and the mixing confirmation terminal 45 respectively comprise an interface for connecting with the RF tag reader/writer which is connected with the bus 68 in addition to the comprisal shown by FIG. 36. The medicine management terminal 43 also comprises a printer interface for connecting with both the syringe tag printer 56 and the bottle label printer 57.

The various processing performed by each terminal and server according to the present embodiment is accomplished by the CPU 61 executing the program stored in the main storage apparatus 62 or the auxiliary storage apparatus 63.

And in each terminal apparatus and server according to the present embodiment, the media readout apparatus 66 reads the program and data stored in the portable storage media 67 and the readout program and data are loaded onto, or stored in, the main storage apparatus 62 or the auxiliary storage apparatus 63. Then, a later described each processing by the server and terminal according to the present embodiment is also accomplished by the CPU 61 loading the program and data from the portable storage media to the main storage apparatus 62.

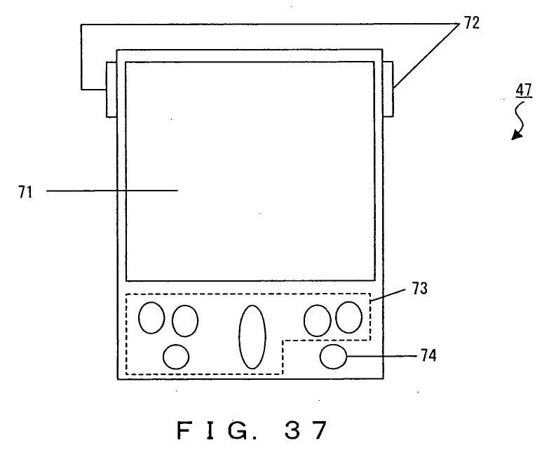

FIG. 37 shows an example configuration of the injection practice recording PDA 47.

The injection practice recording PDA 47 comprises an LCD (Liquid Crystal Display) panel 71 for displaying information, an RF tag readout button 72 for having an RF tag reader/writer equipped within the injection practice recording PDA 47 read RF tag(s), input & selection buttons 73 for instructing various inputs and selections, and a power switch button 74.

Note that the display screen of the LCD panel 71 may be configured by a touch panel for enabling input operations by touching a character or graphics in the display screen. Also, means for notifying the operator by a sound may be included in addition to the LCD panel 71.

The next description is about the flow of medicine and its information when applying the information system according to the present embodiment.

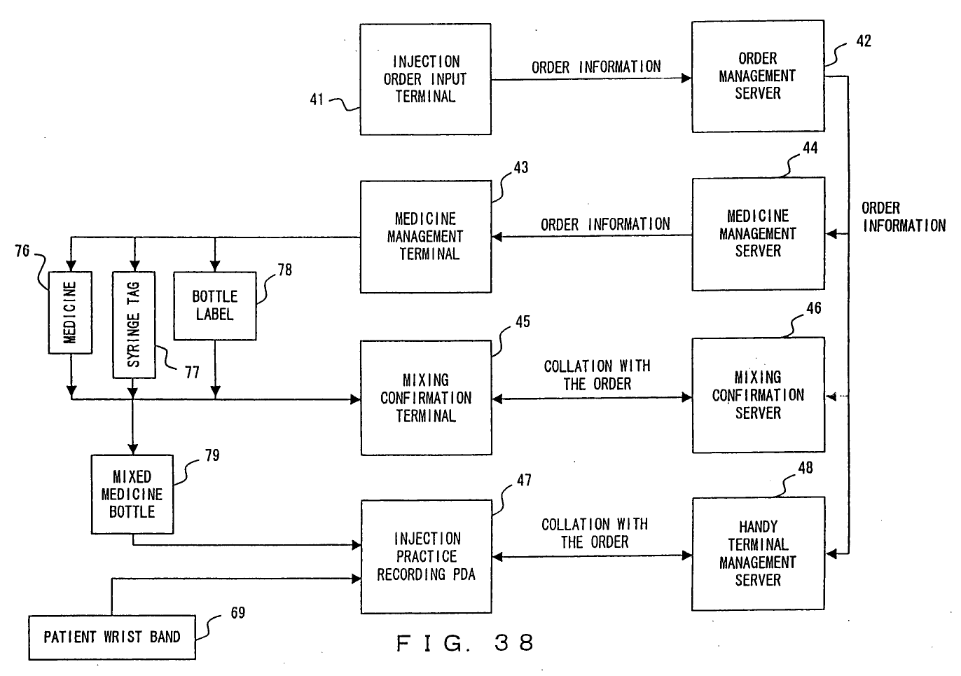

FIG. 38 shows information and material flows relating to a medicine administered to a patient in the hospital by using the hospital information system according to the present embodiment.

When a physician inputs, on the injection order input terminal 41, an order of administering a medicine to a patient, the injection order input terminal 41 transmits the inputted order information to the order management server 42.

The order management server 42 accumulates the transmitted injection order information as a data base therein and, at the same time, transmits the aforementioned information respectively to the medicine management server 44, the mixing confirmation server 46 and the PDA management server 48.

Over at the pharmacy dept., having received the information about the injection order from the medicine management server 44, the medicine management terminal 43 displays the received injection order in the display 52b therein. A practitioner in charge of delivering, such as a pharmaceutical chemist, who operates the medicine management terminal 43, takes either one or a plurality of medicines 76 out for delivery based on the injection order shown by the display 52b.

Also in the pharmacy dept., the practitioner makes the syringe tag printer 56 print a syringe tag 77 and the bottle label printer 57 print a bottle label 78 both based on the order information.

During the above processing, the order ID and the information about the mixing are written in the RF tags attached to the medicine 76 and bottle label 78 as tag information.

Then the medicine 76, the syringe tag 77 and the bottle label 78 are all transported to the ward where the patient specified by the order information is.

Back at the ward, having received the medicine 76, the syringe tag 77 and the bottle label 78 from the pharmacy dept., a practitioner in charge of mixing the injection medicine such as a nurse uses the mixing confirmation terminal 45 to read the tag information with the RF tag reader/writer 55c out of the RF tag attached to the container of the medicine 76 and to collate the information with the order information by transmitting a query to the PDA management server 48, and confirms the syringe tag 77 and operates a mixing if there is a plurality of medicines 76.

After mixing the medicines, the practitioner puts the mixed medicine into a mixed medicine bottle 79, which is usually one of the containers of the pre-mixing medicines, and therefore attaches the bottle label 78 describing the information about the post-mixing medicine to the mixed medicine bottle 79.

If, on the other hand, there is no mixing required, the container of the medicine 76 becomes the mixed medicine bottle 79, in Fig.38.

When administering the medicine such as injection, a practitioner in charge of injection, et cetera, such as a nurse, goes to the patient room where the patient to be administered stays, carrying the mixed medicine bottle 79.

Then she makes the injection practice recording PDA 47 transmit the order ID read out of the RF tag of the mixed medicine bottle 79 and the patient ID read out of the patient wrist band 69 to the PDA management server 48 for collating the patient ID and order ID with the patient ID recorded by the order information, followed by performing the injection to the patient.

As described above, in the hospital information system according to the present embodiment, the tag information stored by the RF tag attached to each medicine 76, et cetera, contains the order ID of the injection order corresponding to the medicine 76 and the various kinds of information used for checking at the time of mixing the medicine, and therefore it is possible to refer to the necessary information just by reading the information by using the RF tag reader/writer 55c on the respective spots in the hospital, without reading such information out of the server, et cetera.

Even if the order is changed after the pharmacy dept. delivering the medicine 76, the response is enabled by overwriting the tag information recorded by the RF tag.

The next detailed description deals with each processing shown by FIG. 38.

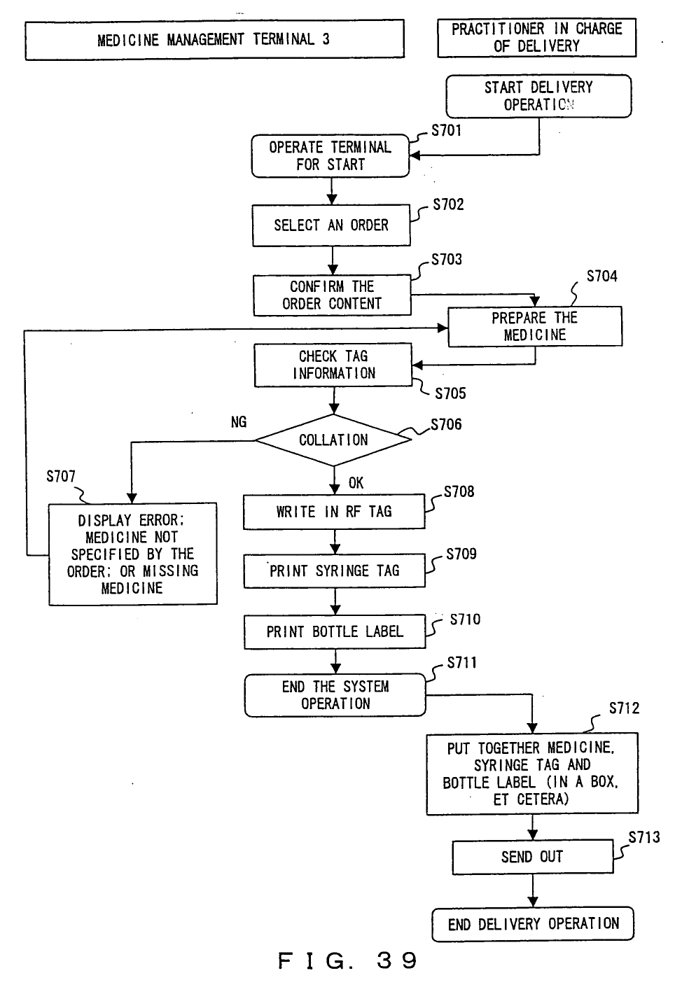

FIG. 39 is a flow chart showing a processing flow for delivery of a medicine.

The right side of FIG. 39 shows the processings done by an operator of the medicine management terminal 43 who is in charge of delivering a medicine on the outside of the information system, while the left side thereof shows the processing done by the medicine management terminal 43.

Incidentally, the assumption here is that the medicine management terminal 43 has been receiving order information from the order management server 42 by way of the LAN 10 to accumulate it in the memory comprised by itself for every injection order, before starting the processing shown by FIG. 39.

As the practitioner in charge of delivering medicine starts the delivering operation by operating the medicine management terminal 43 (S701), the medicine management terminal 43 displays the injection order list in the display 52b based on the order information received from the medicine management server 44 so that the person in charge of delivering medicine operates the pointing device 54b to select the order to be processed from among the ones indicated by the display screen (S702).

Prompted by the above described operation, the medicine management terminal 43 displays the detail information about the order selected by the S702 in the display unit 52b so that the practitioner in charge of delivering medicine can confirm the content (S703).

The displayed detailed information about the order is based on the order information received from the medicine management server 44, which are, for example, injection schedule date & time, physician issued the order (e.g., name and ID information), patient ID, patient name, medicine list of one or a plurality of medicine(s) and the (respective) amount of usage.

The practitioner in charge of delivery refers to the using medicine list indicated by the display 52b of the medicine management terminal 43 to select the medicine(s) 76 specified by the using medicine list (S704).

Each medicine 76 is attached by an RF tag on the container, recording a medicine ID having a unique value for category of medicine (or, for each medicine).

The medicine management terminal 43 reads the tag information recorded by the RF tags of all the medicines 76 by using the RF tag reader/writer 55b (S705).

Since the RF tag has a characteristic of allowing reading the information out of a plurality thereof all at once within the operating range of radio wave, the practitioner in charge of delivery lets the RF tag reader/writer read the tag information out of all the medicines 76 prepared in the S704 at once.

Then the medicine management terminal 43 collates the medicine ID read out of the RF tags in the S705 with the medicine ID recorded by the order information for identity (S706). And if the result of collation does not indicate an identity (“No” for S706), the display 52 shows either a missing medicine 76 or the excessive medicine 76 (S707).

Having seen the above described display content, the practitioner in charge of delivery goes back to S704 for taking out the right medicine 76.

Then, if a result of the collation in S706 indicates the medicine ID read out of the RF tags of the medicines 76 identifies with the medicine ID recorded by the order information (“yes” for S706), the medicine management terminal 43 writes the necessary information in the RF tags of the medicines 76 by using the RF tag reader/writer 55b (S708).

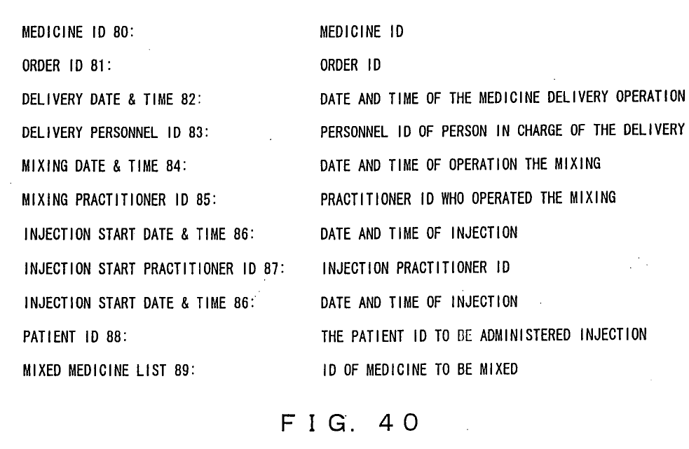

FIG. 40 shows the tag information stored in an RF tag attached to the medicine 76 and medicine bottle label 78.

In the RF tag, the following pieces of information are stored as tag information: medicine ID 80, order ID 81, delivery date & time 82, delivery personnel ID 83, mixing date & time 84, mixing practitioner ID 85, injection start date & time 86, injection start practitioner ID 87, patient ID 88 and mixed medicine list 89. Among all pieces of information shown by FIG. 40, all but the medicine ID 80 are stored by the RF tag in a rewritable way, so as not to allow RF reader/writer 55 to rewrite the medicine ID 80.

Among the information shown by FIG. 40, the medicine ID 80 is the information indicating the medicine ID for uniquely identifying the medicine attached by the RF tag.

The order ID 81 is the information indicating the order ID for uniquely identifying the order the medicine(s) 76 corresponds to.

The delivery date & time 82 is the information indicating the date and time of the medicine delivery operation.

The delivery personnel ID 83 is the information indicating the personnel ID of the practitioner in charge of the delivery.

The mixing date & time 84 is the information indicating the date and time of operating the mixing.

The mixing practitioner ID 85 is the information indicating the practitioner ID who operated the mixing.

The injection start date & time 86 is the information indicating the date and time of administering the medicine such as injection.

The injection start practitioner ID 87 is the information indicating the injection practitioner ID for identifying the physician or nurse who practiced injection.

The patient ID 88 is the information indicating the patient ID for identifying the patient to be administered by the medicine such as injection.

The mixed medicine list 89 is the information indicating the medicine to be mixed with when operating the mixing.

Now back to step S708 shown by FIG. 39, the medicine management terminal 43 writes the order ID of the order using the medicine in the order ID 81, the date and time of the delivery work being done in the delivered date & time 82, and the personnel ID of person in charge who performed the delivery in the delivery personnel ID 83 (S708).

The medicine management terminal 43 also writes a medicine ID in the mixed medicine list 89 if there is a medicine 76 to be mixed. For instance, if a medicine mixture uses medicines A, B and C, the medicine IDs for the medicines B and C are written in the mixed medicine list 89 of the RF tag attached to the medicine A; the medicine IDs for the medicines C and A are written in the mixed medicine list 89 of the RF tag attached to the medicine B; and the medicine IDs for the medicines A and B are written in the mixed medicine list 89 of the RF tag attached to the medicine C.

Then the medicine management terminal 43 makes the syringe tag printer 56 print a syringe tag 77 (S709) and the bottle label printer 57 print a bottle label 78 (S710).

The pieces of information printed on the syringe tag 77 and bottle label 78 are for instance scheduled injection date and time, patient ID, patient name, medicine name, all of which are based on the order information received from the medicine management server 44.

Having finished the operation on the system (S711), the person in charge of delivery puts together the medicine 76, syringe tag 77 and bottle label 78 in a box, et cetera (S712) and sends it out to the ward where the administration of the medicine such as injection will be carried out (S713).

As described above, the hospital information system according to the present embodiment has the information about the medicine relating to the mixing stored in the RF tag attached to the medicine when delivering the medicine, thereby enabling a cross-check when mixing the medicine by using the information.

The next description is about a mixing operation which is the operation for making a medicine to be administered to a patient such as injection by mixing a plurality of medicines, which are done in the nurse station, et cetera.

The mixing operation using the hospital information system according to the present embodiment is carried out by a mixing practitioner such as a nurse operating the mixing confirmation terminal 45 installed in the nurse station, et cetera.

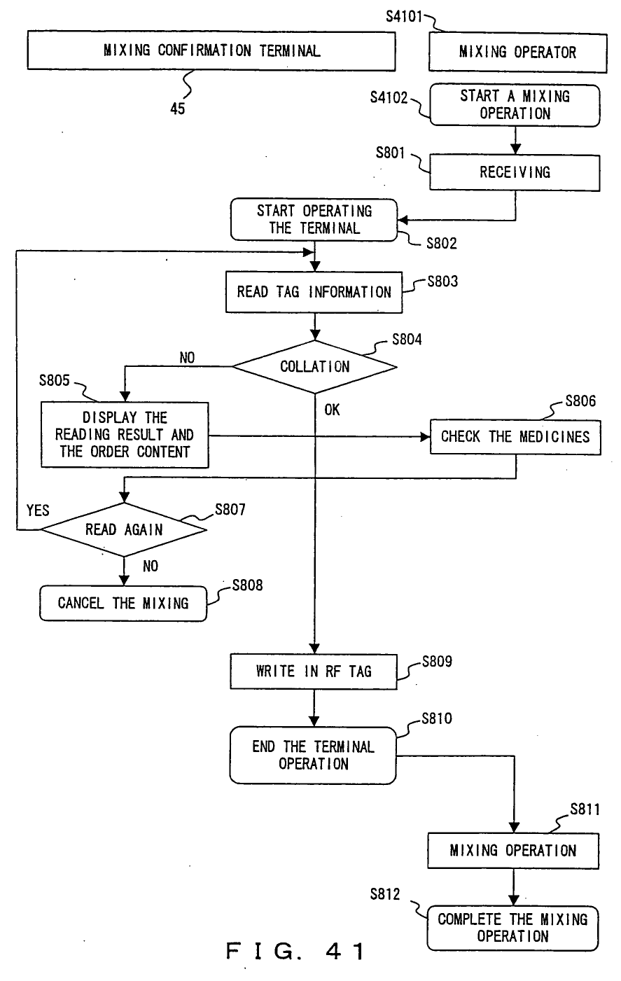

FIG. 41 is a flow chart showing a processing flow of injection medicine mixing operation.

The right side of FIG. 41 shows the processing done by an operator of the mixing confirmation terminal 45 such as nurse who is the practitioner of mixing medicines on the outside of the information system, while the left side thereof shows the processing done by the mixing confirmation terminal 45 and mixing confirmation server 46.

When starting a mixing operation, the mixing operator receives the medicines 76, the syringe tag 77 and the bottle label 78 from the pharmacy dept. (S801).

Then, the mixing operator starts operating the mixing confirmation terminal 45 and thereby carries out the mixing operation program (S802).

The operator then makes the RF tag reader/writer 55c comprised by the mixing confirmation terminal 45 read the tag information out of the RF tags attached to the medicines 76 (S803).

Since the RF tag has a characteristic to allow being read the information out of a plurality thereof all at once within the operating range of radio wave, the mixing operator reads the tag information out of the RF tags attached to all the medicines 76 and bottle labels 78 simultaneously.

Then the mixing confirmation terminal 45 performs a collation processing by the tag information read out in step S803 (S804).

Since the RF tags attached to the respective medicines 76 contain the tag information shown by FIG. 40 and therefore it is possible to judge whether or not all the medicines 76 corresponding to the injection order have been delivered just by comparing the respective tag information.

The mixing confirmation terminal 45 transmits a query to the mixing confirmation server 46 by the order ID, contained by the tag information read out in step S803, asking for the medicine ID of the medicines 76 to be used for the injection order.

The mixing confirmation server 46 searches the order content in the order information corresponding to the queried order ID and respond to the mixing confirmation terminal 45 with the medicine ID of the medicines specified by the order.

And the mixing confirmation terminal 45 collates the obtained medicine ID as a result of asking the mixing confirmation server 46 with the medicine ID contained by the tag information which has been read out in step S803 (S804).

As a result of the collation, if the above described two pieces of information do not identify with each other (“no” for S804), then the medicine ID read out of the RF tags attached to the respective medicines 76 (or the medicine name corresponding to the medicine ID) and the medicine ID (or the medicine name corresponding to the medicine ID) indicated by the order content obtained from the mixing confirmation server 46 as the response therefrom are both shown by the display 52c so as to enable the mixing operator to compare (S805).

Having seen the display, the mixing operator checks which medicine 76 is excessive (or missing) (S806).

As a result of collation in the S804, the causes for the medicine ID read out of the RF tags of the medicines 76 not identifying with the medicine ID of the order content can be three fold, i.e., not all the RF tags of the medicines 76 have been read; some medicine 76 is missing; and an excessive medicine 76 has been contained.

Referring to the displayed screen of the display 52c, the mixing operator checks the medicines 76 to take a corrective action such as eliminating an excess if there is one.

If it is considered a simple mistake as reading error such as the difference in the number of medicines between the read out result and the received medicines 76, then re-reading is necessary by going back to S803 (“yes” for S807).

If there is an excessive medicine 76 included, it must be removed, followed by going back to S803 to read the tag information once again (“yes” for S807).

If a medicine is still missing (“no” for S807), the mixing operation will be cancelled (S808).

Here, if a medicine 76 unrelated to the order was contained, the medicine concerned 76 is removed in the S806, while the RF tag of the medicine 76 has the tag record therein, such as the order ID, delivered date & time, delivery personnel ID and mixing medicine list, all of which are the log information about the medicine delivery in the S708 and the mixing.

This then makes it possible to recognize which order the removed medicine 76 shall be used for by reading the tag information out of the removed medicine 76 by using the mixing confirmation terminal 45, hence returning it to the rightful place.

Meanwhile, having confirmed that all the medicines 76 to be mixed are lined up as a result of the collation in the S804, the mixing confirmation terminal 45 lets the RF tag reader/writer 55c write mixing confirmation information in the RF tags attached to all the medicines 76 and the bottle label (S809), the contents of which are the mixing date & time 84 and the mixing operator ID 85 as the mixing confirmation information.

Then, having finished the operation of the mixing confirmation terminal 45 (S810), the mixing practitioner carries out the mixing operation using the checked medicines 76 (S811).

Then, having finished the mixing operation, the mixing practitioner attaches the bottle label 78 to the main bottle containing the mixed medicine, thus completing the mixing operation (S812).

As such, it is possible to avoid a mixing operation using a wrong medicine 76 in the mixing processing by using the hospital information system according to the present embodiment.

It is also possible to cross-check between the respectively related medicines 76 and the order information because various kinds of information are recorded in every medicine 76 to be mixed for assisting the mixing operation such as the mixing medicine list indicating which medicines the particular medicine 76 will be mixed with, and therefore check an excess or missing medicine 76 for integrating the mixing medicines.

This enables a firmer check than the conventional method. Also in the processing, if a wrong medicine 76 has been delivered, the tag information having the order ID allows the recognition as to which order the aforementioned medicine 76 originally belongs to, thereby making it possible to return it to the rightful place.

The next description is about a processing for administering a medicine such as an injection to a patient.

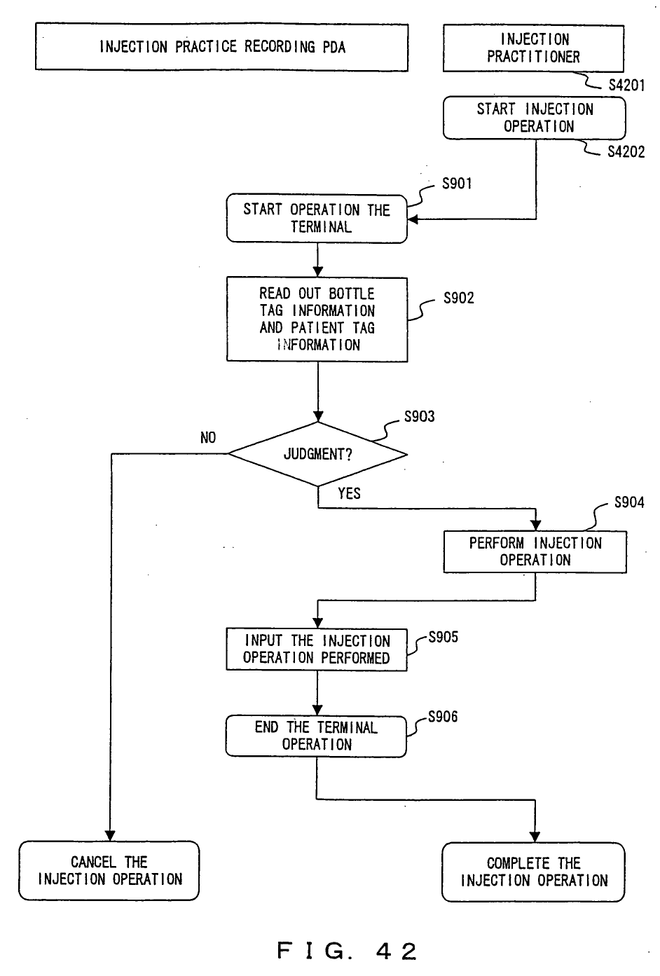

FIG. 42 is a flow chart showing a processing of injection practice.

The right side of FIG. 42 shows the processings done by an operator of the injection practice recording PDA 47 such as a physician or nurse who is the practitioner of injection on the outside of the information system, while the left side thereof shows the processing done by the injection practice recording PDA 47.

Having started an injection practice for administering the medicine such as injection and drip infusion, the injection practitioner starts practicing the injection at the bed side of the patient, et cetera, by using the injection practice recording PDA 47.

The patient wears a wrist band 69 attached by an RF tag which stores identification information such as the patient ID for identifying uniquely the patient wearing the wrist band 69.

According to a operation by the practitioner, the injection practice recording PDA 47 read the tag information out of the wrist band 69 and the bottle label 78 attached to the mixed medicine bottle 79 (S902).

And the injection practice recording PDA 47 transmits the order ID contained by the tag information readout of the bottle label 78 and the patient ID contained by the tag information read out of the wrist band 69 to the PDA management server 48 by way of the access point 49 for collation with the injection order (S903).

Having received the transmission, the PDA management server 48 searches for the order information corresponding to the transmitted order ID, examine the order content, judges whether or not the patient of the transmitted patient ID is the one for the administration of medicine and now is the time therefor, and notifies the injection practice recording PDA 47 of the judgment result.

Having received the notification of the judgment result, the injection practice recording PDA 47 displays the judgment result in the LCD panel 71 and, if it indicates that the administration of the medicine is not allowed due to a reason such as the patient wearing the wrist band 69 is not the one for the administration of medicine, or now is not the time therefor (“no” for S903), the injection practitioner cancels the administration of the medicine such as injection and the injection practice.

The cause for the cancellation can be considered as a nonidentity of the patient whom the medicine is about to be administered to with the one specified by the order, a nonidentity of the operation schedule time, et cetera, which is shown by the LCD panel 71 of the injection practice recording PDA 47, enabling the injection practitioner to perform the applicable process such as canceling the treatment.

On the other hand, the judgment result allows the injection practice in the S903 (“yes” for S903), the injection practitioner administers the medicine such as injection and drip infusion to the patient (S904).

Then, having completed the administration, the injection practitioner writes the information about the injection operation in the RF tag attached to the mixed medicine bottle 79 by using the injection practice recording PDA 47 (S905).

The pieces of information written in the S905 are, all shown by FIG. 40, the date and time of the practice for the injection start date & time 86, the ID information of the injection practitioner for the injection start practitioner ID 87, and the patient ID read out of the patient wrist band for the patient ID 88.

As described above, an administration of wrong medicine can be avoided by judging in comparison of the medicine about to be administered with the order at the time of administering the medicine by using the hospital information system according to the present embodiment.

The next description deals with an injection medicine mixing operation in the case of changing the injection order.

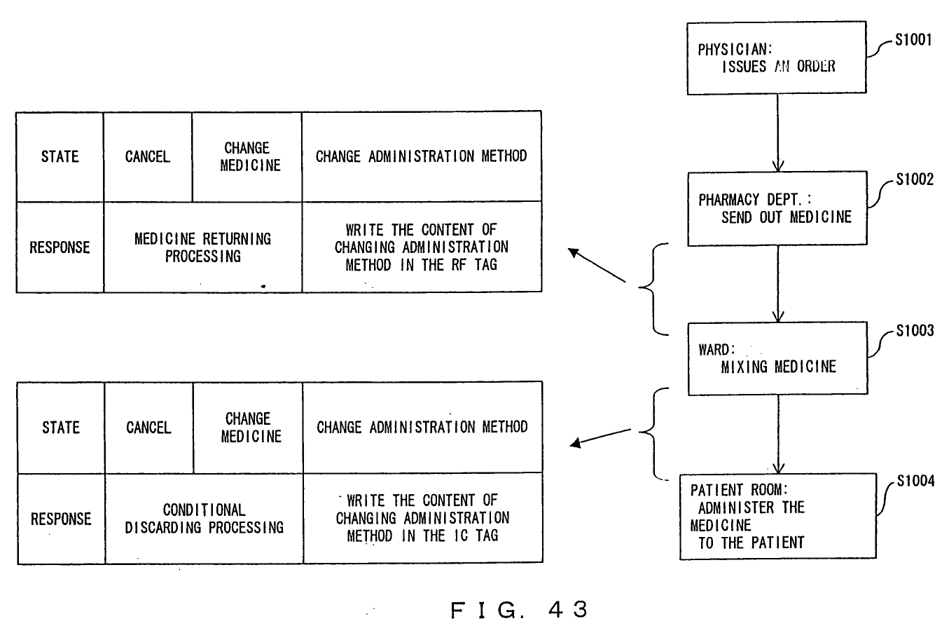

FIG. 43 illustrates a processing flow from the time of normal order issuance through the administration of medicine to the patient. The following flow illustrating the steps from an order issuance for administering a medicine to the actual administration is explained roughly as follows.

A physician issues an order (S1001).

Having receiving the order, over at the pharmacy dept., a pharmaceutical chemist puts together the medicine(s) as per the received order to send out to the ward specified by the order (S1002).

Back at the ward, having received the medicine(s), the mixing practitioner carries out the mixing operation based on the order (S1003).

The practitioner then administers the mixed medicine to the patient specified by the order (S1004).

If there is no change from the order issuance in the S1001 through to the administration of medicine in the S1004 without any abnormality in the above described processing flow, there is no problem to address.

Such orders, however, are often changed from the content specified by the order to the content actually administered to the patient in an attempt to respond to a quick change in the condition of patient or a postoperative progress.

In such event, if the order change occurs before the pharmacy dept. sends out a medicine 76 to the ward, the medicine 76 is returned to thereto for reuse, whereas such response has not been conventionally done for a change made after delivering to the ward, during mixing the medicine or before the administration, in which case the medicine cannot be used for other orders, hence being discarded.

Medicines are very expensive, and the discarded medicines cannot be included in the medical expense bill for the patient, and therefore the cost is a large loss to a hospital.

As a countermeasure to the problem, the hospital information system according to the present embodiment has the order ID of an order corresponding to the RF tag attached to the container of medicine 76 or a bottle label 78 stored and, when the aforementioned initial order is changed, has the order ID rewritten to the changed order ID to respond thereto, thereby saving a large amount of medicine.

If an order change occurs, the response varies between the case where the order change occurs after delivering the medicine to the ward in the steps S1002 and S1003, but before a mixing operation; and the case where the order change occurs after the mixing operation in the steps S1003 and S1004, but before an administration to the patient (refer to FIG. 43 left).

In the former case of the above described, the changed medicine will be returned to the pharmacy dept. if there is an order change for changing the sent out medicine such as a cancellation of administration and a change of medicine to be administered.

If the order just changes the administration methods, and not the medicines, the present hospital information system responds thereto by rewriting the tag information recorded by the RF tag attached to the medicine 76, compared to the conventional method of changing the bar code labels.

In this case, changing the order ID contained by the tag information to a new order IC for indicating the order change makes it possible to transfer the medicine 76 to new processing.

Meanwhile, if an order change occurs with a cancellation thereof or the medicine change in the latter period, the present hospital information system makes the medicine conditionally reusable by carrying out a conditional discarding processing, which will be described later, compared to the conventional method in which all the medicines have been discarded and the order re-issued.

Meanwhile, if an order change occurs with just a change in the administration method, not the medicine, then changing the order ID contained by the tag information to a new order IC for indicating the order change makes it possible to transfer the medicine 76 to new processing.

The above described method makes it possible to save a waste of medicine otherwise being discarded conventionally.

The next description is about the above noted conditional discarding processing which deals with an order change which cancels the administration or changes the medicines to be administered after mixing the medicine and before administering it.

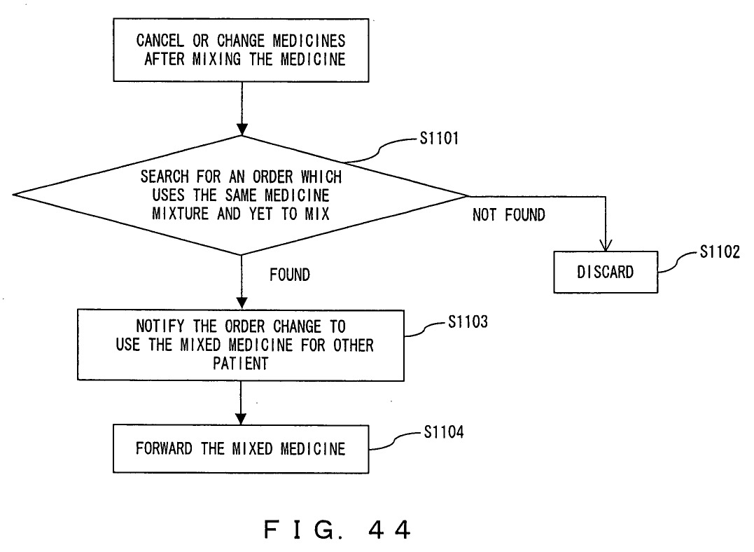

FIG. 44 describes a processing at an order change. The flow chart of FIG. 44 shows an outline of conditional discarding processing. The processing shown by FIG. 44 is carried out when the order change occurs to cancel the administration or change the medicines after the applicable medicine is mixed.

The first processing, in the processing shown by FIG. 44, searches for an order which uses the same mixed medicines with a mixing the medicine being not yet done by using the search key of the medicine ID contained by the pre-change order information instructing the injection medicine mixing (S1101).

In the processing, the search is to exclude the orders for which the administration date and time is when the “use by” date and time of the mixed medicine expires by including the mixed date and time in the search element.

As a result of the search in the S1101, if there is no applicable order found (“not found” for S1101), discards the mixed medicine (S1102) since there is no such order issued.

On the other hand, if the applicable order is found (“found” for S1101) as a result of the search in the S1101, meaning there is an order possible to use the mixed medicine, notifies that the order using the mixed medicine has been changed (S1103) to perform a processing for forwarding the mixed medicine to the patient indicated by the changed order (S1104).

As described above, it is possible to follow up the processing by using the present system where the conventional method has not been able to avoid a discarding when a change or cancellation occurred because a medicine has been uniquely associated with the order, and therefore cut the expenses.

The next detailed description deals with the processing when an order change occurs to the one shown by FIG. 44.

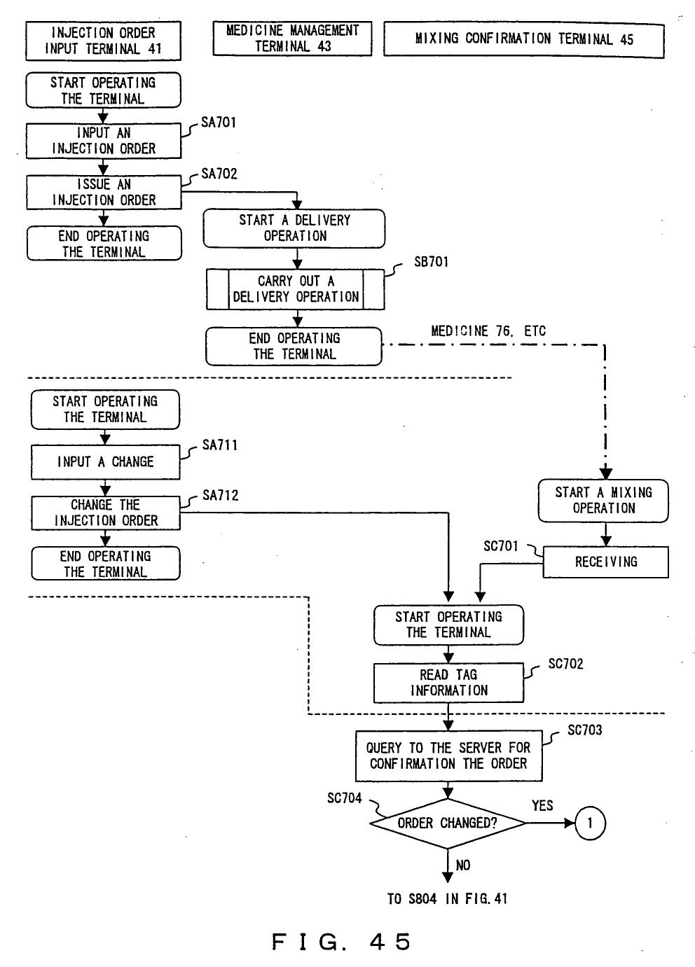

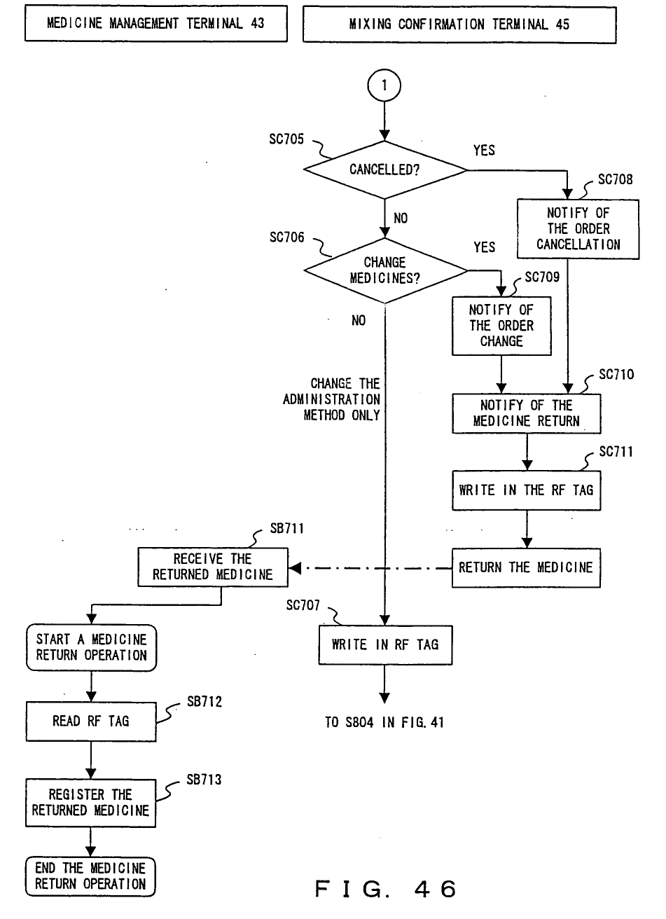

FIGS. 45 and 46, together, show a flow chart describing a processing in the case of changing injection order before an injection medicine mixing operation, following the medicine delivery.

In FIG. 45, the left part shows an injection order operation accomplished by a physician operating the injection order input terminal 41; the center part shows a delivery operation accomplished by a delivery practitioner such as a pharmaceutical chemist operating the medicine management terminal 43; and the right part shows a mixing operation accomplished by a mixing practitioner such as a nurse operating the mixing confirmation terminal 45.

In FIG. 46, the left part shows a returning medicine operation accomplished by a delivery practitioner such as a pharmaceutical chemist operating the medicine management terminal 43; and the right side shows a mixing operation accomplished by a mixing practitioner operating the mixing confirmation terminal 45.

First of all, a physician operates the injection order input terminal 41 to input the information such as patient information, a medicine to be administered and the administration method, administration date and time, et cetera, instructing and asking for the administration of medicine (SA701).

Then, the injection order input terminal 41 creates order information based on the inputted information and transmits the order information to the order management server 42 as an injection order issuing processing (SA702).

Having received the transmission, the order management server 42 stores the order information in the memory therein for management and, at the same time, notifies the medicine management server 44, the mixing confirmation server 46 and the PDA management server 48 of the order information.

Having received the order information, starting a delivery operation, a delivery practitioner such as a pharmaceutical chemist carries out a delivery operation (SB701), which is the same as the processing described in reference to FIG. 39.

Upon finishing the delivery operation, the delivery-processed medicine will be delivered to the ward together with a syringe tag 77 and a bottle label 78.

Also in the processing, the RF tag attached to the medicine 76 is recorded by the following pieces of information in addition to the medicine ID 80: order ID 81, delivery date & time 82 and delivery personnel ID 83.

Upon finishing the delivery operation, the delivery practitioner sends out the delivery-processed medicine 76, et cetera, to the ward administering the medicine.

In the meantime, if a change occurs to the injection order, the physician inputs the content of change on the injection order input terminal 41 (SA711).

Then the injection order input terminal 41 notifies the order management server 42 of the change of the injection order (S712), followed by the order management server 42 sending the notification to the medicine management server 44, mixing confirmation server 46 and PDA management server 48.

In the above described notification, the changed injection order is attached by a new order ID as the indication that an order change has been made.

Back at the ward, having received the medicine 76 and the mixing operation getting started, a mixing practitioner such as a nurse starts operating the mixing confirmation terminal 45 (SC701).

By the mixing practitioner operating it, the mixing confirmation terminal 45 lets the RF tag reader/writer 55c read the tag information out of the medicine 76 received in the SC701 (SC702).

Since the order ID 81 shown by FIG. 39 is recorded by the tag information, the mixing confirmation server 46 is queried for the order information by the order ID 81 (SC703).

If a notification of the order change made in the above described SA712 has been transmitted from the injection order input terminal 41 to the mixing confirmation server 46 prior to the query, the order information recorded by the mixing confirmation server 46 has also been changed to the order content in accordance with the notification of the order change.

Since the present embodiment is for showing the processing in the case of an injection order having been changed after the delivery of the medicine and before the injection medicine mixing operation, the assumption here is that the order change has already been made at the time of the query in the SC703.

Then, the mixing confirmation terminal 45 judges whether or not an order change has been made (SC704) and, if the judgment is that there has been no change (“no” for SC704), the processing goes to the S804 shown by FIG. 41.

On the other hand, if the judgment is that the order has been changed (“yes” for SC704), the processing goes to the SC705 shown by FIG. 46.

In the processing shown by FIG. 46, the mixing confirmation terminal 45 determines the content of the order change from among: (1) a cancellation of administering the medicine, (2) a change of medicines to be administered, or (3) no change of medicine, but only a change of administering method.

The mixing confirmation terminal 45 judges whether or not the content of order change is (1) a cancellation of administering the medicine (SC705) and, if it is a cancellation (“yes” for SC705), displays a notification of order cancellation in the display screen of the display 52c (SC708).

If it is not a cancellation in the SC705, the mixing confirmation terminal 45 judges whether or not the content of the order change is (2) a change of medicines to be administered (SC706) and, if it is a change of medicine (“yes” for SC706), displays a notification of the order change in the display screen of the display 52c (SC709).

Meanwhile in the SC706, the content of the order change is not a change of medicine to be administered (“no” for SC706), then the content of order change is (3) a change in administration method only, and therefore overwrites the RF tag attached to the medicine 76 with the changed order number (SC707), followed by proceeding to the S804 shown by FIG. 41 for a mixing operation of the medicine.

By writing the RFID in the SC707, changing the order ID contained by the tag information makes it possible to use the medicine as is, compared to the conventional method where an order change forces the discarding of the medicine.

If the order content is either a cancellation of administration or a change of medicine, the received medicine in the SC708 will not be used, and therefore a notification is displayed in the display 52c in the SC708 or SC709, followed by displaying a notification of return of the medicine (SC710).

Then, the processing writes the RF tag attached to the medicine 76 (SC711), entering the date and time of canceling the mixing, changing the practitioner ID, clearing the order ID, et cetera.

Having seen the notification in the SC711, as the mixing practitioner returns the medicine 76 (SC711), then the pharmacy dept. receives the returned medicine 76 (SB711) and starts processing a medicine return processing by operating the medicine management terminal 43.

The medicine management terminal 43 lets the RF tag reader/writer 55b read the tag information out of the RF tag attached to the returned medicine 76 to confirm a medicine ID (SB712), and register the medicine ID as a returned medicine in the medicine management server 44 (SB713).

This enables the pharmacy dept. to deliver the returned medicine when another injection order needs the same medicine.

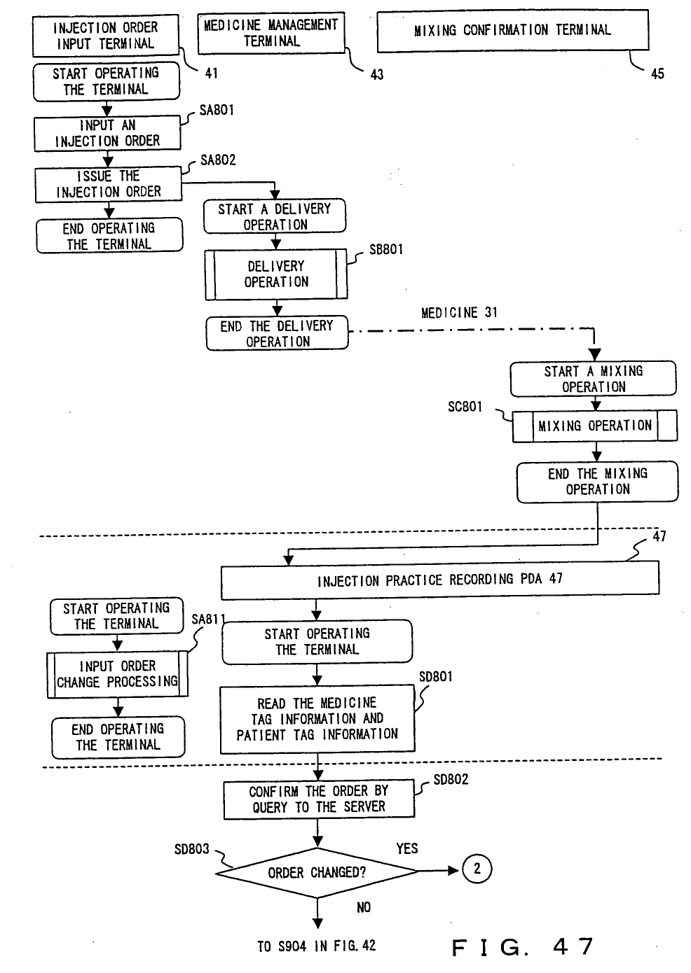

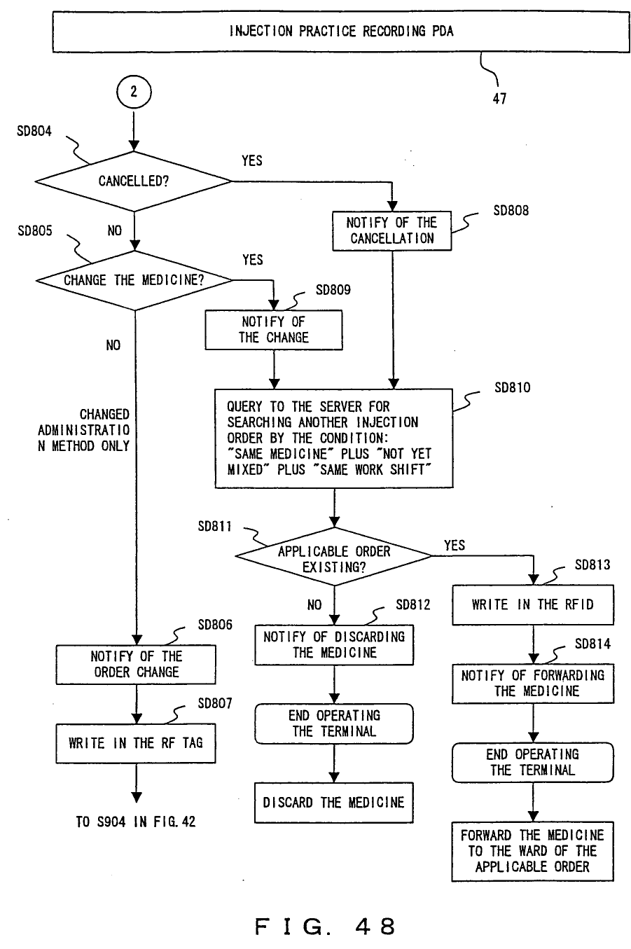

FIGS. 47 and 48, together, show a flow chart indicating a processing in the case of changing an injection order after the injection medicine mixing operation.

In FIG. 47, the left part shows an injection order operation accomplished by a physician operating the injection order input terminal 41; the center part shows a delivery operation accomplished by a delivery practitioner such as a pharmaceutical chemist operating the medicine management terminal 43; and the right part shows a mixing operation accomplished by a mixing practitioner such as a nurse operating the mixing confirmation terminal 45.

And the right part of FIG. 47 shows an injection practice operation accomplished by an injection practitioner such as a nurse operating the injection practice recording PDA 47.

And FIG. 48 shows an injection practice operation accomplished by an injection practitioner operating the injection practice recording PDA 47 in the case of order change.

First, a physician operates the injection order input terminal 41 to input the information such as patient information, medicine to be administered, its administration method and the date & time of administration, et cetera, to instruct and request for an injection practice (SA801).

Prompted by the input, the injection order input terminal 41 creates order information based on the inputted information and transmits the order information to the order management server 42 as a processing for an injection order issue (SA802).

Having received the transmission, the order management server 42 notifies the medicine management server 44, mixing confirmation server 46 and PDA management server 48 of the order information.

Having received the order information and starting a delivery operation, a delivery practitioner such as a pharmaceutical chemist operates the delivery operation (SB801) which is the same processing as described in reference to FIG. 39.

Having finished the delivery operation, the delivery-processed medicine 76 will be sent out to the applicable ward together with a syringe tag 77 and bottle label 78.

And the RF tag attached to the medicine 76 is recorded by an order ID 81, delivered date & time 82 and delivery practitioner ID 83 in addition to the medicine ID 80 which has been recorded initially in the RFID tag.

Having finished the delivery operation, the practitioner sends out the delivery-processed medicine 76, et cetera, to the applicable ward.

Back at the ward, having received the medicine 76, et cetera, delivered from the pharmacy dept., a mixing practitioner such as a nurse operates the mixing confirmation terminal 45 to start a mixing operation.

In the mixing operation, the practitioner carries out the mixing operation processing (SB801) which is the same as the processing described in reference to FIG. 41.

On the other hand, if the injection order is changed due to a cause such as a rapid change in patient condition, an injection order change processing will be carried out.

In this processing, a physician operates the injection order input terminal 41 to process an injection order change which is the processing of the steps SA711 and SA712 shown by FIG. 45 (SA811).

As the physician inputs the content of the order change on the injection order input terminal 41, the change content is notified to the medicine management server 44, mixing confirmation server 46 and PDA management server 48 by way of the order management server 42. And the notified changed injection order is attached by a new order ID.

Note that the present embodiment is under the assumption that the notification is transmitted to the medicine management server 44, mixing confirmation server 46 and PDA management server 48 after completing the mixing operation processing in the SC801 and the mixing operation of the medicine to be administered by the pre-change, old order.

Meanwhile, in the ward, having completed the mixing operation, an administration of the medicine to the patient starts.

The injection practitioner such as a nurse operates the injection practice recording PDA 47 so as to start an injection processing and let the injection practice recording PDA 47 read the tag information out of the RF tag attached to the medicine 76 and the patient wrist band 69 worn by the patient (SD801).

In this event, as the tag information of the medicine 76 contains not only the medicine ID but also the order ID, the injection practice recording PDA 47 then queries the PDA management server 48 for the content of order by using the order ID (SD802).

Then injection practice recording PDA 47 judges whether or not there has been an order change based on the response back to the query transmitted in the SD802 (SD803) and, if there has been no change (“no” for SD803), the processing goes to step S904 shown by FIG. 42 to proceed with administering the medicine to the patient.

If the judgment in the SD803 is that there has been a change of order (“yes” for SD803), the injection practice recording PDA 47 transfer the processing to the SD804 shown by FIG. 48.

In the processing shown by FIG. 48, the injection practice recording PDA 47 first determines the content of the order change which are categorized as: (1) a cancellation of administering the medicine, (2) a change of administering medicine, or (3) no change of medicine but change of administration method.

The injection practice recording PDA 47 judges whether or not the content of the order change is (1) a cancellation of administering the medicine (SD804) and, if it is a cancellation (“yes” for SD804), notifies the injection practitioner of the cancellation of administering the medicine by a method such as displaying the notification in the LCD panel 71 (SD808).

If the content of the order change is judged to be not a cancellation in the SD804, the injection practice recording PDA 47 judges whether or not the content of the order change is (2) a change of administering medicine (SD805) and, if it is (2) a change of administering medicine (“yes” for SD805), notifies the injection practitioner of the change in administering medicine due to the order change by a method such as displaying the notification in the LCD panel 71 (SD809).

If the content of the order change is judged to be not (2) a change of administering medicine in the SD805 (“no” for SD805), then the content of the order change resulting only in (3) a change of administration method the injection practice recording PDA 47 notifies the injection practitioner of the order change by using a display screen and/or sound and, in addition, displays the changed administration method in the LCD panel 71 (SD806).

This is followed by overwriting the changed order ID in the RF tag attached to the medicine 76 (SD807), followed by transferring the processing to the step S904 shown by FIG. 42 for practicing the administration of medicine such as injection.

Writing in the RF tag in the SD807 enables the medicine 76 to be used as is by changing the order ID contained by the tag information so as to relate with the changed order information, contrary to the conventional method which forces the discarding medicine in response to an order change.

If a content of order is either (1) a cancellation of administering the medicine or (2) a change of administering medicine, the medicine delivered from the pharmacy dept. will not be used, therefore the injection practice recording PDA 47 notifies the injection practitioner by a method such as displaying in the display screen (SD808 for the above (1); and SD809 for the above (2)), followed by transmitting a query to the order management server 42 by way of the PDA management server 48 (SD810).

Responding to this, the order management server 42 searches an injection order which can use the mixed medicine to respond back to the injection practice recording PDA 47 with the search result.

The search conditions for the above search are: (1) an administration of medicine which is the same as the mixed medicine in terms of kind, amount and portion; (2) the mixing is not done; and (3) the administration of medicine will take place within the “use by” of the mixed medicine such as the date, time and work shift of administration is the same, et cetera; with all three of the aforementioned conditions being satisfied.

The injection practice recording PDA 47 judges whether or not there exists another order matching to the conditions based on the response back from the order management server 42 (SD811).

As a result of the judgment, if there is no such order (“no” for SD811), the injection practice recording PDA 47 notifies the injection practitioner of discarding the medicine by a screen display, and/or sound, et cetera (SD812), thus ending the injection practice processing.

Then, having received the notification of the SD812, the injection practitioner discards the mixed medicine 76 that she has been carrying for administering to the patient.

Meanwhile, if it is an injection order change, the injection practitioner waits for the pharmacy dept. to deliver a changed medicine anew, and proceeds with the injection practice when the changed medicine 76 arrives at the ward.

Meanwhile in the SD811, if the judgment is that there exists the applicable injection order (“yes” for SD811), making it possible to use the medicine by changing to the corresponding injection order, then the injection practice recording PDA 47 overwrites the order ID recorded in the RF tag of the bottle label 78 attached to the medicine with the order ID of the aforementioned applicable injection order (SD813).

And the injection practice recording PDA 47 notifies the injection practitioner of forwarding the medicine by a message, et cetera, and of the detailed information about the new injection order such as the patient ID, patient name, practice schedule date and time, practice ward to be transferred to, et cetera, by a display screen, et cetera (SD814), thus ending the processing for the injection practice.

And the injection practitioner, having received the notification in the SD814, forward the medicine to the ward corresponding to the applicable order.

In the meantime, the medicine 76 according to the changed injection order will be processed by operating the medicine management terminal 43 for delivery to the ward where the mixing and injection practices will be carried out accordingly upon arrival thereat.

As described above, a use of the hospital information system according to the present embodiment can minimize the amount of medicine to be discarded even if the injection order is changed during the process of preparing for an injection.

As also described above, a capability of reading information out of RF tags, and writing information therein, makes it possible to confirm medicines to be mixed more accurately and determine to which order a medicine erroneously delivered is supposed to belong according to the fourth embodiment of the present invention.

Therefore, a mistake committed in each readying step for administering medicine to a patient can be reduced. Also a medicine erroneously delivered can be determined to which order it is supposed to belong.

Also, information, which is recorded by an RF tag attached to a medicine, about an instruction for administering the medicine and an operation record of each readying processing makes it possible to obtain the various kinds of information about the medicine instantly just by reading the information out of the RF tag, without transmitting a query to a server, et cetera, within the information system.

Furthermore, if a change occurs in the injection order between the mixing practice and the injection of the medicine, changing the mixing content, the already mixed medicine can be used as the one for another order, thereby reducing a waste of medicine, contrary to the conventional method which has forced to discard it.

1. A hospital information system, at least comprising:
a terminal for inputting and outputting data relating to a medical practice;
a server system for exchanging the data with the terminal; and
an intra-hospital information management system for recording, and managing integrally and centrally, information within a hospital being exchanged by the server system, wherein
the terminal at least comprises
an order registration terminal comprising an order registration apparatus for registering an order relating to an injection practice, and
a mobile terminal, at least one of which is installed as the one belonging to the server system, and capable of inputting and outputting data relating to an injection practice on the spot of the injection operation, and
the intra-hospital information management system comprises
at least a work schedule data creation apparatus for creating injection work schedule data for the injection practice based on a registration of an order transmitted from the terminal byway of the server system, and
the mobile terminal comprises
a noncontact identification information reading apparatus for reading identification information in a noncontact way out of an identification tag,
an identification information output apparatus for outputting the identification information read by the noncontact identification information reading apparatus to the server system,
a data acquisition apparatus for acquiring the injection work schedule data created by the intra-hospital information management system by way of the server system,
a display apparatus for displaying a catalog of the injection work schedule data acquired by the data acquisition apparatus,
a medicine certification apparatus for certifying an absence of mistake in medicine to be used, of change or cancellation of the order, and certifying that an injection medicine mixing having been practiced, based on identification information read out of a medicine identification information tag attached to a medicine to be used by using the noncontact identification information reading apparatus when carrying out an injection practice according to the injection work schedule data,
a patient certification apparatus for certifying an absence of mistake relative to the order based on identification information read out of a patient identification information tag worn by a patient by using the noncontact identification information reading apparatus when carrying out an injection practice according to the injection work schedule data, and a practice registration apparatus for registering an injection practice for the server system when all results of certification by the medicine certification apparatus and patient certification apparatus are successful.

2. The hospital information system according to claim 1, wherein the medicine certification apparatus is configured for querying identification information read out of the medicine identification information tag to the server system to perform the each certification.

3. The hospital information system according to claim 1, wherein the medicine certification apparatus is configured for performing the certifications of
absence of mistake in medicine to be used by collating identification information read out of the medicine identification information tag with an injection work schedule data acquired by the data acquisition apparatus,
absence of a change or cancellation of the order by querying identification information read out of the medicine identification information tag to the server system, and
having practiced an injection medicine mixing based on an injection medicine mixing information read out of medicine identification information tag which allows writing information about injection medicine mixing relating to the injection medicine mixing.

4. The hospital information system according to claim 1, wherein the practice registration apparatus is configured for recording at least pieces of information, i.e., practitioner, operated patient, used medicine, operated date and time, in the server system as the practice registration.

5. The hospital information system according to claim 1, wherein the mobile terminal comprises a warning apparatus for warning when either one of respective certification results brought about by the medicine certification apparatus or the patient certification apparatus is failed.

6. The hospital information system according to claim 1, wherein the mobile terminal comprises an accumulation apparatus for accumulating error log information when either one of respective certification results brought about by the medicine certification apparatus or the patient certification apparatus is failed, and comprises an output apparatus for outputting error log information to the server system at the time of ending a processing of the mobile terminal

7. The hospital information system according to claim 3, wherein the mobile terminal comprises a certification apparatus for certifying medicine to be mixed based on identification information read out of medicine identification information tag attached to the medicine by using the noncontact identification information reading apparatus, and comprises a writing apparatus capable of writing information about mixing including a completion status of mixing operation in the medicine identification information tag when a certification result brought about by the certification apparatus is a success.

8. The hospital information system according to claim 7, wherein the writing apparatus is configured for writing information about a medicine used for an injection medicine mixing in the medicine identification information tag as mixing injection medicine information.

9. A hospital information system, in the hospital information system for managing information about a medicine to be administered to a patient, comprising:
an order information storage apparatus for creating order information indicating an instruction relating to an administration of medicine based on the instruction input for the administration of the medicine to a patient and storing the created order information; and
a medicine management apparatus for writing information created based on the order information relating to the medicine in an RF tag attached to the medicine when performing a medicine delivery practice based on the order information.

10. The hospital information system according to claim 9, wherein information written in the RF tag by the medicine management apparatus contains information indicating a record of medicine delivery operation for the medicine when performing the medicine delivery operation.

11. The hospital information system according to claim 9, further comprising an injection medicine mixing information writing apparatus for writing information indicating a record of medicine mixing operation performed for the medicine in an RF tag attached to the mixed medicine when operating a mixing medicines for making the medicine to be administered to a patient by mixing a plurality of medicines based on the order information.

12. The hospital information system according to claim 9, further comprising a medicine administration information recording apparatus for writing information indicating an administrating operation record of the medicine in an RF tag attached to the administering medicine when administering the medicine to the patient.

13. The hospital information system according to claim 9, wherein the information indicating an operation record contains at least one of identification information for uniquely identifying an operation time and a practitioner.

14. The hospital information system according to claim 9, further comprising a delivery check apparatus for reading, when operating a delivery processing, identification information of the medicine out of an RF tag that is attached to the medicine and records identification information for uniquely identifying a medicine to which the RF tag is attached, and for checking the medicine by referring to the order information.

15. The hospital information system according to claim 9, further comprising an injection medicine mixing check apparatus for reading, when operating an injection medicine mixing for making a medicine to be administered to a patient by mixing a plurality of medicines based on the order information, information out of RF tags attached to the plurality of medicines, respectively, and checking the medicines by referring the information to the order information.

16. The hospital information system according to claim 9, further comprising a medicine administration check apparatus for reading information out of an RF tag attached to the medicine to be administered and checking the medicine by referring the information to the order information when administering the medicine to the patient.

17. The hospital information system according to claim 9, further comprising a notification apparatus for notifying a practitioner of a change in the order when the order is changed.

18. The hospital information system according to claim 9, further comprising an order change processing apparatus for overwriting, when the order is changed, information recorded by an RF tag attached to the medicine based on the changed order information.

19. The hospital information system according to claim 18, wherein the order change processing apparatus judges whether or not a change has occurred in the order information based on information read out of an RF tag attached to the medicine and, if the change has occurred, overwrites information recorded by the RF tag attached to the medicine based on the changed order information when operating the injection medicine mixing.

20. The hospital information system according to claim 18, wherein the order change processing apparatus judges whether or not a change has occurred in the order information based on information read out of an RF tag attached to the medicine and, if the change is about an administration method of medicine, overwrites information recorded by the RF tag attached to the medicine based on the changed order information when administering the medicine to the patient.

21. The hospital information system according to claim 9, wherein the injection medicine information writing apparatus writes also information indicating other medicine to be used for injection medicine mixing.

22. The hospital information system according to claim 9, wherein the RF tag utilizes an RFID (Radio Frequency Identification) technology.

23. A program, being the program executed within a terminal apparatus for building up a hospital information system for managing information about a medicine to be administered to a patient, accomplishing the functions of
receiving, by way of a network, and storing in a memory, order information indicating an instruction relating to an administration of medicine; and
writing information based on the order information in an RF tag attached to a medicine.

24. A program, being the program executed within a terminal apparatus for building up a hospital information system for managing information about a medicine to be administered to a patient, accomplishing the functions of
reading information out of an RF tag attached to a medicine;
referring the information which is read out of the RF tag to an order information indicating an instruction for administering medicine; and
checking the medicine based on a result of the reference.
